(19) United States
(12) Patent Application Publication
(10) Pub. No.: US 2026/0311196 A1
(43) Pub. Date: Oct. 8, 2026

(54) System and Method for Maximizing the Value of Consumption Data

(71) Applicant: DemanData Inc., Port Washington, NY (US)

(72) Inventors: Joseph Fedele, Port Washington, NY (US); Colin Gunn, Waco, TX (US); Francis J. Lemieux, JR., Sag Harbor, NY (US); Ranganath Maramraju, Hyderabad (IN); Gordon Kessler, Mount Kisco, NY (US); Jeremy Landis, Austin, TX (US)

(21) Appl. No.: 19/542,040

(22) Filed: Feb. 17, 2026

Related U.S. Application Data
(60) Provisional application No. 63/972,575, filed on Jan. 30, 2026.
(60) Provisional application No. 63/804,370, filed on May 12, 2025.
(60) Provisional application No. 63/783,107, filed on Apr. 3, 2025.

(51) Int. Cl. G06Q 30/02; G06Q 30/0601

(52) U.S. Cl. CPC G06Q 30/02; G06Q 30/0631

(57) ABSTRACT

A system and method are provided for providing dynamic primary validated data of consumers wishing to purchase products. The system includes, in part, a user interface for receiving future intent to purchase data for one or more products, the future intent to purchase data for each product being associated with a particular one of one or more registered consumer users of the system, and data storage for storing recent and current consumption data relevant to prior purchases of products of the particular one of the one or more registered consumers. The system further includes a processor for processing the recent and current consumption data and the future intent to purchase data to determine whether the registered consumer has indeed purchased the products identified in the future intent to purchase data, and for generating a data value score in accordance with this determination.

### CROSS-REFERENCE TO RELATED APPLICATIONS

This application claims the benefit of US Provisional Patent Application Serial No. 63/783,107, filed Apr. 3, 2025 to Fedele et al., titled “System and Method for Empowering Consumption”, to US Provisional Patent Application Serial No. 63/804,370, filed May. 12, 2025 to Fedele, et al., titled “System and Method for Valuing Demand”, and US Provisional Patent Application Serial No. 63/972,575, filed Jan. 30, 2026 to Fedele, et. Al., titled “System and Method for Maximizing the Value of Consumption Data”, the contents of each of these applications being incorporated herein by reference.

### DEFINITIONS

Definitions:
“Business Consumers” comprise businesses, institutions, and public entities, and the like that buy products and services for their businesses provided by Original Sources.
“Consumption” comprises Individual Consumers and Business Consumers.
“Data as a Service” (DaaS)” comprises providing anonymized aggregated Consumption and other data to Data Purchasers.
“Demand as Service” (DaS)” comprises providing personalized primary, entity level Consumption Data to Data Purchasers.
“Data Purchasers” comprise one or more entities wishing to acquire data from Consumption.
“Data Sellers” comprise Consumption wishing to sell their data to one or more Data Purchasers.
“Dynamic Primary Validated Data” comprises Recent and Current Consumption Data and Future Intent to Purchase Data (preferably including but not limited to personal and/or business interest, intent, transactional, geographic, demographic, psychographic, behavioral, and other data), that is then validated and rated through evidence of subsequent consumption behavior.
“Data Value Score” comprises a score indicative of a correlation between Future Intent to Purchase Data and Recent and Current Consumption Data.
“Future Intent to Purchase Data” comprises data provided by Consumption on one or more goods or services they intend to purchase in the future.
“Gross Merchandise Value” comprises a total cost paid by Consumption, including goods cost and any intermediary storage and/or transportation charges. “Individual Consumers” comprise one or more individual, family units, or groups of individuals who buy products and services to utilize and consume that are provided by Original Sources.
“Original Sources” comprise any corporate entity or individual that is the last point of value creation for products or services that are ready for Consumption to consume and utilize, comprising manufacturers, OEMs, and the like.
“Recent and Current Consumption Data” comprises data provided by Consumption on one or more goods or services that they have actually purchased.
“Procurement as a Service” (PaaS) comprises providing full procurement and delivery processes for Business Consumers.
“Supply Chain as a Service” (SaaS) comprises providing full procurement and delivery processes for Individual Consumers.

### BACKGROUND OF THE INVENTION

Individuals and businesses generate and hold significant amounts of personal and confidential data related to their purchasing of goods and services. This data is well known to be very valuable to many in the marketplace, including original sources of goods and services and intermediaries who accumulate such data, and not to mention the advertisers, online Internet service providers, and the like. It is patently unfair to the individuals and businesses who own this data that these entities are able to monetize this private data without compensating the individuals and businesses that own it.

When considering the purchase of goods and services, prospective Consumption enjoys searching for and acquiring goods and services through the Internet, or in brick and mortar stores. However, purchasing through the Internet has proven to be fraught with challenges. First, Consumption is not able to readily confirm that they are receiving the best price or quality for goods and services they are seeking to purchase. While they can search across multiple websites, it is often difficult to make direct comparisons. Consumption also may not be sure that the goods and services they purchase are appropriate to meet their particular wants, needs, and desires. Consumption acquires a wide array of items on a regular basis and cannot be experts in every category or have the technical knowledge in each category to conduct a proper search, or otherwise evaluate each and every product. As such, Consumption is often unaware of what may be the best product or service for them among the various options presented in the market and can be adversely influenced to purchase goods and services that benefit the retailer and the search platform/engine more than themselves. Additionally, data and personal privacy is always a problem online, as evidenced by the ever-increasing number of new data privacy regulations being promulgated around the world and the vast number of data breaches that occur with regularity. While these data privacy regulations typically indicate what a data controller or data processor must do in order to safeguard collected personal information, Consumption must still provide personally identifiable information to online providers in order to use the Internet to search for information, interact with suppliers of goods and services, and purchase those goods and services. This personal and distinct data (including but not limited to geographic, demographic, psychographic, behavioral and intent data) may be subject to a breach or simply used by recipients in a way that benefits themselves, not Consumption (data provider), but rather the seller or provider of goods and services. Finally, Consumption currently does not have the means to directly leverage the value of their data to improve the pricing of any of the goods and services they may be interested in purchasing.

Additionally, suppliers and Original Sources of goods and services are not always sure and/or incentivized to determine which goods or services best align with specific individual Consumption wants, needs, and desires, and what optimal production requirements might be for their various products or services in the absence of such insights (the “Bullwhip Effect”). Suppliers and other Original Sources of goods and services spent over $34 trillion in 2024 globally in an effort to determine the “who, what, where, when, why and how” of Consumer purchasing (in others words ‘Demand’) with this cost being directly passed on to those same Consumption. Furthermore, there are other costs are passed on to Consumption, including sums paid for multiple levels of distribution, warehousing, transportation, slotting, merchandising, sales allowances retail media fees, multiple tiers of demand reaggregation, customer service, and multiple financial layers of credit and working capital financing, all of which can eat up to 70% of every Consumption dollar paid. All of these costs, in turn, significantly reduce profits that could alternatively be provided to Original Sources and/or reduce costs to Consumption. It would therefore be beneficial to provide a solution that overcomes the drawbacks of the current big box “retail” Internet and big box brick and mortar sales models.

### SUMMARY OF THE INVENTION

In US Patent Application Serial Nos. 13/372,324 (Now US Patent No. 8,666,791; 17/147,390 (Now US Patent No. 11,734,450); 18/217,581 (Now US Patent No. 12,039,083); 18/742,385; 17/147,395 (Now US Patent No. 12,339,998); 17/147,399; 17/147,402, and 18/742,385, the text of these applications and patents being incorporated herein by reference, Applicant has presented a number of systems and methods for supporting Individual Consumers, Business Consumers, and other components of Consumption, purchasing of goods and services via the Internet and brick and mortar. The current disclosure and invention expand on these prior applications and patents to address additional purchasing and data uses that further increase Consumption’s ability to monetize its private data and intent and receive goods and services that meet purchaser wants, needs, and desires at a materially more concise match to their particular want, need and desire, and extremely relevant reduced cost.

The inventive (“DemanData™”) solutions are applicable in three main areas: 1) Individual Consumer purchases of goods and services and monetization of their Past Consumption Data and Future Intent to Purchase Data in the form of further discounts ; 2) Business Consumer purchases of goods and services and monetization of their Past Consumption Data and Future Intent to Purchase Data in the form of further discounts; and 3) monetization through sale of Consumption’s historical and their Past Consumption Data and Future Intent to Purchase Data via a DemanData facility known as “DataBank™.” In each of these main areas, DemandData removes the unnecessary additional costs from the purchase exchange and enables Consumption to monetize its data with Original Sources, reaping significant rewards and increasing discounts and cash on goods and services they wish to purchase, and also allowing for the sale by Consumption of this data to one or more Data Purchasers.

The DemanData consumer solution enables Individual Consumers to purchase any goods and services directly from Original Sources in all market verticals, thereby eliminating middlemen and all of their costs (including gross profits, distribution costs, etc.) and realizing savings on those goods and services being purchased. With DemanData, Individual Consumers can save significantly if they want or need their goods immediately and can save even more if

they are willing to wait for 30 or more days for their goods to be delivered. Indeed, savings on the multiple trillions of dollars spent by Individual Consumers each year can be as much as 30% for purchases requiring immediate delivery and up to 50% if the Individual Consumers can wait 30 or more days. This new, inventive purchasing schema allows the demand from Individual Consumers to be provided to Original Sources, creating a novel system of ‘Demand and Supply’ where demand drives supply Additionally, Individual Consumers are empowered to sell their Past Consumption Data and Future Intent to Purchase Data (including but not limited to: geographic, demographic, psychographic, behavioral data and future intent data) to provide additional insight to Original Sources of those goods and services. This process provides benefits to both the Individual Consumers and the Original Sources, thus resulting in the creation of a proprietary system of “Supply Chain as a Service” (SaaS).

The DemanData business solution enables Business Consumers to acquire goods and services on which they currently spend trillions of dollars each year at a savings of up to 50% based on entry into a managed direct relationship with Original Sources, thus avoiding all intermediate distribution, storage, inventory imbalances, and other middleman costs. DemanData’s proprietary process of “Procurement as a Service” (PaaS), preferably aggregates each Business Consumer’s utilization rates of their consumption of goods and services by analyzing their two immediately prior years of history (although any number of years may be utilized) including product utilization rates, current purchase requirements, and preferred delivery timing. This information is then aggregated with the needs of other Business Consumers in the same geographic area to enable the contract manufacture of such goods and services by an appropriate Original Source. This process eliminates all middlemen and their redundant non-value-added costs, resulting in a significant savings of as much as 50% of what they currently pay for such goods and services for all participating Business Customers. This Procurement as a Service process facilitates “manufacture to order” which has long been the ‘Holy Grail’ for Original Sources. The DemanData business solution manages just-in-time delivery by consolidating ordering and delivery across multiple Business Consumers in geographically common markets. As with Individual Consumers, Business Consumers provide their Past Consumption Data and Future Intent to Purchase Data to Original Sources, setting up a similar dynamic of demand driving supply, and reaping savings of up to 50% of the standard purchase price in exchange for that data.

The DemanData DataBank solution enables disintermediation of the traditional data supply chain by empowering Consumption to monetize their own personal and/or business Dynamic Primary Validated Data, enabling them to sell it directly to Data Purchasers such as Original Sources, financial institutions, hedge funds, brands, banks, AI companies, venture capitalists, and others. Consumption is thus able to monetize its Dynamic Primary Validated Data by selling it directly to Data Purchasers who are then able to provide customized financial incentives and offers directly to Consumption. Consumption seeking to monetize their Dynamic Primary Validated Data through its sale to Data Purchasers have a large incentive to maximize the value of that data by proving their reliability in estimating their consumption interest and purchase intent and having it validated and rated through their subsequent consumption behavior (i.e. Consumption is asked to predict what they will purchase and then have that intent confirmed based upon their actual subsequent purchases). Data Purchasers seek to find reliable data with the highest level of accuracy and, most importantly, reliability. The most accurate and reliable data set, by leaps and bounds, is Dynamic Primary Validated Data from Consumption that is generated and confirmed in accordance with one or more embodiments of the present DemanData invention.

Implementation of the DemanData DataBank solution preferably includes two proprietary processes called “Data as a Service” (DaaS) and “Demand as Service” (DaS). In accordance with the Data as a Service inventive offering, Data Sellers may consent to the sale of their anonymized and aggregated Dynamic Primary Validated Data, and may further agree to sell their fully anonymized profile data through a blanket agreement that may consolidate such data from multiple Individual Consumers or Business Consumers to provide a dataset of interest to one or more Data Purchasers. For these Data Purchasers, the type of data sought may vary. For example, a hedge fund may choose aggregated anonymized data sets for rapid analysis or opt for anonymized individual-level information on a specific market segment for deeper, proprietary analysis. Alternatively, AI companies using such data to assist in training their LLMs, for example, may rely on the most accurate consumer data in order to expedite the training of their models and improve accuracy thereof. Other potential Data Purchasers may have similar intentions when acquiring Dynamic Primary Validated Data from DemanData.

In accordance with the Demand as Service offering, alternatively, Data Sellers can selectively consent to sell their personally identifiable information, in addition to their Dynamic Primary Validated Data to Data Purchasers on a case-by-case basis in exchange for direct payments or discounted product or service purchase offers. These Data Purchasers can engage directly with the Data Sellers to offer these direct payments, or alternatively goods and/or services at extreme discounts, to these Data Sellers. For example, an Original Source might seek direct access to Individual Consumers or Business Consumers with a high intent to purchase goods or services they provide, and purchase data that reveals the intent of each such potential customer, thus providing a way to reach these Individual Consumers and Business Consumers to make relevant attractive offers for their data through the DemanData system.

The DemanData solutions and processes rely on a number of fundamental Artificial Intelligence (AI) applications (and/or agents) that process data in a unique manner and are able to be combined in various constructs in order to provide desired outputs to Consumption, Data Purchasers, and other users, as will be described in greater detail below.

In addition to the data purchasing scenarios noted above, the DemanData solutions taken as a cohesive group, also address a number of drawbacks associated with current standard, generic data acquisition typically employed for AI model training and processing. While data used to train and validate generic AI processing models is typically a combination of data secured from different sources with unknown accuracy that is stitched together to create a new dataset, the DemanData solution provides more accurate and reliable Dynamic Primary Validated Data that is sourced directly from Individual Consumers and Business Consumers. This Dynamic Primary Validated Data, comprising primary want, need, desire, and intent data, provided directly by these sources is significantly more indicative of future purchase plans than aggregated third-party data, as the Dynamic Primary Validated Data is validated by subsequent actual purchase confirmation and evidence.

Indeed, a number of the DemanData solutions and processes encapsulated in the present invention rely on this same Dynamic Primary Validated Data that Data Purchasers can buy. Using this data as input, the DemanData processing relies on Past Consumption Data and Future Intent to Purchase Data with dramatically increased accuracy and reliability. While generic AI processing typically relies on a combination of data obtained from different sources in addition to machine generated (synthetic data), such generic AI processing suffers from a lack of ability to differentiate between machine generated data and data that is produced naturally through human interaction. Model collapse may occur as a result of the system simply running out of data (excluding synthetic data) on which it can be trained or may similarly collapse as the quality of live or synthetic data degrades. Also, the accuracy of the models may diminish when unknown scenarios are encountered.

In the DemanData solutions Past Consumption Data and Future Intent to Purchase Data that is human-generated, and including individualized source tags, is preferably leveraged during implementation. Additionally, updates to the Dynamic Primary Validated Data are applied continuously from the DemanData user community when Consumption updates their Future Intent to Purchase Data and then validates their purchases through evidence of their subsequent consumption behavior related to their most recent purchases, models are trained on this updated data and therefore remain most relevant to encounter new scenarios and situations. This allows the DemanData Solutions to provide the most accurate offers to purchase goods and/or services, including recommendations based upon the wants, needs, and desires of Consumption, can be presented to those participating Individual Consumers and Business Consumers.

Finally, in generic AI processing scenarios, outputs produced from one model are often provided as an input to the next model, thereby resulting in data pollution through successive generations of execution. This presents a danger for potential replication and amplification of mistakes over time in multiple models as they continue to learn from each prior generation. Because the DemanData solution always operates based on current, Dynamic Primary Validated Data provided by Consumption, updated verified and validated data is used for each successive generation of the DemanData models. Additionally, generic AI processing also suffers from a lack of data quality, rules, and standardization, causing the frequent production of inconsistent results. Furthermore, due to the unavailability of an authoritative source of the data, models that leverage generic AI lack transparency and explainability. In contrast, the DemanData solutions leverage and provide auditability into a consistent set of data quality rules and standards that are applied across the architecture, and tags source information for the data to assure transparency and explainability.

### BRIEF DESCRIPTION OF DRAWINGS

The invention will be described making reference to the drawings, in which:

FIG. 1 is a flowchart diagram depicting the pricing of a good through a legacy Individual Consumer supply chain;

FIG. 2 is a flowchart diagram depicting an improved, significantly more efficient and materially less expensive Individual Consumer supply chain in accordance with an embodiment of the invention;

FIG. 3 is a flowchart diagram depicting an improved, significantly more efficient and materially less expensive Individual Consumer supply chain in accordance with an additional embodiment of the invention;

FIG. 4 is a flowchart diagram depicting Individual Consumer interaction with the DemanData Consumer system in accordance with an embodiment of the invention;

FIG. 5 is a flowchart diagram depicting the pricing of a good through a legacy Business Consumer supply chain;

FIG. 6 is a flowchart diagram depicting an improved, significantly more efficient and materially less expensive Business Consumer supply chain in accordance with an embodiment of the invention;

FIG. 7 is a flowchart diagram depicting a Business Consumer interaction with the DemanData business system in accordance with an embodiment of the invention;

FIG. 8 is a flowchart diagram depicting an improved process for Data Sellers to sell and monetize their Dynamic Primary Validated Data by disintermediating the data supply chain in accordance with an embodiment of the invention;

FIG. 9 is a flowchart diagram depicting processing of Dynamic Primary Validated Data to generate a Data Value Score in accordance with an embodiment of the invention;

FIG. 10 is a flowchart diagram depicting more detailed description of implementation of the Data Value Score in accordance with an embodiment of the invention;

FIG. 11 is a flowchart diagram depicting a process and system for allowing Consumption to monetize their Future Intent to Purchase Data, Recent and Current Consumption Data, and other data in accordance with an embodiment of the invention;

FIG. 12 is a flowchart diagram depicting a Data Seller’s interaction with the DemanData DataBank system in accordance with an embodiment of the invention;

FIG. 13 is a flowchart diagram depicting a high-level system architecture drawing constructed in accordance with an embodiment of the invention;

FIG. 14 is a flowchart diagram depicting a personalized content AI application in accordance with an embodiment of the invention;

FIG. 15 is a flowchart diagram depicting additional features of the personalized content AI application of FIG. 14 in accordance with an embodiment of the invention;

FIG. 16 is a flowchart diagram depicting a use case for the application of personalized content in accordance with the embodiment of FIGS. 14 and 15 of the invention;

FIG. 17 is a flowchart diagram depicting the use of a personalized content system to provide personalized product recommendations accordance with an embodiment of the invention;

FIG. 18 is a flowchart diagram depicting additional features of the use of the personalized content system of FIG. 17 in accordance with an embodiment of the invention;

FIG. 19 is a flowchart diagram depicting a use case for the application of personalized content in accordance with the embodiment of FIGS. 17 and 18 of the invention;

FIG. 20 is a flowchart diagram depicting use of a personalized marketing system in accordance with an embodiment of the invention;

FIG. 21 is a flowchart diagram depicting a use case for the application of the personalized marketing system of FIG. 20 in accordance with an embodiment of the invention;

FIG. 22 is a flowchart diagram depicting Expert Advisor in accordance with an embodiment of the invention;

FIG. 23 is a flowchart diagram depicting a further implementation of Expert Advisor in accordance with an embodiment of the invention;

FIG. 24 is a flowchart diagram depicting management of communities in accordance with an embodiment of the invention;

FIG. 25 is a flowchart diagram depicting further management of communities in accordance with an embodiment of the invention;

FIG. 26 is a flowchart diagram depicting a use case for the application of dynamic communities in accordance with an embodiment of the invention;

FIG. 27 depicts a preferred group of standard AI algorithms in accordance with an embodiment of the invention;

FIG. 28 depicts a subset of business functions and AI Algorithms that are preferably applied across all application areas in accordance with an embodiment of the invention;

FIG. 29 depicts a subset of business functions and AI Algorithms that are preferably applied to the application area for direct to consumer purchasing by Individual Consumers in accordance with an embodiment of the invention;

FIG. 30 depicts a subset of business functions and AI Algorithms that are preferably applied to the application area for direct to direct to business purchasing by Business Consumers in accordance with an embodiment of the invention;

FIG. 31 depicts a subset of business functions and AI Algorithms that are preferably applied to the application area for DataBank in accordance with an embodiment of the invention; and

FIG. 32 discloses an Artificial Intelligence structure presented accordance with an embodiment of the invention;

### DETAILED DESCRIPTION OF THE INVENTION

In accordance with various embodiments of the invention, the term “Data Processing Apparatus” (or “Apparatus”) refers to data processing hardware and encompasses all kinds of apparatus, devices, and machines for processing data, including by way of example a programmable processor, a computer, or multiple processors or computers. The Apparatus can also be or further include special purpose logic circuitry, e.g., an FPGA (field programmable gate array) or an ASIC (application specific integrated circuit). The Apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by, and the Apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Edge or Supercomputers may also be employed, and may be based locally or in a cloud based configuration, provided by one or more cloud service providers.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD ROM and DVD-ROM disks. The processor and the memory can be supplemented by, or incorporated in, special purpose logic circuitry.

AI Agents are devised to perform a predefined category of AI processing and analysis. AI Agents may be combined together in a multi-agent scenario, thus performing the job of a single AI Agent in a more efficient fashion. Thus, reference to an AI Agent may include a single or group of AI Agents performing such function. AI Applications may perform one or more analysis functions and may provide one or more recommendations. AI Applications may be combined together in a multi-application scenario, thus performing the job of a single AI Application in a more efficient fashion.

To provide for interaction with a user, embodiments of the subject matter described in this specification can be implemented on a computer having a display device, e.g., a CRT (cathode ray tube), LCD (liquid crystal display) monitor or any display technology, for displaying information to the user and a keyboard and a pointing device, e.g., a mouse or a trackball, by which the user can provide input to the computer, mobile, or other electronic device designed to receive information input by a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page or data payload, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of any subject matter described in this disclosure or on the scope of what may be claimed, but rather as descriptions of features that may be specific to particular embodiments of the subject matter described in this disclosure. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

### System Descriptions

### DemanData Consumer

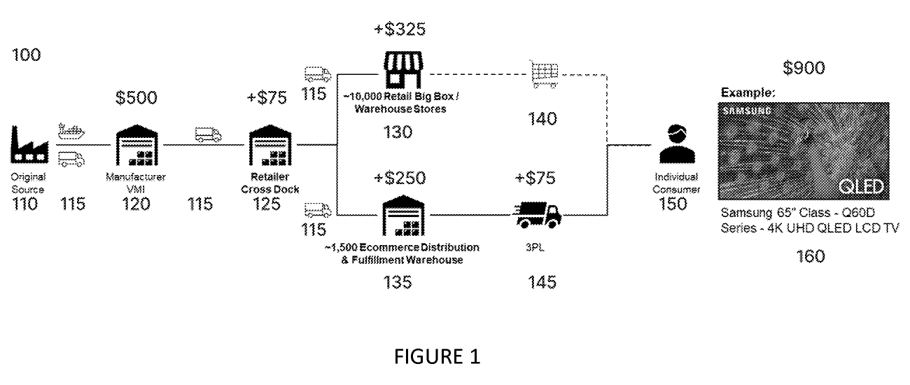

The DemanData Consumer solution allows Individual Consumers to purchase goods and services at a significant discount by allowing their personal demand to drive supply, and by eliminating any unnecessary cost in a new, disintermediated supply chain. Referring to FIG. 1, an example of pricing of a good through a legacy supply chain 100 is depicted. In legacy supply chain 100, an Original Source 110 manufactures one or more goods 160 (in this example, a television) or services for ultimate consumption by Individual Consumers. These goods are then shipped via boat, truck, train, or other commercial transport 115 to one or more Manufacturer VMI (Vendor Managed Inventory) Warehouses 120 which operate in a number of convenient locations throughout the country and, in this example, carry a price of $500. Goods are shipped o and stored in these VMI warehouses well in advance of purchase by the ultimate Individual Consumer, and thus the manufacturers must “guess” well ahead of time what goods to produce and in what volumes based upon typically inaccurate data.

After being received, cataloged, and stored in VMI warehouse 120 from which they will be further distributed (potentially to additional VMI warehouses in the delivery process), these goods are again transported via transport 115 to one or more retailer cross docks 125 where the goods are once again received, cataloged, and stored at that location at an additional cost of $75. Later, the goods are transported via transport 115 to one of 10,000 retailer or big box retailers 130 or ecommerce distribution and fulfillment warehouses 135. The goods are once again received, cataloged, and stored at each of those locations at an additional cost of $325 when sent to retailer or big box retailers 130 or at an additional cost of $250 when sent to ecommerce distribution and fulfillment warehouses 135. When stored and/or shelved at one of the retail or big box stores 130, these goods are maintained waiting for an Individual Consumer 150 to visit the store and place the goods into a shopping cart 140 to make a purchase. Alternatively, when stored at an ecommerce distribution and fulfillment warehouse, Individual Consumer 150 may order one of the goods online or through other purchasing means, and that good would be shipped to Individual Consumer 150 via a 3PL 145 at an additional cost of $75. As is clear, each of the steps in FIG. 1 adds cost to the overall current supply chain, and effectively increases and diverts the price paid by Individual Consumer 150 from Original Source 110 to the providers of the intermediary steps such that the initial $500 good ends up costing Individual Consumer 150 $900 in this particular example and Original Source 110 only receives $500 of the amount actually paid by Individual Consumer 150.

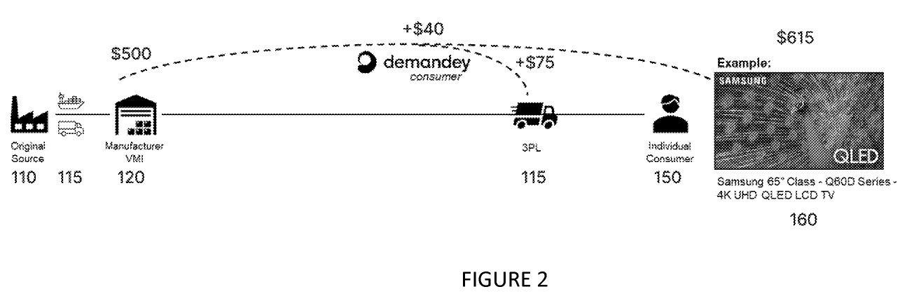

In accordance with an embodiment of the invention, FIG. 2 depicts an alternative, significantly more efficient and materially less expensive supply chain. As is shown in FIG. 2 Original Source 110 still ships goods 160 with a price of $500 to VMI Warehouse 125 via transport 115. However, the next steps comprise Individual Consumer150 ordering a good via the DemanData platform, and that good being delivered directly from the VMI 120 to Individual Consumer 150 via a single 3PL 115 at a cost of $75. The DemanData system provides this system to Individual Consumer 150 at a cost of $40 (preferably calculated as a percentage of an amount paid by Individual Consumer 150 for the price of the good 120 and 3PL shipping 115), thus saving the costs associated with the reduced multiple intermediate steps as shown in FIG. 1 and resulting in a final cost of $615 to Individual Consumer150.

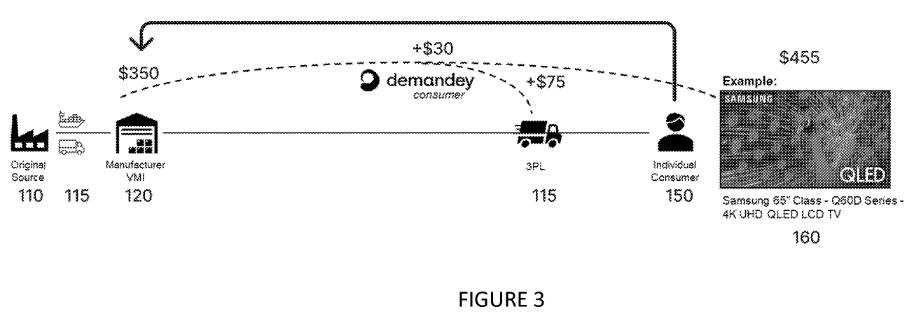

As is next shown in FIG. 3, if Individual Consumer 150 is willing to wait for 30 days to receive their goods, additional savings may be available. Thus, instead of Original Source 110 shipping goods to VMI 120 without an indication that the goods will ever be purchased, consumer 150 first purchases the goods before manufacture. Manufacturer 110 is then able to produce the goods during a time of excess capacity, or in other batch manufacture process that is more efficient and less costly, in this example, $350. In one embodiment the goods are then shipped to VMI 120 via shipping 115, and then the goods are shipped directly to consumer 150 via 3PL 115 adding $75 to the cost for consumer 150. After the DemanData fee 7% of the $425 cost (or $30), the price paid by consumer 150 is $455. Thus, an additional savings of approximately 20% or more may be enjoyed by consumer 150. In a further alternative embodiment, it may also be possible to avoid 3PL 115 charge as the goods may be shipped directly transferred to customer 150 with only one shipping step. In this scenario, cost would be reduced even further.

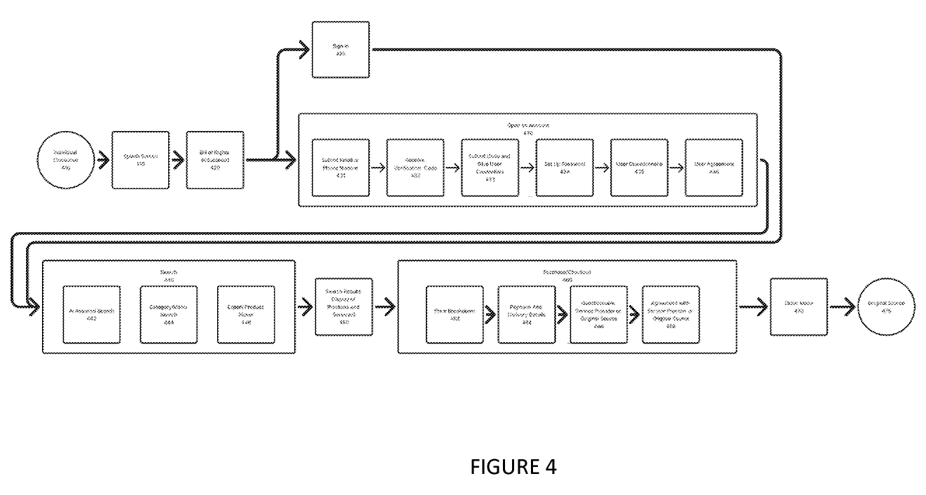

Individual Consumer interaction with the DemanData Consumer system will now be described, making reference to FIG. 4. As is shown in FIG. 4, an Individual Consumer 410 first enters the DemanData system via any web browser or other Internet access system. A splash screen 415 is shown to Individual Consumer 410, followed by a consumer Bill of Rights 420 laying out all of the rights Individual Consumer 410 will gain and preserve while using the DemanData system. DemanData promises the following for each and every Individual Consumer using the system:
The DemanData system enables the Individual Consumer to buy direct from original sources, allowing the Individual Consumer to save 30-50% on the same products and brands the Individual Consumer buys today.
DemanData empowers the Individual Consumer to monetize their personal data within the marketplace, by enabling the Individual Consumer to sell their data directly to Original Sources in exchange for receiving 30 to 50% savings.
DemanData exclusively represents the Individual Consumer. The DemanData fee is just 7% of the Gross Merchandise Value the Individual Consumer. DemanData keeps the Individual Consumer anonymous and will never sell the Individual Consumer’s data to anybody. The Individual Consumer’s data is only used to give the consumer the best potential product recommendations. The DemanData Consumer system, however, also enables the Individual Consumer to monetize their data, supporting the sale of their data to Original Sources.
Everywhere the Individual Consumer currently shops, their data makes other people money. The DemanData Consumer system empowers the consumer to use their data to save money (and in the case of DataBank, as will be described below in greater detail) actually get cash for their Data.
Once the Individual Consumer is completely satisfied with their purchase, DemanData collects its 7% fee and the Individual Consumer still saves 30-50%.

If Individual Consumer 410 has previously registered with the DemanData system, processing proceeds at 425 where Individual Consumer 410 logs into their DemanData account. If, in the alternative, after step 420 Individual Consumer 410 has not previously registered with the DemanData system, processing instead proceeds at 430 where Individual Consumer 410 opens an account. This account opening includes steps such as submitting an email at 431, receiving a verifications code at 432, submission of the received verification and other user credentials at 433, and password setup at 434. Processing then continues at 435 where Individual Consumer 410 is provided with an introductory questionnaire to complete so that the DemanData system may provide the best, most accurate information to Individual Consumer 410. The questionnaire is preferably generated based upon an AI analysis of all of the Original Sources that may participate on the DemanData system. These sources preferably indicate one or more parameters defining one or more categories of Individual Consumers they wish to address. These categories may include high intent to buy, medium intent to buy, and low intent buy, or may include any other valuable categories. An inventive AI agent may perform an analysis across all of these Original Sources and generate one or more sets of generic questions to be asked of one or more Individual Consumers up front. The DemanData Consumer system can set a value for each Individual Consumer 410 depending on where they fall within the categorization scheme. Individual Consumer 410 is then presented with a user agreement for review and execution at 436.

Whether Individual Consumer 410 signed into the system at 425 or opened an account at 430, processing continues at 440 where Individual Consumer 410 is able to search for one or more products or services they wish to purchase. Such search may comprise an AI Assisted search 442, a more standard Category/Menu search 444, or an interaction with an Expert Product Picker (Expert Advisor) 446, as will be described below in greater detail. Regardless of the search implementation, a list of products and/or services comprising the search results are displayed to Individual Consumer 410 at 450 via a display associated with the app or web rowser or other Internet access system relied upon by Individual Consumer 410 to access the DemanData system. Such results include not only product information and pricing, but also pricing at other popular shopping sites so that Individual Consumer 410 is able to confirm the significant discounts they are receiving by using the DemanData system.

Individual Consumer 410 is then able to select one or more products and/or services for purchase, where processing then passes to 460 for purchase and checkout. The purchase and checkout processing further comprises provision of a price breakdown 462, preferably showing precisely how much an Original Source 475 is being paid, how much of the purchase price is dedicated to shipping of the product to Individual Consumer 410, how much is dedicated to taxes, etc. and finally the fee payable to the DemanData system. At 466 a second, product specific questionnaire may be presented to Individual Consumer 410 querying their journey to purchasing that particular product, including when, where, why, how, and other relevant questions as defined by Original Source 475 pertaining to the particular purchase. In this embodiment of the invention, providing responses to this questionnaire may be mandatory in order to receive the discounts that Individual Consumer 410 has been promised, thus the “monetization of their data.” Finally, an agreement regarding the purchase is entered into between Original Source 475 and Individual Consumer 410 outlining the terms of the sale. Once checkout is completed, processing passes to 470 to confirm that the order has been completed, and the order details are then passed to Original Source 475 to provide the goods at 475 according to the terms of the order, (i.e. immediate delivery or 30 day delivery, etc. as describe above).

### DemanData Business

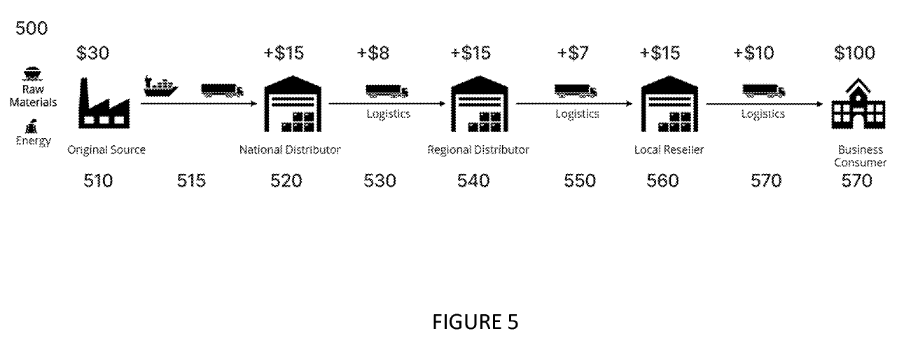

The DemanData Business solution allows Business Consumers to purchase goods and services at a significant discount by allowing these Business Consumers to order goods directly from the Original Source, and allowing these goods to be combined for delivery to multiple Business Consumers located in similar geographic locations, thus resulting in reduced manufacturing and delivery costs. Demand drives supply, as in the above consumer solution, by eliminating any unnecessary costs in a new, disintermediated supply chain. Referring to FIG. 5, a legacy supply chain 500 is depicted. In this example, an Original Source 510 first produces one or more goods for the marketplace at a cost of $30 per good, and these goods are then shipped to a national distributor 520 via a shipping provider 515 at a cost of an additional $15. Logistics rovider 530 is then employed at an added cost of $8 to ship those goods to a regional distributer 540 at an additional cost of $15. These same goods are then shipped via another logistics provider 550 at a cost of $7 to a local reseller 560 with an added cost of yet another $15. Finally, yet another logistics provider 570, at a cost of $10, delivers the goods to a Business Consumer (institution) 580 purchasing the goods at a total cost to Business Consumer 580 of $100. Thus, the supply chain ate $70 out of the $100 paid by Business Consumer 580.

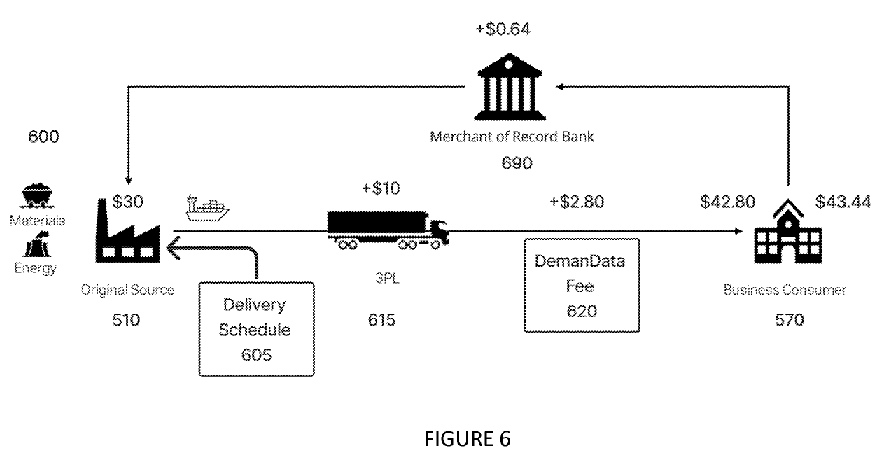

Referring next to FIG. 6, an improved, inventive institutional supply chain 600 is depicted. This new supply chain assumes the implementation of the DemanData business solution in that the first step requires Business Consumer 570 to provide data in advance to the DemanData system so that the DemanData system can provide an advance purchasing schedule to an Original Source 510 for delivery to Business Consumer 570 (for a made to order manufacturing process, vs made to stock for all existing antiquated supply chains that exist today). Thus, processing starts at step 605 with a provision of a goods delivery schedule to Original Source 610 from the DemanData system, that schedule being generated in a manner as will be described below. Once produced in accordance with the delivery schedule for $30, the goods are delivered to Business Consumer 570 via a 3PL provider 615 at an added cost of $10. Additional costs associated with the system include a DemanData fee 620 equal to 7% of the Gross Merchanidse Value for Business Consumer 570, in this example, $2.80. This results in a final purchase price of $42.80 for Business Consumer 570. In an additional embodiment of the invention, in order to allow Business Consumer 570 to pay according to more standard payment terms of approximately 30-45 days, but allowing Original Source 510 to be paid on an accelerated basis in fewer than 15 days, a merchant of record bank 690 preferably pays Original Source 510 and charges Business Consumer 570 a small fee of 1.5% per month. In this example, this fee for one month would come to $0.64, bringing the total cost for Business Consumer 570 to $43.44. This system overall saves Business Consumer 570 from 40%-60% while ensuring Original Source 510 is paid the same fee for their goods, and in a timeframe short enough to avoid any factoring or working capital financing costs on their end.

The improved, inventive institutional supply chain shown in Figure six provides the following benefits:
Physical
Made-to-order manufacturing efficiency
Single 3PL direct delivery from Original Sources to Business Consumers
Disintermediates all legacy supply chain redundant, non-value added inventory, shipping and handling
Financial
Single supplier of credit with lowest direct cost of capital funding AAA rated Business Consumers
Disintermediates all legacy supply chain working capital financing and credit risk functions and cost
Data
Dramatic transparency and efficiency to the end-to-end demand aggregation and demand forecasting
Professional procurement and customer service leveraging data and insights
Disintermediates all legacy supply chain sales and marketing and profit margin

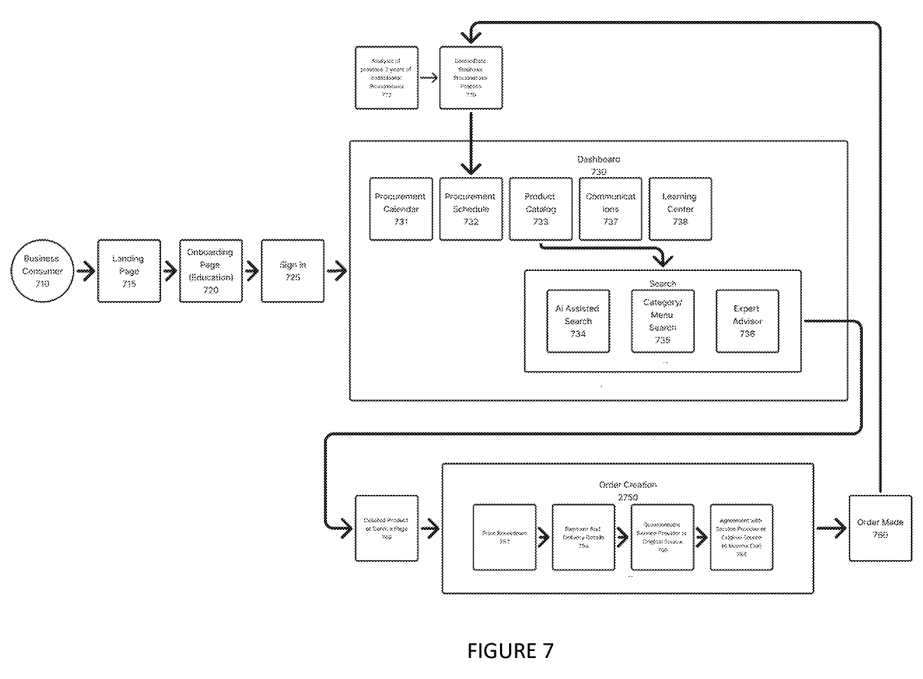

Business Consumer interaction with the DemanData business system will now be described, making reference to FIG. 7. As is shown in FIG. 7, a Business Consumer user 710, representing a particular institution, business, government entity, or the like first enters the system at 710 via any web browser or other Internet access system. Business Consumer user 710 is then presented with a landing page 715 and then onboarding page 720 including educational materials about the use of the DemanData business system. Business Consumer user 710 then signs in at 725. Business Consumer user 710 preferably does not have to register as they will have been authorized, credentialed, and pre-registered by the Business Consumer institution. Once confirmed that Business Consumer user 710 has previously entered the system, educational onboarding page may be skipped when Business Consumer user 710 re-engages with the DemanData business system.

Once logged in, Business Consumer user 710 is presented with a dashboard 730 presenting various functions to Business Consumer user 710. Business Consumer user 710 may interact with a procurement calendar 731 showing in a calendar view when goods or services are to be delivered to the Business Consumer with which Business Consumer user 710 is associated. Business Consumer user 710 may alternatively view upcoming deliveries in a schedule rather than the calendar view at 732. Procurement schedule 732 is preferably generated during a DemanData Business Procurement Process 770 in which a predetermined timeframe of institutional procurement for the Business Consumer is analyzed at 772. In a preferred embodiment, a prior two years of procurement is analyzed, but any appropriate timeframe may be utilized. It is anticipated that all significant procurement categories will be analyzed, but in the event there is one or more categories that have not previously been analyzed, or the Business Consumer has a need for procurement of new goods or services, DemanData Business Procurement Process 770 may be reinitiated at any time. During DemanData Business Procurement Process 770, DemanData interacts with one or more Original Sources to determine and schedule deliveries to the business user based upon order quantity, delivery frequency, proximity to other business users purchasing the same goods or service, and other details to ensure a lowest price and on-time delivery by one or more 3PLs. This process at 770 then feeds automatically into the procurement schedule 732 so Business Consumer user 710 is able to view upcoming procurement, preferably for at least the next six months. This analysis and procurement process may take place in advance of any purchasing for Business Consumer user 710 for one or more, or all products available to be sold to the Business Consumer. Alternatively this process may take place for a particular class or type of good initially, and then additional goods or services may be analyzed and added to the procurement calendar at a later date.

Even if multiple categories of goods have been evaluated during Demandey Business Procurement Process 770, it is possible that the Business Consumer has not initially agreed to purchase goods in all analyzed categories. In such a situation Business Consumer user 710 is also preferably presented with a product catalog 733 that may include one or more of the goods that have been analyzed but not yet requested to be purchased by the Business Consumer. Thus, Business Consumer user 710 may be able to indicate from product catalog 733 a desire to purchase one or more of these additional goods. Although Business Consumer 710 may make such a request, processing must be initiated by the DemanData team to analyze other geographically local business, availability of shipping availability, and ability of the Original Source providing the requested good to meet a desired delivery schedule. Thus, and such request to add goods would preferably be analyzed as if the Business Consumer were a new Business Consumer as related to that new good and would have to be fully evaluated to fit within the supply chain. Business Consumer user 710 is further potentially provided with one or more communications via a communications module 737, and a learning and help center 738. Product catalog 733 preferably may comprise an AI assisted search module 734, a category/menu search module 735, and access to an expert advisor module 736 (described in greater detail below) to assist Business Consume User 710 to select from any additional available goods or services. Each of these modules therefore assists Business Consumer user 710 in searching for products for which they wish to purchase via the DemanData Business platform.

Once Business Consumer user 710 has performed a search and selected a particular product they wish to purchase, after a proper analysis performed by the DemanData team and it is determined that the Business Consumer is able to begin procurement of the newly-requested good or service, processing continues and a detailed product or service page 740 is displayed corresponding to the user-requested product or service. This detailed product page 740 preferably provides all information about the selected product or service so Business Consumer user 710 can make a decision about purchasing this product and preferably includes a price comparison between the DemanData Business platform price and the price from more traditional retailers from which Business Consumer user 710 may have purchased these goods or services in the past. Processing then passes 750 and an order is created. Order creation 2950 preferably includes a price breakdown 752 showing pricing for quantities, etc. of the particular goods and/or services, a payment and delivery details module 754, a second, product specific questionnaire at 756 from the Original Source of the good or service may be presented to Business Consumer user 710 querying their journey to purchasing that particular product, including when, where, why, how, and other relevant questions as defined by the Original Source pertaining to the particular purchase. Finally at 758, Business Consumer user 710, on behalf of their Business Consumer, enters into an agreement with the Original Source of the goods or services, preferably for delivery of the goods or services in the future, and more preferably approximately six months in the future to allow for production of the goods and/or organization of delivery of the services to allow for best pricing. Then, at 760 the order is confirmed. After confirmation, it is possible for Business Consumer user 710 to request a new DemanData Business Procurement Process 770 to analyze a new good or service the Business Consumer may wish to purchase in the future.

The DemanData Business system therefore allows a Business Consumer to order goods or services in advance (made to order), in bulk, directly from one or more Original Sources. These goods or services may be combined with orders from other Business Consumers in similar geographic locations to reduce shipping and logistics costs. By providing Dynamic Primary Validated Data to the one or more Original Sources via a questionnaire about the Business

Consumer’s journey to the purchase of the particular goods or services, the Business Consumer receives the lowest price for these items, monetizing their valuable data to further reduce costs.

### DemanData DataBank

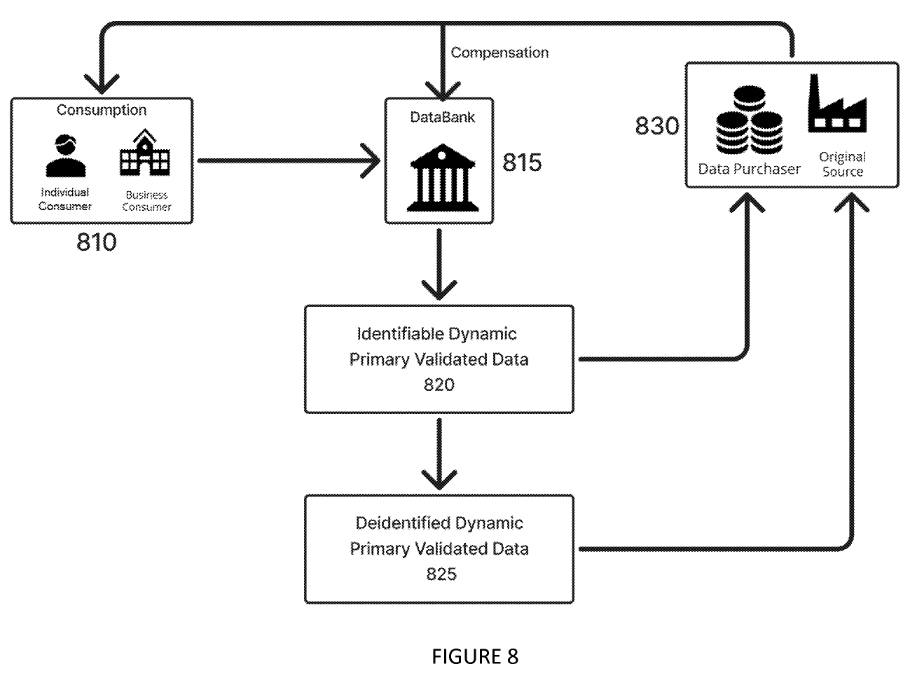

The DemanData DataBank solution allows Individual Consumers and Business Consumers (“Data Sellers”) to sell and monetize their Dynamic Primary Validated Data by disintermediating the data supply chain. As is shown in FIG. 8, Consumption 810 provide their Recent and Current Consumption Data and Future Intent to Purchase Data to the DataBank system 815 which is confirmed/validated to become Dynamic Primary Validated Data. This provided Dynamic Primary Validated Data may be consolidated as a group of Individual Consumer and Business Consumer identifiable Dynamic Primary Validated Data consumption data 820 (Demand as Service), or alternatively may be aggregated to provide aggregated, deidentified Dynamic Primary Validated Data 825 (Data as a Service) that may be used determining analytics and trends. This information may be provided to Original Sources or other Data Purchasers 830. Original Sources or other Data Purchasers 830 in turn pay compensation directly to Data Sellers 810 via the DemanData system, and DemanData DataBank takes its compensation in the form of a percentage of the compensation provided to Data Sellers 810, preferably 7% of the compensation, but any appropriate percentage or fee can be employed.

One or more of the DemanData solutions may rely on Dynamic Primary Validated Data in order to provide the best, most accurate Consumption data set for AI model training purposes and many other important uses, and for interaction with Consumption. The inventors of the present invention have determined that Individual Consumer and Business Consumer Future Intent to Purchase Data and actual follow-through may differ significantly. Thus, simply asking Consumption what they intend to purchase in the future is not sufficient as Consumption may truly believe that they will purchase a particular good or service in the future. But things may happen, tastes may change, financial situations may change, or wants, needs, and desires may change. Thus, it is necessary to validate such Future Intent to Purchase Data by comparing this data in the future with Consumption’s Recent and Current Consumption Data.

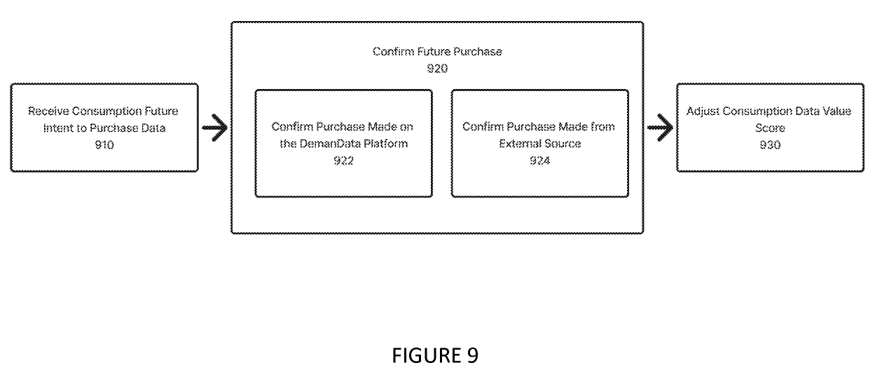

Comparison of these data sets, and thus generation and processing of such Dynamic Primary Validated Data in accordance with an embodiment of the present invention will now be described making reference to FIG. 9. As is shown in FIG. 9, a registered Individual Consumer or Business Consumer is first asked to provide their Future Intent to Purchase over the next few months (or other desirable timeframe) at step 910. This Future Intent to Purchase Data is preferably collected via a consumer portal provided to one or more registered Individual Consumers or Business Consumers on the DemanData system in a manner as will be described below. Once such Future Intent to Purchase Data is collected, Individual Consumer or Business Consumer then preferably purchases one or more of the goods indicated in the Future Intent to Purchase Data at step 920.

If the Individual Consumer or Business Consumer then subsequently makes one or more purchases of one or more of the goods or services they indicated they would purchase in their Future Intent to Purchase data via the DemanData platform, such purchase is logged in the Individual Consumer or Business Consumer user’s account at step 922. Alternatively, if the Individual Consumer or Business Consumer prefers to purchase one or more of the indicated goods or services outside the DemanData system, they are enabled to upload evidence of such purchases via an upload module preferably provided within the DemanData system. Such uploaded data is confirmed by the DemanData system, and then similarly stored associated with the Individual Consumer or Business Consumer user’s account at step 924. Processing then continues at step 930 where a Data Value Score is generated that is indicative of the accuracy of the Individual Consumer or Business Consumer’s Future Intent to Purchase Data. Purchases as compared to their Recent and Current Consumption Data. If the Individual Consumer or Business Consumer made purchases they said they would, the Data Value Score increases, while if the Individual Consumer or Business Consumer fails to make such purchases, the Data Value Score decreases.

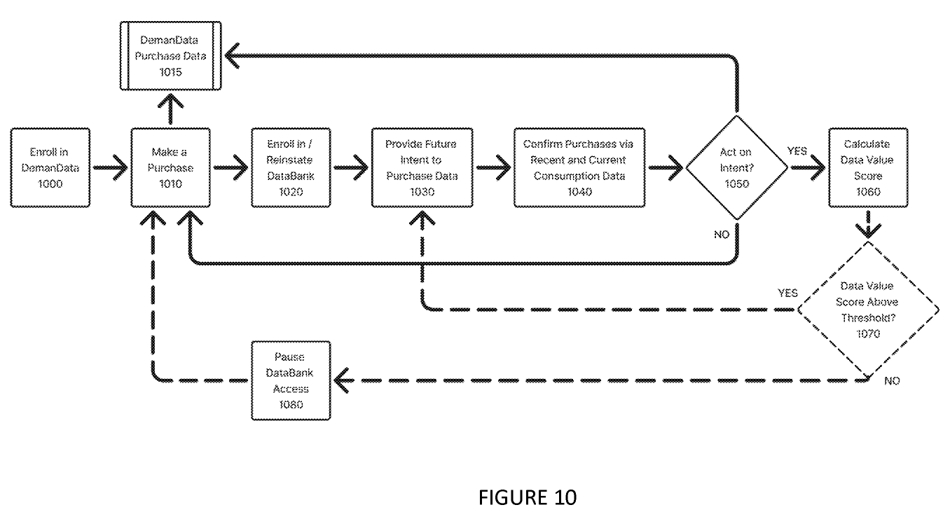

Referring next to FIG. 10, a more detailed description of implementation of the Data Value Score will be provided. At 1000 Consumption, comprising one or more Individual Consumers or Business Consumers, is preferably first enrolled in the DemanData DataBank platform. The DemanData platform allows Consumption to purchase one or more goods or services at a discount. The inventive Data Value Score, however, is not limited to use in conjunction with the DemanData platform. Rather any system for allowing the purchasing of goods or services can be employed. Once enrolled, Consumption is able to complete one or more purchases at 1010. A record of such purchases is stored in database 1015.

Once one or more purchases have been made at 1010 (the number of such purchases may preferably be determined to ensure a particular level of credibility of the Future Intent to Purchase Data), processing continues at 1020 where Consumption may be invited to enroll in the DataBank platform in order to monetize their Future Intent to Purchase Data, their Recent and Current Consumption Data, and other data that may be of interest, by selling such data to one or more potential Data Purchasers. Consumption remains in control of when and to whom they would be willing to sell their data. In an alternative embodiment, it is possible to enroll Consumption in the DataBank system without requiring any pre-enrollment purchase.

Once the consumer is enrolled, processing continues at 1030 where Consumption is asked to provide their Future Intent to Purchase Data for one or more products. Consumption may indicate one or more products, product categories, or the like that they intend to purchase. Consumption may then be asked to indicate a likelihood that they will purchase these products, a timeline of when they intend to purchase these products, a price or discount at which they are willing to purchase one or more of the indicated products, or other relevant questions. Additional Future Intent to Purchase Data can be added at any time by Consumption.

Once Future Intent to Purchase Data has been provided by Consumption, the inventive system preferably monitors purchases made by Consumer via the DemanData platform at 140. Such data is preferably pulled from database 1015. Purchases on other purchasing platforms may also be monitored, in which case database 1015 may also include data collected from these platforms. Purchases are preferably monitored over a predetermined period of time from the provision of the Future Intent to Purchase Data, but may be monitored over any appropriate time frame, and potentially in accordance with a timeline provided by Consumption for when they intend to make one or more of such purchases. As an example, if Consumption indicates an intention to purchase a ticket to a live show, monitoring until the live show takes place may be determined to be appropriate. If Consumption indicates an intention to purchase running shoes for use in a particular race, monitoring until the date of the race may be determined to be appropriate.

At 1050 it is queried as to whether Consumption has acted on their Future Intent to Purchase Data and have purchased one or more goods or services according to their accumulated Recent and Current Consumption Data. If at 1050 the query is answered in the negative, and it is therefore determined that Consumption has not purchased goods or services, so that their Recent and Current Consumption Data does not correlate with their previously provided Future Intent to Purchase Data, then processing returns to 110 and Consumption is placed in a state where they are unable to access the DemanData system and must once again be invited to the system after a DemanData purchase, or, alternatively may simply be returned to 1010 where more data is needed so that a Data Value Score can then be calculated. If, on the other hand, it is determined at query 1050 that Consumption has in fact made a purchase in line with their indicated intention so that their Recent and Current Consumption Data does in fact correlate with their previously provided Future Intent to Purchase Data, processing passes to 1060 where an intent score is calculated. Such score preferably correlates with the validated likelihood that Consumption will purchase goods and services in the future once Consumption has indicated such goods or services in their Future Intent to Purchase Data. As an example, a simple ratio may be employed where the number of intentions indicated by Consumption in their Future Intent to Purchase Data is the denominator, and the number of correlating purchases by Consumption confirmed in their Recent and Current Consumption Data is the numerator. So if Consumption indicates an intention to purchase five goods or services and actually purchases three, their score would be 60%. Of course, more complex algorithms may be employed taking into account time to purchase, size of purchase, Consumption’s indication of likelihood of purchasing, or other metrics.

The Data Value Score may be calculated as an overall score related to goods or services in all categories of Future Intent to Purchase Data and the Recent and Current Consumption Data, or may be calculated as a sub-score in accordance with one or more provided criterium. For example, a particular Individual Consumer may have a very high Data Value Score for indicated items that cost less than $500, while their Data Value Score for items over $1000 may be very low (score by cost of goods). It may make sense to split these scores so that an Original Source that manufactures items under $500 may find the Future Intent to Purchase Data and other data from this Individual Consumer very valuable while an Original Source that manufactures goods only over $1000 may not find the Future Intent to Purchase Data and other data from this Individual Consumer very valuable. Alternatively, the Individual Consumer may have a high Data Value Score for running shoes, but a low Data Value Score for housewares (score by category), suggesting splitting by type of goods may also be valuable. Any number of potentially valuable sub scores may be calculated.

Referring back to FIG. 10, Consumption’s Data Value Score may shift over time, generating a historical record of the Consumption’s purchasing likelihood for indicated goods and services. Thus, after calculating a data score, and having that score shift over time as Consumption adds additional Future Intent to Purchase Data and Recent and Current Consumption Data to the DemanData platform, in an alternative embodiment of the invention (shown with dashed lead lines in FIG. 10), processing may pass to 1070 where it is further queried whether the Data Value Score is above a predetermined threshold utilized to determine that a Consumption’s Future Intent to Purchase Data is reliable. If the query at 1070 is answered in the negative, and it is determined that the Data Value Score is not above the predetermined threshold, processing may continue at 1080 where access to the DemanData system may be paused, and Consumption may once again be returned to 1010 and additional purchases may be required before Consumption is once again invited to participate in the DemanData Program. If on the other hand the query at 1070 is answered in the affirmative, and it is therefore determined that the Data Value Score is above a predetermined threshold, processing may return to 1030 allowing the consumer to provide additional intentions to purchase.

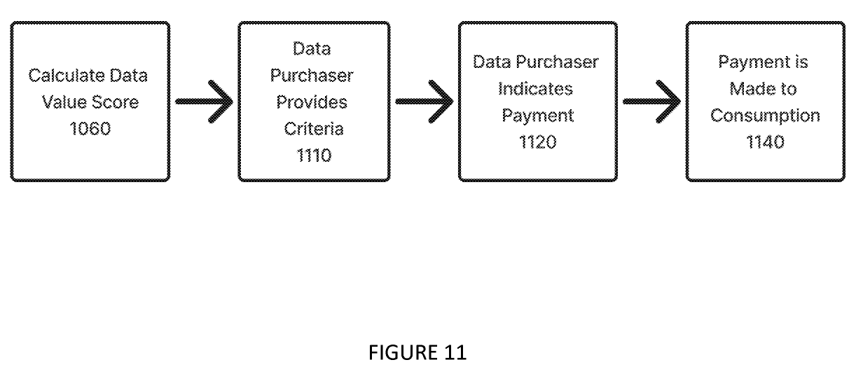

Referring next to FIG. 11, a process and system for allowing Consumption to monetize their Future Intent to Purchase Data, Recent and Current Consumption Data, and other data will be further described. Beginning with the calculated Data Value Score at 1060, processing may then proceed at 1110 where a potential Data Purchaser, such as an Original Source, an investment professional or organization, an individual or group interested in predicting demand for one or more goods or services, or any other group wishing to access such data, preferably provides one or more search criteria for selecting the Individual Consumers or Business Consumers whose data is to be included in their data purchase. For example (and following up from an earlier example), an Original Source producing running shoes may wish to access data from Individual Consumers who have indicated an intent to purchase running shoes, and who have indicated that they are scheduled to participate in a running race within the next six months. Runners participating in a marathon may prove to be more valuable to these manufacturers as this is an indication of the likelihood of running a large number of training miles, and thus requiring the purchase of a number of pairs of running shoes. These potential Data Purchasers may also set a threshold Data Value Score for an Individual Consumer to be included.

Data may be purchased under two different data delivery scenarios, as noted above with respect to FIG. 8. In a first, Data as a Service (DaaS), anonymized, aggregated Dynamic Primary Validated Data 825 is provided to the Data Purchaser in response to one or more queries and/or criteria provided by the Data Purchaser. This aggregated data typically is used to answer more population-level questions about Consumption purchasing decisions. All Data Sellers making up Consumption consenting to sharing their data into such an aggregated data pool, and whose data ultimately is chosen and becomes part of the provided anonymized, aggregated Dynamic Primary Validated Data 825 are paid a fee from the Data Purchaser. The DemanData system receives the fee from the Data Purchaser and distributes payments to each contributing Data Seller.

The Data as a service model empowers Data Sellers to sell their aggregated and anonymized Dynamic Primary Validated Data to Data Purchasers in response to specific queries or criteria and requirements provided by the Data Purchasers. providing the Data Purchasers with extremely valuable insights for marketing, risk assessment, business strategy, trend analysis, potential for new product offerings, and so on. The DemanData system matches Data Purchasers' criteria with the appropriate available anonymized and aggregated Dynamic Primary Validated Data. If that data is already available, an offer for the data can be immediately made by the Data Purchaser. If the requested data has not yet been collected, a questionnaire can be sent out to one or more potential Data Sellers according to desired demographics or other determinants of from whom to request the data. After payment for the data is made by the Data Purchaser, the DemanData platform retains only a small service fee (preferably a 7% service fee) and then distributes the other 93% of the fees paid by the Data Purchaser to the Data Sellers. Throughout, the system ensures compliance with all relevant data privacy laws, maintaining data security and contributor privacy.

In a second data delivery scenario, Demand as Service (DaS), Identifiable Dynamic Primary Validated Data 820 for one or more Individual Consumers or Business Consumers is provided to a Data Purchaser so that the Data Purchaser is able to market directly to each Individual Consumer or Business Consumer. The Data Purchaser may provide one or more queries and/or criteria (similar to above), but the output Dynamic Primary Validated Data is not aggregated. Rather the Data Purchaser can directly contact each individual Data Seller, provide one or more product or service offers to that individual Data Seller (presumably at a discount to standard market rates), or otherwise interact with them.

The Demand as a Service model delivers actual Identifiable Dynamic Primary Validated Data for each Individual Consumer or Business Consumer, including their Future Intent to Purchase Data, Recent and Current Consumption Data, their personal information, and other requested data so that the Data Purchasers can directly find and engage high intent individual Data Sellers through the DemanData platform. One or more Data Purchasers may propose an amount they are willing to pay for Identifiable Dynamic Primary Validated Data from one or more individual Data Sellers that meet one or more criteria. Consumption provides information on their Future Intent to Purchase Data and other data by answering questions on categories, subcategories, products and services, etc. These questions are preferably derived using a proprietary AI agent that analyzes the different data intent profile requests provided by Data Purchasers to create the applicable questions for Consumption. Data Purchasers preferably specify the types of Individual Consumers or Business Consumers they want to reach based on criteria such as preferred demographics, level of interest, and purchase intent, demographic, geographic, psychographic or behavioral data, etc. An AI agent preferably matches these requirements with the pool of verified Individual Consumers or Business Consumers and delivers detailed, Identifiable Dynamic Primary Validated Data of potential Data Sellers directly to the Data Purchasers.

Once one or more Data Sellers are selected by a Data Purchaser, a contract is executed between the Data Sellers and the Data Purchasers. This empowers organizations to directly engage with Data Sellers who have already demonstrated genuine interest in their products or services, dramatically increasing the efficiency and effectiveness of customer acquisition. This bypasses the outdated, inefficient data supply chains, and traditional direct advertising efforts which results in a meager 1-9% conversion rate. Businesses and institutions can now focus their resources and efforts on attaining high-intent Individual Consumers of Business Consumers, leading to dramatically increased conversion rates returning multiples higher conversion rates potentially reaching as high as 95% to 99%.

Thus, a search of all DemanData Consumption may be performed and the results sold to the Data Purchaser after the Data Purchaser indicates an amount that they are willing to pay (or an amount set as a predetermined, set rate) Consumption in exchange for their anonymized, aggregated Dynamic Primary Validated Data 825 or their Identifiable Dynamic Primary Validated Data 820 at 1120. Consumption is preferably required to confirm their desire to sell their data to these particular Data Purchasers. The Data Purchasers may also provide a tiered payment schedule based upon the Data Value Score (i.e. the higher the score, the more accurate and predictable the Dynamic Primary Validated Data, presumably the more valuable that Dynamic Primary Validated Data may be). Such data may be purchased in the aggregate (Data as a Service) so that trends may be elicited, or the data may be purchased individually (Demand as Service), thus allowing the Data Purchaser to individually reach out to one or more Individual Consumers or Business Consumers to provide offers to them to purchase goods or services (preferably via the Demandey platform) at a discount. Once the data is provided to the Data Purchaser, payment is preferably made to Consumption at 1140.

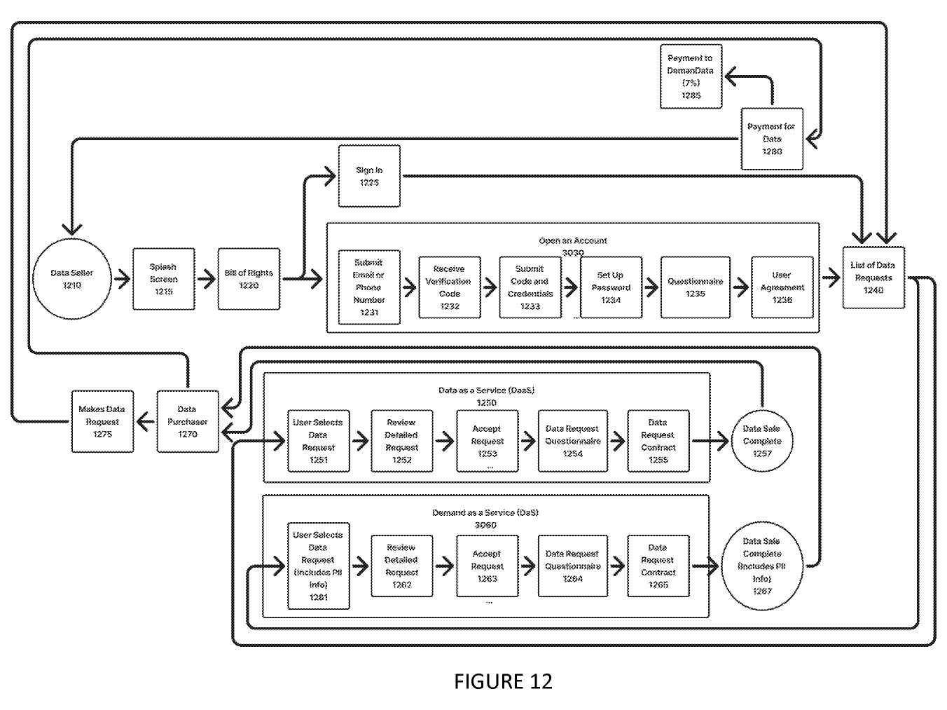

Referring next to FIG. 12, a flowchart diagram depicting a Data Seller’s interaction with the DemanData DataBank system is provided. As is shown in FIG. 12, at 1210 a Data Seller first enters the DemanData system via any web browser or other Internet access system. A splash screen 1215 is shown to the Data Seller, followed by a consumer Bill of Rights 1220 laying out all of the rights the Data Seller will gain and preserve while using the DemanData system, similar to those rights noted above with respect to the DemanData Consumer system. If the Data Seller has previously registered with the DemanData system, processing proceeds at 1225 where the Data Seller logs into their DemanData account. If, in the alternative, after step 1220 the Data Seller has not previously registered with the DemanData system, processing instead proceeds at 1230 where the consumer opens an account. This account opening includes steps such as submitting an email at 1231, receiving a verifications code at 1232, submission of the received verification and other user credentials at 1233, and password setup at 1234. Processing then continues at 1235 where the Data Seller is provided with an introductory questionnaire to complete so that the DemanData system may provide the best, most accurate information of the Data Seller to one or more potential Data Purchasers. The questionnaire may ask questions related to standard sets of data that a Data Purchaser may typically buy, and may include one or more customized questions. In order to generate such typical questions, an AI agent preferably looks across typical data purchases and generates one or more generic questions for inclusion, thus allowing for up front generation of the most common data requests across all Data Purchasers. Such information may include one or more of demographic, geographic, psychographic, behavioral, and intent data. The Data Seller is then presented with a user agreement for review and execution at 1236.

Whether the Dat Seller signed into the system at 1225 or opened an account at 1230, processing continues at 1240 where the Data Seller is provided a list of data requests to which they can choose to respond and provide data. From this screen, the Data Seller is able to review the status of any data requests initiated by a potential Data Purchaser. Such data requests may be related to Data as a Service at 1250 or Demand as Service at 1260. If the consumer indicates a desire to respond to a Data as a Service data request, processing continues at 1250. The process at 1250 further includes the Deta Seller first selecting a particular data request at 1251, and then is able to review the details about such a data request at 1252. Next, at 1253, the Data Seller is able to accept the request and is then provided with a data request questionnaire to be completed at 1254. This more specific questionnaire may provide one or more questions specifically required by the Data Purchaser that cannot be fulfilled by the data collected in the generic questionnaire at 1235 and may include one or more questions related to the particular Data Seller attributes, or the industry of interest for the Data Purchaser. The Data Seller is finally presented with a data request contract at 1255 spelling out the terms of the data offer from the Data Purchaser to the Data Seller to purchase their Dynamic Primary Validated Data that will be anonymized and aggregated for delivery. The data sale is then completed at 1257.

If, on the other hand, the Data Seller chooses to respond to a Demand as Service data request, processing continues at 1260. The process at 1260 further includes the Data Seller first selecting a particular data request at 1261, the data request including a request for Identifiable Dynamic Primary Validated Data and potentially other personally identifying information so the Data Purchaser eventually may directly connect and market to the Data Seller. The Data Seller is then able to review the details about such a request at 1262. Next, at 1263, the Data Seller is able to accept the request and is then provided with a data request questionnaire to be completed at 1264. Finally the consumer is presented with a data request contract at 1265, spelling out the terms of the data offer from the Data Purchaser to the Data Seller. The data sale is then completed at 1267.

Once a data sale is declared complete at either 1257 or 1267, processing continues at 1270 where the collected data is provided to the Data Purchaser. The Data Purchaser is then able to make a further data request at 1275 (if desired) which is then added to the list of data requests at 1240, and also pay for the received data at 1280. DemanData then receives its fee (preferably a 7% fee) at 1285 and distributes the remainder of the fee paid by the Data Purchaser to the Data Seller.

In this manner, Data Purchasers are able to receive aggregated data to see over all trends in a particular market (Data as a Service), or receive identifiable specific data to allow direct, efficient and successful marketing to one or more individual, identifiable consumers (Demand as a Service).

In this manner, Data Sellers are in control of their data, and are paid for the use of their data by others. They are able to determine when and to whom their Dynamic Primary Validated Data is provided, and are paid for providing their Dynamic Primary Validated Data. Rather than having one or more large data aggregation platforms monetize their data, Consumption receives direct payment for their valuable Dynamic Primary Validated Data. Data Purchasers receive accurate, Dynamic Primary Validated Data from Data Seller that is validated through the noted purchase requirements, thus resulting in far more accurate Future Intent to Purchase Data.

### System Architecture Descriptions

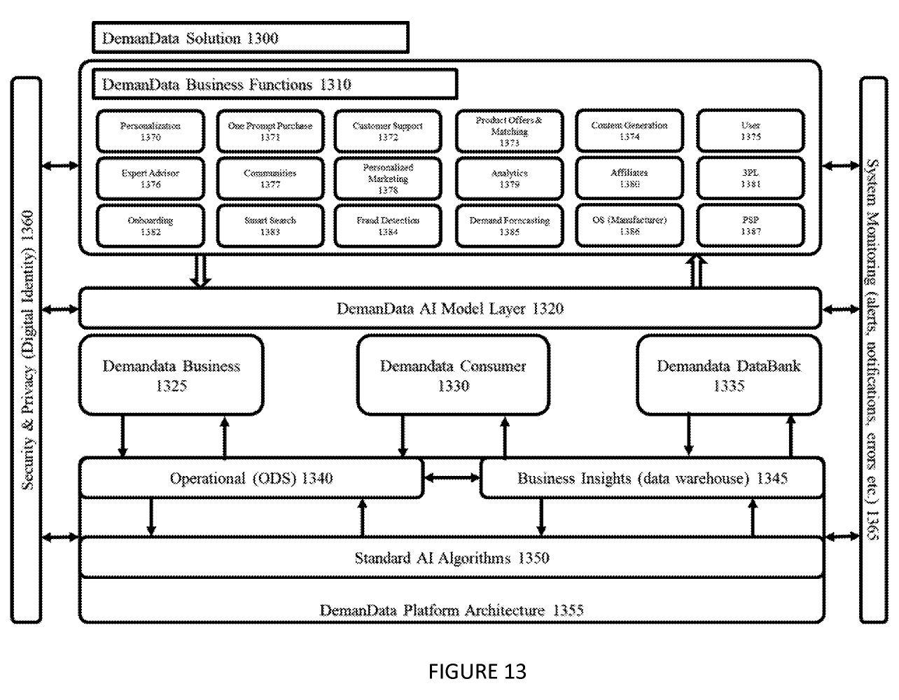

Referring next to FIG. 13, a high-level system architecture drawing constructed in accordance with an embodiment of the DemanData solution 1300 invention is shown. The inventive system architecture includes a business function layer 1310 including a plurality of business functions to be performed by the system, and as will be shown below, may be customized in order to perform one or more different business applications. The architecture further includes a DemanData AI model layer 1320 including one or more artificial intelligence models that may be applied to the workflow of the system, to any standard AI algorithms (to be described below), and to support any of the business functions 1310.

The AI model layer 1320 may be configured to apply to three main areas of application as described above: 1) DemanData Consumer; 2) DemanData Business; and 3) DemanData DataBank. Each of these three main areas preferably utilizes different combinations of the business functions 1310 and AI algorithms or AI Agents 1350, as will be described below.

Regardless of the main area of application, the AI model layer 1320 and the area of application in use interact further with an operational data store (ODS) layer 1340, and a business insights data warehouse 1345. ODS 1340 is preferably a database designed to integrate data from multiple sources for additional operations on the data, for reporting, controls and operational decision support. The data in ODS 1340 need not be passed back to operational systems, but rather it preferably may be passed for further operations to the data warehouse 1345. The data warehouse preferably comprises a central repository of data integrated from disparate sources, including but not limited to Future Intent to Purchase Data, and Recent and Current Consumption Data. It stores current and historical data organized so as to make it easy to create reports, receive queries, and generate insights from the data. It is intended to be used by other components of the system to help make organizational decisions. The data stored in warehouse 1345 may pass through the ODS 1340 and may require data cleansing or other additional operations to ensure data quality before it is used in data warehouse 1345 for reporting and other system support.

The ODS 1340 and data warehouse 1345 may rely on one or more standard AI algorithms (or AI Agents) 1350, comprising one or more AI algorithms for performing one or more functions in accordance with the overall operation of the system 1300. The ODS 1340, data warehouse 1345, and AI algorithms 1350 comprise the DemanData platform architecture 1355. The DemanData business functions 1310, the AI model layer 1320, and the platform architecture 1355 may further interact with a security and privacy layer 1360 and a system monitoring layer 1365. Security and privacy layer 1360 comprises setting up a digital identity for each user of the system and allows the user to control access to associated user data. The system monitoring layer 1365 monitors overall function of the system 1300, and preferably provides alerts, notifications, error reporting and the like as appropriate.

Any number of particular business functions may be provided that can be combined as desired in order to initiate and carry out any desired area of functionality. The following business functions may be provided in accordance with an embodiment of the invention (some of these functions will be described in greater detail below):

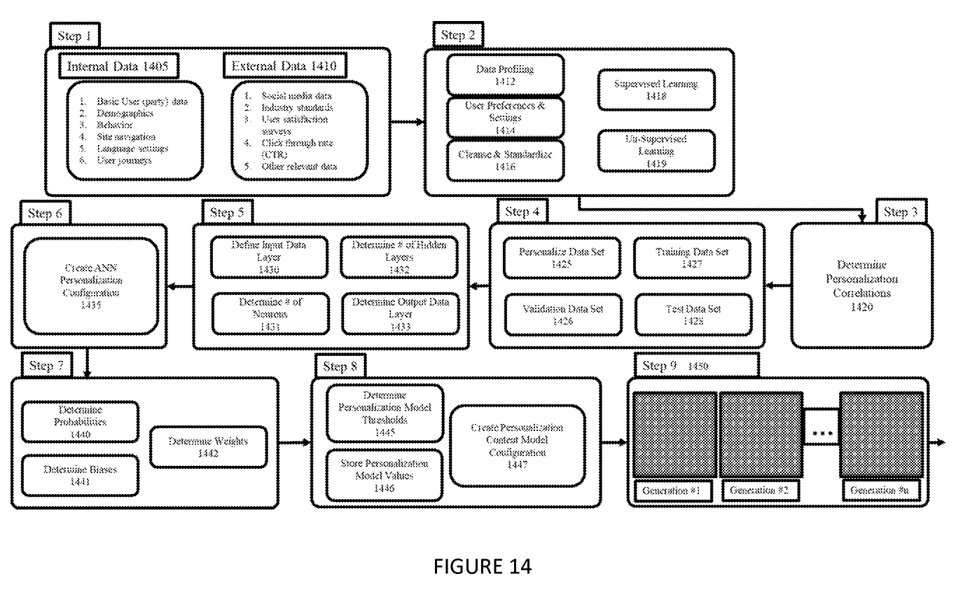

Personalization 1370. The inventive Personalized Content AI Application 1370 preferably enhances user experience by using Dynamic Primary Validated Data from Consumption, which gives the DemanData solution the advantage of delivering highly relevant content to people or businesses. Analyzing and utilizing this data set through AI and Machine Learning (ML) allows the DemanData solution to offer a uniquely personalized and engaging buying experience, tailoring content to user profiles, individual preferences, purchase history, and navigation behavior. A detailed description of personalized content AI application 1370 begins making reference to FIG. 14. As is shown in FIG. 14, in a Step 1 first internal data 1405 is collected and may comprise one or more of: 1) basic user data (comprising at least in part responses to one or more questions provided to a user in a predefined generic question set); 2) user demographics; 3) user behavior data, including but not limited to geographic, demographic, psychographic, behavioral data, and the like; 4) site navigation data; 5) language settings & preferences; 6) user purchase intent data; and 7) user’s user journey on the platform. This data is collected and stored in the DemanData platform ODS 1340 (see FIG. 13). This collected data preferably comprises Dynamic Primary Validated Data that is validated prior to storing in ODS 1340. In an alternative embodiment of the invention, external data 1410 (information and attributes that are collected from one or more external agencies, repositories and through sensing via user reviews, feedback, surveys etc.), may also collected at Step 1, and may comprise one or more of: 1) social media data; 2) industry standards; 3) user satisfaction surveys (and potentially comments posted); 4) click through rates; and 5) other relevant from external data providers, by way of example only. This external data is preferably also stored in the platform’s ODS 1340 and may be used as inputs into analytics and AI modules. Proprietary tools and utilities (such as data profile) may be applied to ensure consistency before storing data in ODS 1340.

Processing then continues at step 2 where data profiling 1412 is first performed. During the data profiling process, all of the data collected and captured in the system at various touchpoints is assessed for quality and consistency. Profiling comprises a mechanism of evaluating the quality of data prior to storing in ODS 1340. There are preferably over 12 metrics (such as consistency, null-check, integrity, variance etc., by way of example only) that may be applied to data that is to be stored in ODS 1340. This is a component that allows for the processing of large volumes of data in a short period of time. User preferences and settings 1414 allows a user to customize the data views per their convenience and level of comfort. Preferences may comprise a style of view (i.e. styling from as simple as light vs dark), language, priority of information that is to be shown to the user is enabled by the user’s choice. Settings such as alerts, email notifications, etc. can also be customized to one’s liking and choice. All of these constitute user preferences & settings. In addition to saving users’ preferences and settings in the platform, ODS 1340 information regarding how these selections are made is equally important and may also be stored separately to be used during AI module execution.

Collected data is then preferably cleaned and standardized at step 1416. Data cleansing is the process of identifying and correcting or removing errors, inaccuracies, and inconsistencies in the data. Standardization is the process of transforming data into a common format that can be easily understood and used across different modules of the DemanData platform. Some examples of standardization comprise one or more of converting data to consistent formats, applying uniform rules and structures, and if external data has been collected at 1410, ensuring compatibility between different sources, which is important when data is procured from disparate sources such as social media platforms, NPD, IRI etc. Processing then passes to both supervised learning 1418 and unsupervised learning 1419 techniques that are well known to one of ordinary skill in the art. Supervised learning comprises a standard machine learning (ML) technique where algorithms are trained on labeled data. This means each input data point is paired with a corresponding correct output. The goal is for the model to learn the mapping from inputs to outputs, enabling it to make accurate predictions on new, unseen data. Supervised learning is commonly used for tasks such as classification and regression. In classification, an algorithm assigns input data into predefined categories, while in regression, it predicts continuous values. Unsupervised learning, in contrast, deals with unlabeled data. Here, the algorithm tries to identify patterns and structures within the data without any pre-existing labels or outputs. This approach is useful for clustering, where the algorithm groups similar data points together, and for association tasks, which involve finding relationships between variables in a dataset. Unsupervised learning is often used when the goal is to explore the underlying structure of the data without specific outcomes in mind.

Processing then continues at Step 3 where personalization correlations 1420 are determined, comprising a measure of association or relationship between attributes in the dataset without relying on predefined labels. These correlations are preferably determined by applying both unsupervised and supervised ML techniques on the datasets of the DemanData platform. The personalization correlations are primarily used for one or more of: 1) pattern discovery – identifying hidden structures and relationships between attributes of the dataset; 2) feature extraction – capturing essential information from the dataset to enable meaningful distinctions; and 3) dimensionality reduction – reducing the number of features while preserving important information (e.g., user to product to payment to logistics relationships are derived directly from ODS 1340, which is a relational database).

At a next step 4, one or more datasets are preferably generated. These datasets may comprise one or more of:

Personalize Dataset 1425 - From the data available in the DemanData platform (in various ODS’s 140 comprising one or more of internal and external data repositories) a dataset is preferably created to be used for a development team’s component development and unit testing purposes. This assists with unit testing while validating the hypothesis at a very granular level. The hypothesis is that the dataset created will encompass combinations of scenarios to represent personalization. This process is defined as the personalization of the dataset used for functionality development purposes.

Training Dataset 1427 - A dataset that is created from one or more various repositories of the DemanData platform to be used to train the functionality. This is a critical step in training the AI model and builds on the knowledgebase to be used on the platform.

Validation Dataset 1426 - A dataset that is created from one or more various repositories of the DemanData platform to be used to validate the functionality. This is a critical step in validating the AI model and builds on the knowledgebase to be used on the platform.

Test Dataset 1428 - A dataset that is created from one or more various repositories of the DemanData platform to be used to test the functionality. This is a critical step in testing the AI model and builds on the knowledgebase to be used on the platform.

Generally, datasets are iterated and changed to improve the accuracy and efficiency of the model. A training dataset that is leveraged for one generation of the model is preferably recycled and exchanged with Test datasets for future generations of a model. This is best practice which helps with the accuracy and efficacy of the AI Models.

A number of hidden layers is then determined at 1432. Hidden layers are intermediate layers between the input and output layers. They are crucial for transforming and processing the input data to extract features and patterns. Key aspects of hidden layers are as following: 1) Computation: Each neuron in a hidden layer takes inputs from the previous layer, applies weights, sums them up, adds a bias, and passes the result through an activation function to introduce non-linearity; 2) Feature extraction: Hidden layers help in extracting complex features from the input data by performing various transformations. This is especially important for capturing non-linear relationships; and 3) Multiple layers: An artificial neural network (ANN) can have one or more hidden layers. Networks with multiple hidden layers are often referred to as deep neural networks, which can model more complex patterns. In the DemanData platform implementation there are preferably a minimum of 3 hidden layers for determining one or more non-linear relationships. The number of hidden layers employed is optimized from a performance perspective as a higher number of hidden layers require more computing power. Based on initial results of processing using a default number of hidden layers, the number of hidden layers may be increased dynamically, and such configuration information is stored externally in a configuration file.

An output layer is then determined at 1433. The output layer in an artificial neural network (ANN) is the final layer that produces the network's predictions or results. Such an output layer comprises one or more of the following key characteristics and functions: 1) Final layer: The output layer is the last layer in the neural network architecture, responsible for producing the final output based on the inputs processed through previous layers; 2) Number of nodes: The number of nodes in the output layer depends on the specific problem being solved. There are various methods (such as Binary classification, Multi-class classification, Regression) to determine the number of nodes; 3) Transforming inputs: The output layer preferably receives transformed data from the hidden layers and applies weights and biases to produce an output; and 4) Producing predictions: The output layer generates predictions that can be interpreted directly or require further processing, such as converting probabilities into class labels in classification problems. The output layer plays a critical role in determining how an ANN's learned patterns are translated into actionable insights or decisions. In accordance with an embodiment of the invention, the network is preferably iterated until received results are reasonable and meet a predetermined threshold.

Finally, for the last element of Step 5, a number of neurons is determined at 1431. Neurons (also called as nodes) are mathematical models which are fundamental processing units in the ANN. They are the granular attributes (i.e. data attributes) of the business function (like Personalization, Dynamic communities, Procurement language model etc.). Each neuron receives one or more inputs, applies weights to these inputs and produces a single output. The components of a neuron are as follows: 1) Inputs: data received from DemanData platform’s internal (and external repositories if applicable) 2) Weights: values that determine the strength of connection between the attributes in different and same layers; 3) Bias: an additional input that helps adjust the execution process; and 4) Activation function: a mathematical function (in the DemanData platform case, non-linear equations) that determines the output. Using a non-linear relationship, neurons help understand the complex relationships for a business function. The number of neurons employed in any particular embodiment of the invention is determined by using scientific functions (such as input-output, square root and decreasing neurons methods) initially and applying a data driven approach after an appropriate passage of time after which enough data has been collected.

Processing then continues at step 6 in which an ANN personalization configuration is created at 1435. After all factors are determined to build the ANN this information is stored in an external configuration file to allow the system to make changes dynamically to suit business needs. The configuration is stored in a repository with appropriate version management. This enables the ability to run multiple iterations of the model for fine tuning the results while improving efficiency and accuracy of the model.

At a next Step 7, first one or more probabilities of the ANN are determined at 1440. There are several methods that may be employed to determine the probabilities in the ANN. A sigmoid function is preferably leveraged to determine the probabilities which are used in binary classification problems to output a probability between 0 and 1. After the probabilities are determined using this sigmoid function, they are preferably stored in an external configuration file and are able to be changed dynamically when required. Weights are next determined at 1442. Weights in the ANN are numerical values that determine the strength and significance of the connection between neurons. These weights are applied to each of the inputs as they are passed from neuron to another. These weights are preferably determined initially through Bayesian methods and are refined over time based on the efficiency and efficacy of the results. Biases are then determined at 1441. Biases are additional parameters in the ANN that allow the model to fit the data better by providing each neuron with a constant value. They help in enabling the network to better fit complex patterns by adjusting the thresholds during the computation of the relationships. Together weights and biases enable ANN’s to learn complex relationships between attributes. Efficiency and accuracy of the model is based on fine tuning these parameters. These values are externally stored as configuration parameters to change dynamically per an analysis on the accuracy of the results.

Next, at Step 8, a personalization model is configured. One or more personalization model thresholds are determined at 1445. An ANN which forms the core of the AI module is built with different factors as explained in the above sections. Values for each of these is stored by applying appropriate version mechanisms externally. Threshold values for each of the factors are determined and stored in the configuration files to fine tune and refine as required. Next, at 1446, one or more personalization model values are stored. The factors that are used to build the Personalization AI Model are stored externally either in ODS 1340 or other file storage. Components are developed to change these values dynamically per the business needs. The model configurations are version managed to record the efficiency and accuracy. Finally, at 1447 one or more personalization content model configurations are created. Based on all the factors defined and determined above the AI Model for the Personalization content are developed. These are self-contained code components which may be executed independently or in collaboration with the DemanData platform modules.

Processing then continues with Step 9 in which one or more models 1050 are generated employing one or more generations or iterations. It is a best practice to execute the AI model multiple times with different datasets of varying sizes in batches. By going through this process, the AI model provides better accuracy and results as it learns from the different datasets. For example, if there are 1000 training examples and a batch size of 100 there will be 10 iterations. A set of iterations are defined as an epoch; results are then preferably evaluated by epoch. Processing multiple model generations may include the following:
a. Determine batch size;
b. Calculate or define the total number of iterations;
c. Create a training loop for the model to learn from the datasets;
d. Process data through the model;
e. Compute factors influencing the model along with the weights;
f. The above steps will be repeated and required to stop after meeting a predefined criterion;
g. Assess model results after each epoch;
h. Adjust parameters based on the performance and output;
i. Progress will need to be monitored based on the result set; and
j. Determine early stopping criteria in case there is no significant improvement in performance after each epoch.

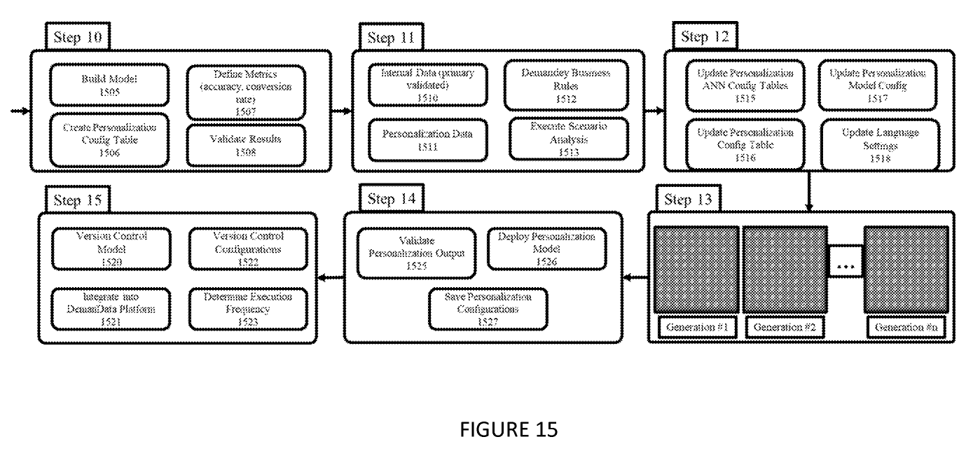

Processing continues with Step 10, shown in FIG. 15. As is shown in step 10, a build model is generated at 1505. Thus, after evaluating the results from the execution of the model in step 9, the model is finalized for the build process to be used on the DemanData platform. The final version of the Model is preferably created and deployed into the platform environment. Version of the values of the model will be stored in ODS 1340. Processing then continues to 1507 where one or more metrics are defined. Goals and metrics are defined for accuracy, efficiency, etc. for the model. Output of each execution of the epoch will be checked and documented against the goals. These metrics may then be adjusted based on the model output result set. At 1506 a personalization configuration table is preferably generated. All the factors and metrics defined against the model are stored in a configuration file or table to make it easy for the future executions. Components are deployed to make it easier and simpler to change these factors dynamically. Finally at 1508 results from the AI model are validated and evaluated for accuracy and efficiency.

Processing then continues at step 11 where internal data 1510 collected during the onboarding process of one or more consumers is accumulated. Such internal (Dynamic Primary Validated Data) data may include one or more of the following: basic User data (comprising at least in part responses to one or more questions provided to a user in a predefined generic question set); User demographics; User behavior data[CG1.1]; Site navigation data; Language settings and preferences; and User’s user journey on the platform. This data is preferably collected and stored in the DemanData platform ODS 1340. One of the key factors is that the collected data is Dynamic Primary Validated Data, which is collected at the source of collection prior to saving in ODS 1340. At step 1512 one or more business rules are defined. A rule employed by the DemanData platform is defined as a specific guideline or principle that provides a deterministic output. In the DemanData platform ML algorithms are leveraged in order to generate rules based on the historical and current (Facts) data available in the various repositories by implementing and deploying an automated process. These rules are further enhanced and specialized based on the product and/or type of purchase by the user. Rules identified through the automated ML process are stored in a rules repository and refreshed at a regular frequency. All the AI components/modules leverage the rules repository and are layered on top of the output generated by executing them. Generally, AI Models produce an output based on the datasets on which the model is developed and trained. A set of rules are preferably defined and cross referenced in order to validate and ensure that the model is producing outputs that are logical. For example: an 80+ year old person purchasing paraphernalia for newborn baby would normally be perceived as a gift (with exceptions coded based on other conditions like the person voluntarily giving information stating that a baby is coming into their life). Any exceptions to the rule defined above will be checked to ensure the AI model is working appropriately.

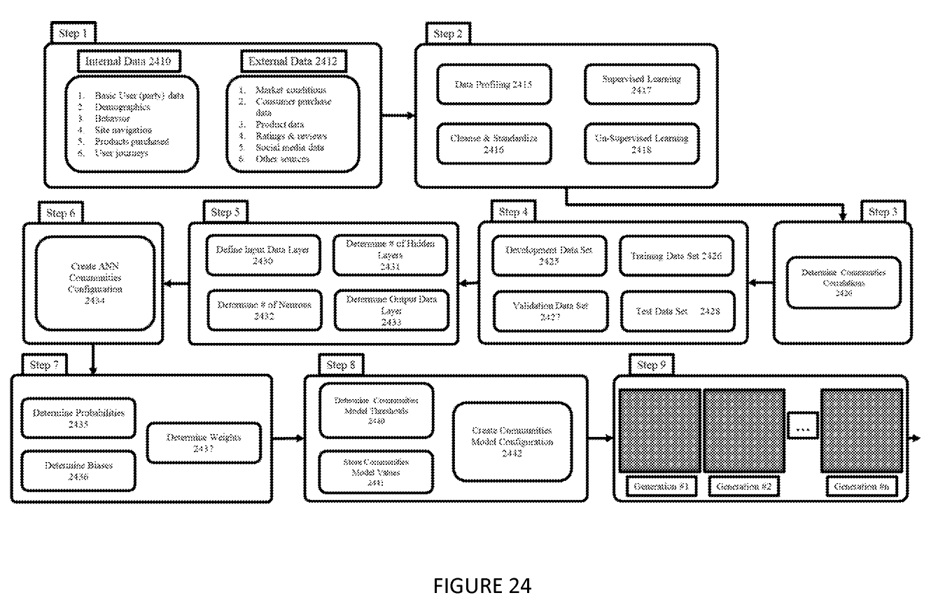

At 1511 Personalization data, or dynamic community data, is preferably accumulated based upon user-provided data and other collected data as described above. Users that are registered with the DemanData platform are preferably ‘grouped’ internally into different communities. These communities may be based on common wants, needs, and desires; geographic location; physical proximity, etc. The criteria may comprise user purchases, behavior, changing wants, needs, and desires. Grouping users into different communities helps to understand the purchasing trends, products usage etc. which can facilitate original sources of goods and services to build better products, optimize inventory positions, better understand communities, and provide upgrades to current products and services, all increasing customer satisfaction. On the DemanData platform the user’s one or more communities may be changed dynamically based on their user journeys, purchase behavior, searches made on the platform, or intervention by the user themselves, etc. From this AI Model perspective, the Dynamic communities play a critical part in recommending one or more products to the user as purchases from a particular user in a particular community can be employed to provide proposed items to other users attached to the same or similar communities. Details of the operation of these dynamic communities are described in greater detail below in FIGS. 24-26. Finally, at 1513 a scenario analysis is executed. The data that was used for development, training, testing and validation is then sliced and diced into various scenarios to ensure wider coverage of this personalization functionality. This is a key factor in improving performance, accuracy and efficiency of the AI Model.

Processing then continues at step 12 where various tables, models, and settings are updated according to new model outputs. At 1515 Personalization (Artificial Neural Network) ANN configuration tables are updated. This is the process of updating the relevant AI Model’s configuration tables to be able to change them dynamically, either in an automated fashion in response to newly acquired data, or actively by the user themselves. These are version controlled and tracked for providing feedback loop in improving efficiency of the model. At 1517 personalization model configuration tables are updated. All of the configuration parameters are updated immediately after the execution and validation of the result sets. These are then stored in external configuration files providing flexibility to make changes without having to go through the time-consuming build and deployment process. At 1516 personalization configuration tables are also updated after each model execution. Finally, at 1518, user language settings are updated.

Next, processing passes to step 13 where final models are generated. The sequence to execute and process the AI model are iterated through multiple times to refine the results for accuracy, model efficiency and performance. Steps explained in the section above for Model generations (step 9) are preferably repeated here while updating the parameters for accurate results. The model output results are validated automatically by developing and applying different test cases and scenarios. After these new models are generated processing continues at step 14 in which various personalization steps are performed. Personalization output from the personalization model for product recommendations is validated at 1525 and is then deployed at 1526. The following steps are followed to deploy the model: Save the model to a file that contains all necessary information (containerize) for making predictions; Keep different model versions using the Bitbucket repository; Package the serialized model and its dependencies into a container; Deploy the trained model into the environment; Set up monitoring tools to track the model's performance, catch errors, and detect any drift in behavior over time; and Implement encryption, authentication, and access control to protect the model and data from unauthorized access. Then at 1527 the personalization configurations are saved. The model, its factors and related configuration is saved for future use, allowing these saved elements to be updated in the future per business needs.

Finally, at step 15 the final deployment items are put in place to release these updated models. At 1520 the model is version controlled. Thus, the model and parameters will be controlled through version management as it helps track results, accuracy and efficiency. This is a standard and straightforward process in helping assess whether to go forward or rollback in case required. At 1522 the configurations applicable to the models are also controlled through version control. At 1521 the new models are integrated into a production platform. This is the final step in the AI model creation. The AI model is thus integrated into the DemanData platform. Finally, at 1523 execution frequency is determined. It is important to understand and determine frequency of the AI model execution. The frequency is based on changing business needs (i.e. what the original sources of goods and services require to best meet demand, and usage patterns of consumption. On the DemanData platform the models are monitored and checked regularly (monthly, for example) to cater to the market and user demands. It is also possible to update the model in parallel with the production instance and then to test to see if an updated model provides significantly improved and more accurate output.

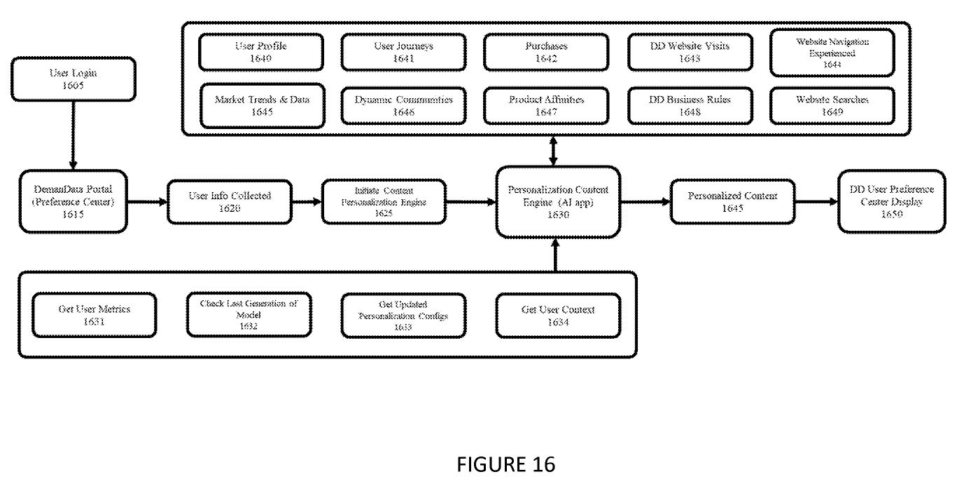

Referring next to FIG. 16, a use case for the application of personalized content in accordance with an embodiment of the invention will be described. At step 1605 a user, such as an Individual Consumer, first enters credentials to login to the DemanData platform. Then at step 1615, after the user’s credentials are validated, the user is logged into the platform. Login time and other information is preferably captured and saved in the ODS 1340. Next at step 1620 user information is collected. Information regarding the profile, number of logins, etc. is collected from ODS 1340 to be presented to the personalization component of the system, and at step 1625 the personalization engine is initiated in order to perform the one or more personalization steps described above. The personalization content engine (the AI app (agent?) described above) is implemented at step 1630. Inputs to the processing at step 1630 include one or more of the following:
User Profile 1640: Information related to the basic profile is put into the platforms state machine to be presented to the personalization engine. User Profile may also include configuration settings related to the user’s likes and preferences of the UI aspects which are fetched from the ODS.
User Journeys 1641: All the data that was captured as the user browsed on the platform (i.e. products searched, features & specifications viewed etc.) is fetched into the state machine.
Product Purchases 1642: Detailed data regarding the past purchases made on the platform are fetched from ODS 1340.
DemanData Website Visits 1643: Number of times the user has visited the website is fetched.
Website Navigation Experienced 1644: Information that is specific to the user’s navigation on the website is captured and made available to the personalization engine.
Website Searches 1649: Different searches made by the user on the platform are fetched and made available for use by the personalization engine
Market Trends & Data 1645: Data from any external sources (if employed, such as social media, NPD, IRI etc.) is fetched from the platform’s repositories.
DD Dynamic Communities 1646: A set of communities will be developed and stored in ODS 1340 as part of the platform implementation. Data that is related to the communities that are defined in ODS 1340 will be fetched.
Product Affinities 1647: Based on user behavior and other factors a set of products will be defined and suggested as product affinities. The data that is captured with respect to the products in which the particular user is interested will be fetched from the ODS to provide as input into the AI model.
DD Business Rules 1648: System fetches business rules related to the product and context the user is in are identified and will be made ready in the memory. This information along with the user settings and preferences is defined and stored in the ODS

In addition to the above information, various information is preferably fetched from the platform in order to further inform the personalization content engine 1630, and may include one or more of the following:
Get User Metrics 1631: The user metrics related to the number of purchases, feedback provided, satisfaction level etc. are fetched from the ODS.
Check Last Generation of Model 1632: System ensures that the version of the AI model being used is the latest and approved version in the repository.
Get Updated Personalization Configs 1633: All the configuration information is validated and fetched to make any changes, if required.
Get User Context 1634: Content related to the user’s request along with context is provided as additional inputs to the engine.

One potential output from the personalization content engine 1630 may comprise personalized content recommendations at step 1645. The AI model is executed with all the inputs from the above sections. The latest version of the configuration parameters and the model are fetched from the version management repository. With the data that is fetched and stored in the session along with user’s context will be provided as input to this AI model. After the execution is complete the AI model will generate one or more potential products that can be recommended to the user. These potential products are then displayed to the user in the preference center at step 1650.

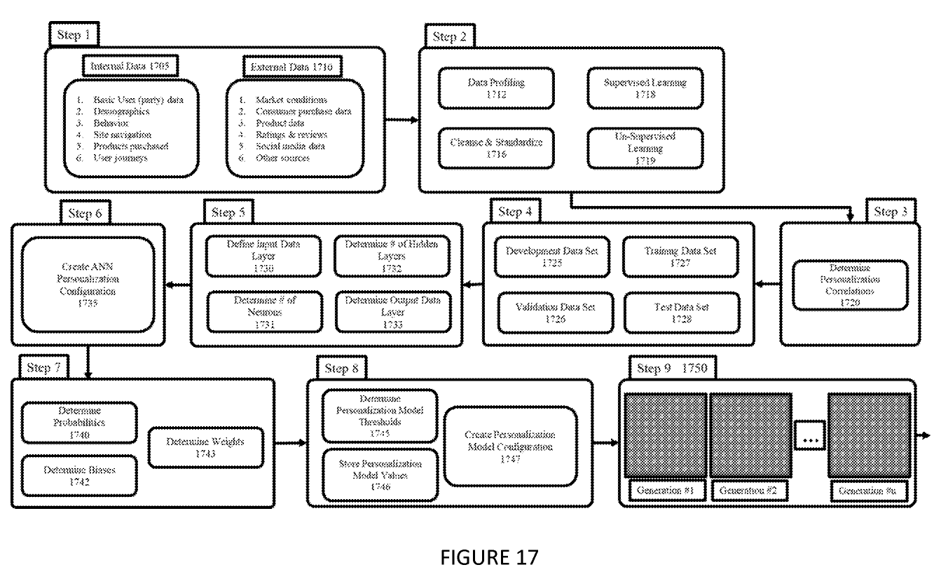

Referring next to FIG. 17, a more detailed description of the use of the personalized content system 1370 to provide personalized product recommendations will be described. This function relies on the data collected for users, such as Individual Consumers and Business Consumers, manufacturers and other Original Sources, etc. and preferably allows for the matching of one or more offers to purchase goods and/or services to one or more users who are likely interested in wanting to purchase such goods or services. The "Product Offer Matching" AI application utilizes clustering and classification models to tailor product offers based on user-provided information, including demographics, psychographic, geographic, behavioral and intent data. The application creates unique profiles for each user, treating them as distinct entities. The system grades users and matches high-intent profile customers with manufacturers seeking similar high-intent profiles, ensuring targeted and effective product offers that align with user interests and behaviors. In addition, AI processes are used to estimate and display the value of the user's data.

As is shown, in a Step 1 first internal data 1705 is collected, and may comprise one or more of: 1) basic user data (comprising at least in part responses to one or more questions provided to a user in a predefined generic question set); 2) user demographics; 3) user behavior data; 4) site navigation data; 5) prior purchased products information; 6) user’s user journey on the platform, and 7) user Future Intent to Purchase Data and Recent and Current Consumption Data. This data is collected and stored in ODS 1340. One of the key factors of this Dynamic Primary Validated Data is that it is validated at the source prior to saving in ODS 1340. Additionally, in an alternative embodiment of the invention, external data 1710 (information and attributes that are collected from one or more external agencies, repositories and through sensing (via user reviews, feedback, surveys etc.) may also be collected at Step 1, and may comprise one or more of: 1) market conditions data; 2) consumer purchase data; 3) product data; 4) ratings and review data; 5) social medial data; and 6) other sources, etc., by way of example only. This external data is also preferably stored in the platform’s ODS 1340 and used as inputs for analytics and AI modules. Proprietary tools and utilities (such as data profile) may also be applied to ensure consistency before storing data in ODS 1340.

Processing then continues at step 2 where data profiling 1712 is first performed. During the data profiling process, all of the data collected and captured in the system at various touchpoints is assessed for quality and consistency. Profiling comprises a mechanism of evaluating the quality of data prior to storing in ODS 1340. There are over preferably 12 metrics (such as consistency, null-check, integrity, variance etc., by way of example only) that may be applied to data stored in the various ODS’s. This is a component that allows for the processing of large volumes of data in a short period of time.

Collected data is then preferably cleaned and standardized at 1716. As noted above, data cleansing is the process of identifying and correcting or removing errors, inaccuracies, and inconsistencies in the data. Standardization is the process of transforming data into common format that can be easily understood and used across different modules of the DemanData platform, such as converting potentially unstructured data into structured data. Some examples of standardization comprise one or more of converting data to consistent formats, applying uniform rules and structures, and ensuring compatibility between different sources, which is important if processing is following the alternative embodiment where data is additionally procured from disparate sources such as social media platforms. Processing then passes to both supervised learning 1718 and unsupervised learning 1719 techniques that are well known to one of ordinary skill in the art. Supervised learning comprises a standard machine learning (ML) technique where algorithms are trained on labeled data. This means each input data point is paired with a corresponding correct output. The goal is for the model to learn the mapping from inputs to outputs, enabling it to make accurate predictions on new, unseen data. Supervised learning is commonly used for tasks such as classification and regression. In classification, an algorithm assigns input data into predefined categories, while in regression, it predicts continuous values. Unsupervised learning, in contrast, deals with unlabeled data. Here, the algorithm tries to identify patterns and structures within the data without any pre-existing labels or outputs. This approach is useful for clustering, where the algorithm groups similar data points together, and for association tasks, which involve finding relationships between variables in a dataset. Unsupervised learning is often used when the goal is to explore the underlying structure of the data without specific outcomes in mind.

At a next step 4, one or more datasets are preferably generated. These datasets may comprise one or more of:

Development Dataset 1725 - From the data available in the DemanData platform (in various ODS’s 1340 such as internal (and external, if employed) data repositories, a dataset is preferably created to be used for a development team’s component development and unit testing purposes. This assists with unit testing while validating the hypothesis at a very granular level. The hypothesis is that the dataset created will encompass combinations of scenarios to represent personalization. This process is defined as the personalization dataset used for functionality development purposes.

Training Dataset 1727 - A dataset that is created from one or more various repositories of the DemanData platform to be used to train the functionality. This is a critical step in training the AI model and builds on the knowledgebase to be used on the platform.

Validation Dataset 1726 - A dataset that is created from one or more various repositories of the DemanData platform to be used to validate the functionality. This is a critical step in validating the AI model and builds on the knowledgebase to be used on the platform.

Test Dataset 1728 - A dataset that is created from one or more various repositories of the DemanData platform to be used to test the functionality. This is a critical step in testing the AI model and builds on the knowledgebase to be used on the platform.

Generally, datasets are iterated and changed to improve the accuracy and efficiency of the model. A training dataset that is leveraged for one generation of the model is preferably recycled and exchanged with Test datasets for future generation of a model. This is best practice which helps with the accuracy and efficacy of the AI Models.

Processing then continues at step 5, in which first an input data layer 1730 is preferably defined. An input data layer is the first layer in an artificial neural network (ANN) and is responsible for receiving one or more input data from the external environment. It consists of nodes or units that correspond to each feature of the input data. The primary functions of the input layer include: 1) a receiving node: each node (or neuron) in the input layer takes in one feature of the input data, such as pixel values in an image or attributes in a dataset; and 2) passing data forward: The input layer nodes pass the received data directly to the neurons in the first hidden layer without performing any computations themselves. In accordance with an embodiment of the invention there is preferably one input layer to manage all the data that are required to execute this AI module. The number of inputs may vary based on the number parameters that are to be considered. Flexibility is embodied in the platform to dynamically change the number of parameters by storing in an external configuration file.

A number of hidden layers is then determined at 1732. Hidden layers are intermediate layers between the input and output layers. They are crucial for transforming and processing the input data to extract features and patterns. Key aspects of hidden layers are as following: 1) Computation: Each neuron in a hidden layer takes inputs from the previous layer, applies weights, sums them up, adds a bias, and passes the result through an activation function to introduce non-linearity; 2) Feature extraction: Hidden layers help in extracting complex features from the input data by performing various transformations. This is especially important for capturing non-linear relationships; and 3) Multiple layers: An artificial neural network (ANN) can have one or more hidden layers. Networks with multiple hidden layers are often referred to as deep neural networks, which can model more complex patterns. In the DemanData platform implementation there are preferably a minimum of 3 hidden layers for determining one or more non-linear relationships. The number of hidden layers employed is optimized from a performance perspective as a higher number of hidden layers require more computing power. Based on initial results of processing using a default number of hidden layers, the number of hidden layers may be increased dynamically, and such configuration information is stored externally in a configuration file.

Finally, for the last element of Step 5, a number of neurons is determined at 1731. Neurons (also called as nodes) are mathematical models which are fundamental processing units in the ANN. They are the granular attributes (i.e. data attributes) of the business function (such as Personalization, Dynamic communities, Procurement language model etc.). Each neuron receives one or more inputs, applies weights to these inputs and produces a single output. The components of a neuron are as follows: 1) Inputs: data received from DemanData platform’s internal and external repositories; 2) Weights: values that determine the strength of connection between the attributes in different and same layers; 3) Bias: an additional input that helps adjust the execution process; and 4) Activation function: a mathematical function (in the DemanData platform case, non-linear equations) that determines the output. Using a non-linear relationship, neurons help understand the complex relationships for a business function. The number of neurons employed in any particular embodiment of the invention is determined by using scientific functions (such as input-output, square root and decreasing neurons methods) initially and applying a data driven approach after an appropriate passage of time after which enough data has been collected.

Processing then continues at step 6 in which an ANN personalization configuration is created at 1735. After all factors are determined to build the ANN this information is stored in an external configuration file to make changes dynamically to suit business needs. The configuration is stored in a repository with appropriate version management. This enables the ability to run multiple iterations of the model for fine tuning the results while improving efficiency and accuracy of the model.

At a next Step 7, first one or more probabilities of the ANN are determined at 1740. There are several methods that may be employed to determine the probabilities in the ANN. A sigmoid function is preferably leveraged to determine the probabilities which are used in binary classification problems to output a probability between 0 and 1. After the probabilities are determined using this function they are preferably stored in an external configuration file and are able to be changed dynamically when required. Weights are next determined at 1743. Weights in the ANN are numerical values that determine the strength and significance of the connection between neurons. These weights are applied to each of the inputs as they are passed from neuron to another. These weights are preferably determined initially through Bayesian methods and are refined over time based on the efficiency and efficacy of the results. Biases are then determined at 1742. Biases are additional parameters in the ANN that allow the model to fit the data better by providing each neuron with a constant value. They help in enabling the network to better fit complex patterns by adjusting the thresholds during the computation of the relationships. Together weights and biases enable ANN’s to learn complex relationships between attributes. Efficiency and accuracy of the model is based on fine tuning these parameters. These values are externally stored as configuration parameters to change dynamically per an analysis on the accuracy of the results.

Next, at Step 8, a personalization model is configured. One or more personalization model thresholds are first determined at 1745. An ANN which forms the core of the AI module is built with different factors as explained in the above sections. Values for each of these are stored by applying appropriate version mechanisms externally. Threshold values for each of the factors are determined and stored in the configuration files to fine tune and refine as required. Next, at 1746, one or more personalization model values are stored. The factors that are used to build the Personalization AI Model are stored externally either in ODS 1340 or other file storage. Components are developed to change these values dynamically per the business needs. The model configurations are version managed to record the efficiency and accuracy. Finally, at 1747 one or more personalization content model configurations are created. Based on all the factors defined and determined above the AI Model for the Personalization content are developed. These are self-contained code components which may be executed independently or in collaboration with the DemanData platform modules.

Processing then continues with Step 9 in which one or more models are generated employing one or more generations or iterations. It is a best practice to execute the AI model multiple times with different datasets of varying sizes in batches. By going through this process, the AI model provides better accuracy and results as it learns from the different datasets. For example, if there are 1000 training examples and a batch size of 100 there will be 10 iterations. A set of iterations are termed as epoch as results are evaluated by epoch. Processing multiple model generations may include the following:
a. Determine batch size;
b. Calculate or define the total number of iterations;
c. Create a training loop for the model to learn from the datasets;
d. Process data through the model;
e. Compute factors influencing the model along with the weights;
f. The above steps will be repeated and required to stop after meeting a predefined criterion;
g. Assess model results after each epoch;
h. Adjust parameters based on the performance and output;
i. Progress will need to be monitored based on the result set; and
j. Determine early stopping criteria in case there is no significant improvement in performance after each epoch.

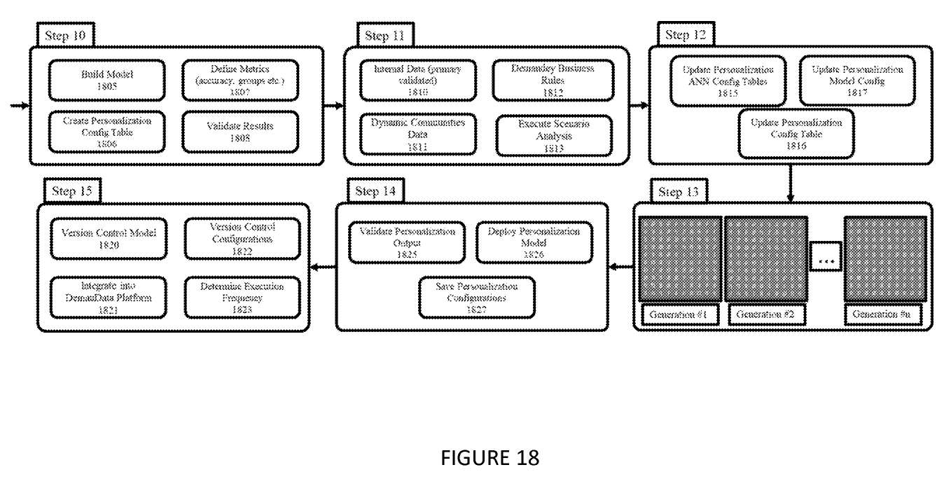

Processing continues with Step 10, shown in FIG. 18. As is shown in step 10, a build model is generated at 1805. Thus, after evaluating the results from the execution of the model in step 9, the model is finalized for the build process to be used on the DemanData platform. The final version of the Model is preferably created and deployed into the platform environment. Version of the values of the model will be stored in ODS 1340. Processing then continues to 1807 where one or more metrics are defined. Goals and metrics are defined for accuracy, efficiency, etc. for the model. Output of each execution of the epoch will be checked and documented against the goals. These metrics may then be adjusted based on the model output result set. At 1806 a personalization configuration table is preferably generated. All the factors and metrics defined against the model are stored in a configuration file or table to make it easy for the future executions. Components are deployed to make it easier and simpler to change these factors dynamically. Finally at 1808 results from the AI model are validated and evaluated for accuracy and efficiency.

Processing then continues at step 11 where internal data collected during the onboarding process of one or more consumers is accumulated. Such internal Dynamic Primary Validated Data may include one or more of the following: basic user data; user demographics; user behavior data; site navigation data; language settings and preferences; and user’s user journey on the platform. This data is preferably collected and stored in the DemanData platform ODS 1340. One of the key factors is that the collected data is dynamic and primary and validated at the source of collection prior to saving in ODS 1340. At step 1812 one or more business rules are defined. A rule employed by the DemanData platform is defined as a specific guideline or principle that provides a deterministic output. In the DemanData platform ML algorithms are leveraged in order to generate rules based on the historical and current (Facts) data available in the various repositories by implementing and deploying an automated process. These rules are further enhanced and specialized based on the product and/or type of purchase by the user. Rules identified through the automated ML process are stored in the repository and refreshed at a regular frequency. All the AI components/modules leverage the rules repository and is layered on top of the output generated by executing them. Generally, AI Models produces an output based on the datasets upon which it is developed and trained. A set of rules is defined and cross referenced in order to validate and ensure that the Model is producing outputs that are logical. For example: a person living in a city without a car purchasing paraphernalia for maintaining a car would normally be perceived as a gift (with exceptions coded based on other conditions like the person voluntarily giving information stating that they are expecting to soon purchase a car). Any exceptions to the rule defined above will be checked to ensure the AI model is working appropriately.

At 1811 Personalized data, or dynamic communities data is accumulated. Users that are registered with the DemanData platform are preferably ‘grouped’ internally into different communities. These communities may be based on geographic location, physical proximity, etc. The criteria can be the user purchases, behavior, changing wants, needs and desires. Grouping users into different communities helps to understand the purchasing trends, products usage etc. which can facilitate original sources of goods and services to build better products increasing customer satisfaction. On the DemanData platform the user’s one or more communities may be changed dynamically based on their user journeys, purchase behavior, searches made on the platform etc. From this AI Model perspective, the dynamic communities play a critical part in recommending one or more products to the user as purchases from a particular user in a particular community can be employed to provide proposed items to other users attached to the same or similar communities. Finally, at 1813 a scenario analysis is executed. The data that was used for development, training, testing and validation is then sliced and diced into various scenarios to ensure wider coverage of this personalization functionality. This is a key factor in improving performance, accuracy and efficiency of the AI Model.

Processing then continues at step 12 where various tables, models, and settings are updated according to new model outputs. At 1815 personalization ANN configuration tables are updated. This is the process of updating the relevant AI Model’s configuration tables to be able to change them dynamically. These are version controlled and tracked for providing feedback loop in improving efficiency of the model. At 1817 personalization model configuration tables are updated. All of the configuration parameters are updated immediately after the execution and validation of the result sets. These are then stored in external configuration files providing flexibility to make changes without having to go through the time-consuming build and deployment process. At 1816 personalization configuration tables are also updated after each model execution.

Next, processing passes to step 13 where final models are generated. The sequence to execute and process the AI model are iterated through multiple times to refine the results for accuracy, model efficiency and performance. Steps explained in the section above for Model generations (step 9) are preferably repeated here while updating the parameters for accurate results. The model output results are validated manually by developing and applying different test cases and scenarios. After these new models are generated processing continues at step 14 in which various personalization steps are performed. Personalization output from the personalization model for product recommendations is validated at 1825 and is then deployed at 1826. The following steps are preferably followed to deploy the model: Save the model to a file that contains all necessary information (containerize) for making predictions; Keep different model versions using the Bitbucket repository; Package the serialized model and its dependencies into a container; Deploy the trained model into the environment; Set up monitoring tools to track the model's performance, catch errors, and detect any drift in behavior over time; and Implement encryption, authentication, and access control to protect the model and data from unauthorized access. Then at 1827 the personalization configurations are saved. The model, its factors and related configuration is saved for future use, allowing these saved elements to be updated in the future per business needs.

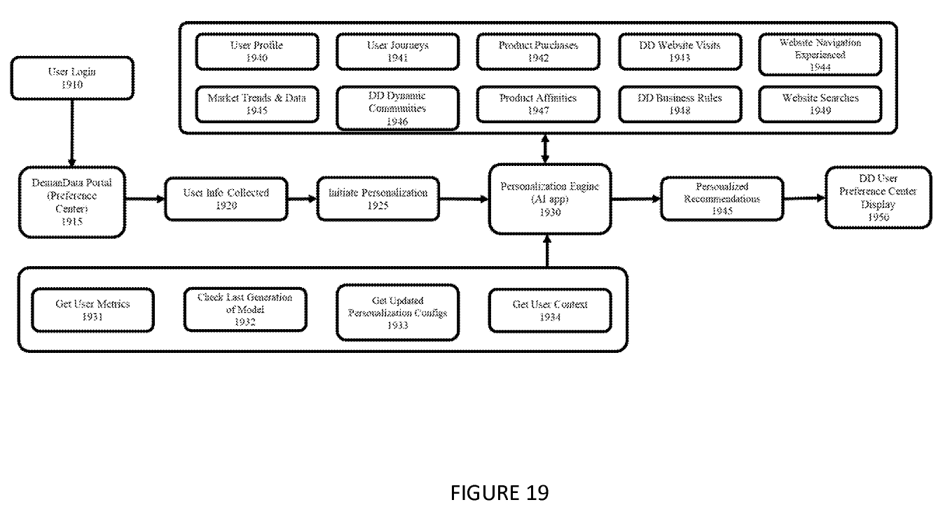

Referring next to FIG. 19, a use case for the application of personalized content in accordance with an embodiment of the invention will be described. At step 1910 a user, such as an Individual Consumer, first enters credentials to login to the DemanData platform. Then at step 1915, after the user’s credentials are validated, the user is logged into the DemanData platform preference center. Login time and other information is captured and saved in ODS 1340. Then at step 1920 user information is collected. Information regarding the profile, number of logins, etc. is preferably collected from ODS 1340 to be presented to the personalization component of the system, and at step 1925 the personalization engine is initiated in order to perform the one or more personalization steps described above. The personalization content engine (the AI app described above) is implemented at 1930. Inputs to the processing at 1930 include one or more of the following:
User Profile 1940: Information related to the basic profile is put into the platforms state machine to be presented to the personalization engine.
User Journeys 1941: All the data that was captured as the user browsed on the platform (i.e. products searched, features & specifications viewed etc.) is fetched into the state machine.
Product Purchases 1942: Detailed data regarding the past purchases made on the platform are fetched from ODS 1340.
DemanData Website Visits 1943: Number of times the user has visited the website is fetched.
Website Navigation Experienced 1944: Information that is specific to the user’s navigation on the website is captured and made available to the personalization engine.
Website Searches 1949: Different searches made by the user on the platform are fetched and made available for use by the personalization engine
Market Trends & Data 1945: Data from any external sources (if employed in an alternative embodiment of the invention, such as social media, NPD, IRI etc.) is fetched from the platform’s repositories.
DD Dynamic Communities 1946: Data that is related to the grouped communities is fetched.
Product Affinities 1947: The data that is captured with respect to the products that the user is interested in is fetched to provide as input into the AI model.
DD Business Rules 1948: System fetches business rules related to the product and context the user is in are identified and will be made ready in the memory.

In addition to the above information, various information is fetched from the platform in order to further inform the personalization content engine 1530, and may include one or more of the following:
Get User Metrics 1931: The user metrics related to the number of purchases, feedback provided, satisfaction level etc. are fetched from ODS 1340.
Check Last Generation of Model 1932: System ensures that the version of the AI model being used is the latest and approved version in the repository.
Get Updated Personalization Configs 1933: All the configuration information is validated and fetched to make any changes, if required.
Get User Context 1934: Content related to the user’s request along with context is provided as additional inputs to the engine.

One potential output from the personalization content engine 1930 may comprise personalized product recommendations at step 1945. The AI model is executed with all the inputs from the above sections. The latest version of the configuration parameters and the model are fetched from the version management repository. With the data that is fetched and stored in the session along with user’s context will be provided as input to this AI model. After the execution is complete the AI model will generate one or more potential products that can be recommended to the user. These potential products are then displayed to the user in the preference center at step 1950.

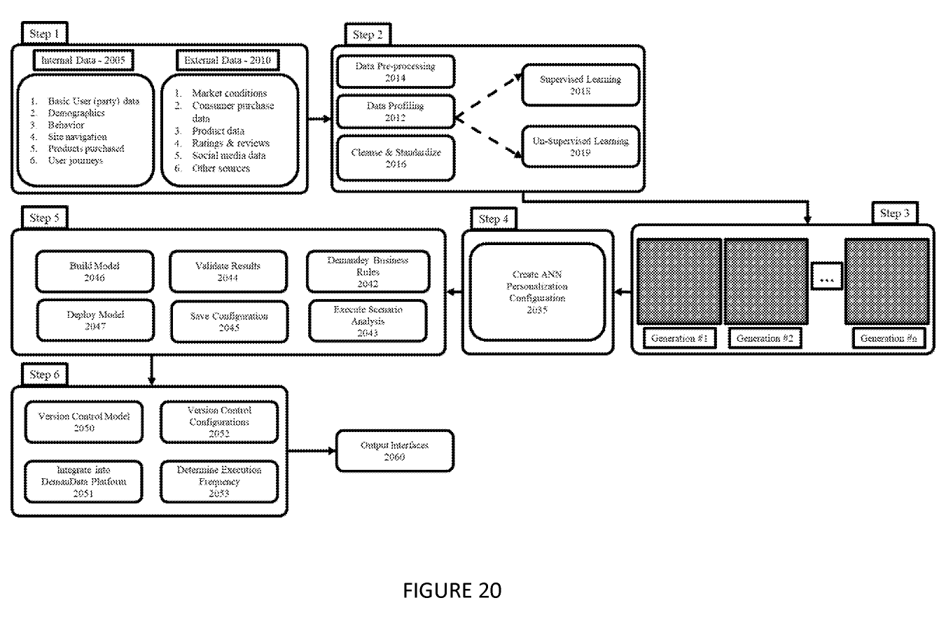

Referring next to FIG. 20, a more detailed description of use of the personalized marketing system 178 (see FIG. 13) to provide personalized marketing will be described. The DemanData Personalized Products Recommendations application 178 uses AI models to analyze users' Dynamic Primary Validated Data, through customer surveys, community interactions, and purchase history, to recommend highly relevant related products, enhancing the shopping experience with precision. With traditional ecommerce, content is presented to users in terms of what is most profitable for the company, or who has paid for the advertising, product placement, etc. With DemanData, users are only presented with tailored recommendations based entirely on the users’ personal Dynamic Primary Validated Data and behavior on the platform, the perfect Consumption centric model. The Customer Surveys AI application (as part of the marketing system) enhance customer experience by automatically sending and analyzing user feedback through advanced AI models. This application features automated question generation and survey creation, summarizing feedback and estimated participation rates, thereby streamlining the survey process and providing actionable insights for improving customer satisfaction. Additionally, this application supports generating heatmaps, conducting servicing surveys, matching Original Sources’ goods or services with Individual Consumer wants needs, and desires, and tracking consumer behavior on the site, all of which feed into the Preference Center for personalized service.

As is shown in Step 1, first internal data 2005 is collected, and may comprise one or more of: 1) basic user data; 2) user demographics; 3) user behavior data; 4) site navigation data; 5) prior purchased products information; 6) user’s user journey on the platform, and 7) Individual Consumer Future Intent to Purchase Data. This data is collected and stored in the DemanData platform ODS 1340. One of the key factors of this collected data is dynamic and primary and is validated at the source prior to saving in ODS 1340. Additionally, in an alternative embodiment of the invention, external data 1610 (information and attributes that are collected from one or more external agencies, repositories and through sensing (via user reviews, feedback, surveys etc.)), is preferably collected at Step 1, and may comprise one or more of: 1) market conditions data; 2) consumer purchase data; 3) product data; 4) ratings and review data; 5) social medial data; and 6) other sources, etc., by way of example only. This external data is also preferably stored in the platform’s ODS 140 and used for analytics and AI modules. Proprietary tools and utilities (such as data profile) may be applied to ensure consistency before storing data in ODS 140. (We are not using external data other than to verify demographic or geographic information).

Processing then continues at step 2 where data profiling 2012 is first performed. During the data profiling process, all of the data collected and captured in the system at various touchpoints is assessed for quality and consistency. Profiling comprises a mechanism of evaluating the quality of data prior to storing in the ODS. There are preferably over 12 metrics (such as consistency, null-check, integrity, variance etc., by way of example only) that may be applied to data stored in the various ODS’s. This is a component that allows for the processing of large volumes of data in a short period of time.

Collected data is then pre-processed at step 2014 and is preferably cleaned and standardized at step 2016. Data cleansing is the process of identifying and correcting or removing errors, inaccuracies, and inconsistencies in the data. Standardization is the process of transforming data into common format that can be easily understood and used across different modules of the DemanData platform. Some examples of standardization comprise one or more of converting data to consistent formats, applying uniform rules and structures, and ensuring compatibility between different sources, which is important when data is procured, in the alternative embodiment of the invention, from disparate sources such as social media platforms, etc. Processing then passes to both supervised learning 2018 and unsupervised learning 2019 techniques. Supervised learning comprises a standard machine learning (ML) technique where algorithms are trained on labeled data. This means each input data point is paired with a corresponding correct output. The goal is for the model to learn the mapping from inputs to outputs, enabling it to make accurate predictions on new, unseen data. Supervised learning is commonly used for tasks such as classification and regression. In classification, the algorithm assigns input data into predefined categories, while in regression, it predicts continuous values. Unsupervised learning, in contrast, deals with unlabeled data. Here, the algorithm tries to identify patterns and structures within the data without any pre-existing labels or outputs. This approach is useful for clustering, where the algorithm groups similar data points together, and for association tasks, which involve finding relationships between variables in a dataset. Unsupervised learning is often used when the goal is to explore the underlying structure of the data without specific outcomes in mind.

Processing then continues at Step 3 employing a neural network where personalization correlations are determined, comprising a measure of association or relationship between attributes in the dataset without relying on predefined labels. These correlations are preferably determined by applying both unsupervised and supervised ML techniques on the datasets of the DemanData platform. The personalization correlations are primarily used for one or more of: 1) pattern discovery – identifying hidden structures and relationships between attributes of the dataset; 2) feature extraction – capturing essential information from the dataset to enable meaningful distinctions; and 3) dimensionality reduction – reducing the number of features while preserving important information (for example: user to product to payment to logistics relationships are derived directly as opposed to going through the cardinality like 3rd normal form).

At a next step 4, an output layer is then determined at 2035. The output layer is an artificial neural network (ANN) is the final layer that produces the network's predictions or results, comprising a personalization configuration. Such an output layer comprises one of more of the following key characteristics and functions: 1) Final layer: The output layer is the last layer in the neural network architecture, responsible for producing the final output based on the inputs processed through previous layers; 2) Number of nodes: The number of nodes in the output layer depends on the specific problem being solved. There are various methods (such as Binary classification, Multi-class classification, Regression) to determine the number of nodes; 3) Transforming inputs: The output layer preferably receives transformed data from the hidden layers and applies weights and biases to produce an output; and 4) Producing predictions: The output layer generates predictions that can be interpreted directly or require further processing, such as converting probabilities into class labels in classification problems. The output layer plays a critical role in determining how an ANN's learned patterns are translated into actionable insights or decisions. In accordance with an embodiment of the invention, the network is preferably iterated until received results are reasonable and meet a predetermined threshold.

Processing then proceeds at step 5, where a model is built at 2046. Then at 2044 the model results are validated for accuracy and efficiency. DemanData business rules are then applied at 2042.

A scenario analysis is then executed at 2043. The data that was used for development, training, testing, and validation will be sliced and diced into various scenarios to ensure wider coverage of the personalization functionality. This is a key factor in improving performance, accuracy, and efficiency of the AI Model. Once completed, personalized configuration tables and models are updated and saved at 2045. This includes updating the relevant AI Model’s configuration tables to be able to change them dynamically. These are version controlled and tracked for providing a feedback loop in improving efficiency of the model. This updating process also includes updating configuration parameters after the execution and validation of the result sets. These updated configuration parameters are stored in external configuration files providing flexibility to make changes without having to go through the time-consuming build and deployment process. This process finally includes updating personalization configuration tables that store the various configuration parameters after each execution and also updating language settings which are useful when integrating with Generative AI components. The context of the data and factors plays an important role when generating responses and hence this plays a critical step in the AI model build and deployment process.

The final version of the model is created and deployed into the platform environment at 2047. The following steps are preferably followed to deploy the model:
Save the model to a file that contains all necessary information (containerize) for making predictions
Keep different model versions using the Bitbucket repository
Package the serialized model and its dependencies into a container
Deploy the trained model into the environment
Set up monitoring tools to track the model's performance, catch errors, and detect any drift in behavior over time
Implement encryption, authentication, and access control to protect the model and data from unauthorized access

Processing then continues at step 6 where at 2050 the model is version controlled. Thus, the model and parameters are controlled through version management as it helps track results, accuracy and efficiency. This is a standard and straightforward process in helping assess whether to go forward or rollback in case required. At 2052 the configurations applicable to the models are also controlled through version control. At 2051 the new models are integrated into a production platform. This is the final step in the AI model creation. The AI model is thus integrated into the DemanData platform. Finally, at 2053 execution frequency is determined. It is important to understand and determine frequency of the AI model execution. The frequency is based on changing business needs and usage patterns. On the DemanData platform the models are monitored and checked regularly (monthly, for example) to cater to the market and user demands. It is also possible to update the model in parallel with the production instance and then to test to see if an updated model provides significantly improved and more accurate output.

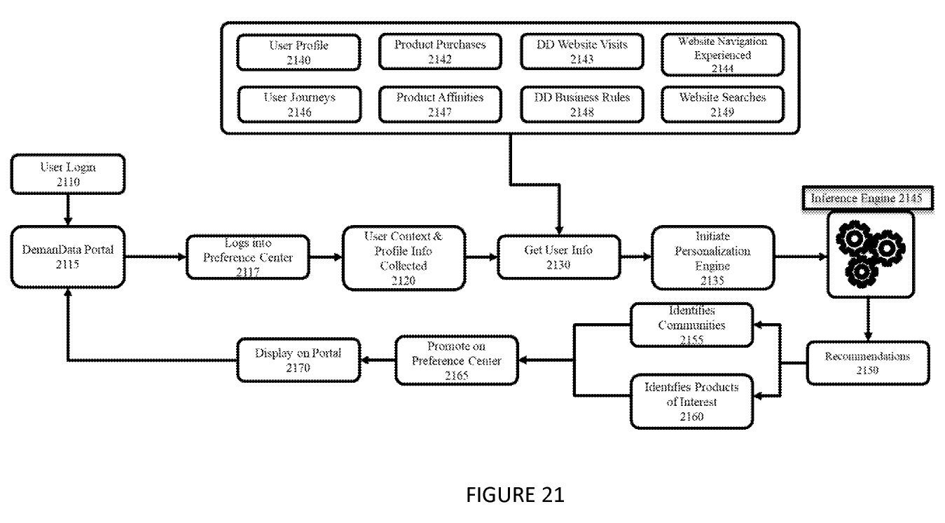

Referring next to FIG. 21, a use case for the application of personalized marketing 178 in accordance with an embodiment of the invention will be described. At step 2110 a user first enters credentials to login to the DemanData platform. Then at step 2115, after the user’s credentials are validated, the user is logged into the DemanData platform. Login time and other information is captured and saved in ODS 1340. At step 2117 the portal then logs the user into the preference center. Then at step 2120 user content and profile information is collected. Information regarding the profile, number of logins, etc. is collected from ODS 1340 to be presented to the personalization component of the system. The personalization engine (the AI app described above) is implemented at step 2140. Inputs to the processing at step 2140 include one or more of the following collected as user data at step 2130:
User Profile 2140: Information related to the basic profile is put into the platforms state machine to be presented to the personalization engine.
User Journeys 2146: All the data that was captured as the user browsed on the platform (i.e. products searched, features and specifications viewed etc.) is fetched into the state machine.
Product Purchases 2142: Detailed data regarding the past purchases made on the platform are fetched from the ODS.
DemanData Website Visits 2143: Number of times the user has visited the website is fetched.
Website Navigation Experienced 2144: Information that is specific to the user’s navigation on the website is captured and made available to the personalization engine.
Website Searches 2149: Different searches made by the user on the platform are fetched and made available for personalization engine
Product Affinities 2147: The data that is captured with respect to the products that the user is interested in is fetched to provide as input into the AI model.
DemanData Business Rules 2148: System fetches business rules related to the product and context the user is in are identified and are made ready in the memory.

Once the data is collected, personalization engine is initiated at step 2135 and the inference engine processes the input data at step 2145. The output comprises a group of one or more recommendations at step 2150. The recommendations in turn allow for one or more communities to be identified to which the user may be attached at step 2155 or identify one or more products that may be of interest to the user at step 2160. These recommendations are then promoted on the preference center at 2165 and displayed on the user portal to the user at step 2170.

Expert Advisor 176. This function preferably interactively extracts information from a user using common language prompts and responses to ultimately provide advice as to the best product-user fit for their particular, individual use case. Expert Advisor is a sophisticated rules- based system that delivers product recommendations with exceptional precision. Utilizing multi-factorial search technology, the Expert Advisor aligns Individual Consumers’ wants, needs, and desires with the most required functionality and technical attributes of those products or services, to provide the ultimate satisfaction for the Individual Consumers’ particular wants, needs, and desires. This provides the user with suitable, brand agnostic recommendations for products and services. This advanced matching process ensures that buyers receive only the most relevant Individual Consumer centric highly personalized recommendations that align with their personal wants, needs and desires.

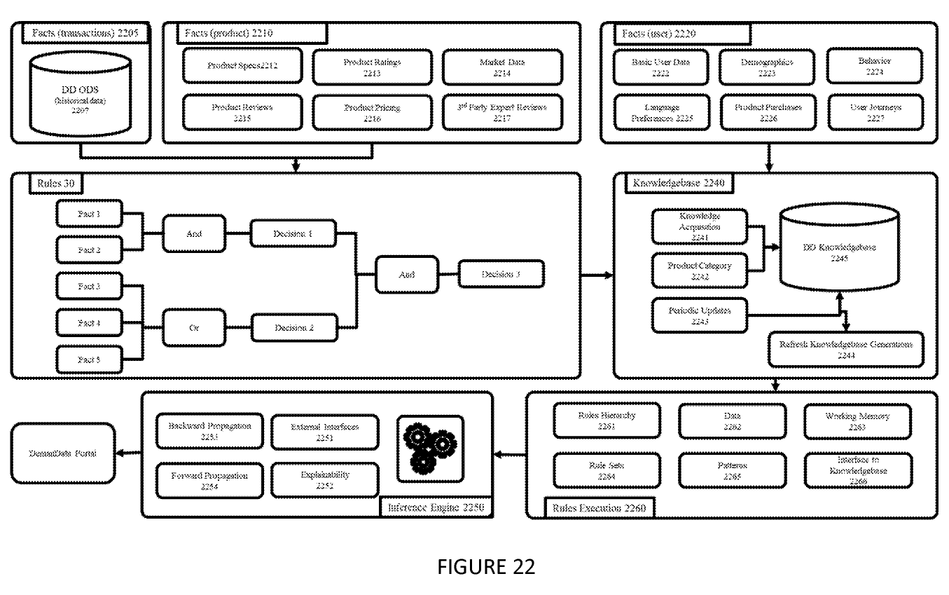

Referring to FIG. 22, Expert Advisor 176 will be described in greater detail. Expert Advisor 176 begins with a set of transaction facts 2205 (including historical transactions stored in an ODS 2207) and a set of product facts 2210. Transactional facts 2205 comprise data that is stored in an ODS 2207 as one or more users make one or more purchases in the system. ODS 2207 may also contain data related to the user demographics, profile and other general information, including but not limited to demographic, geographic, psychographic, and behavioral data. In a preferred embodiment, only the last 12 months of data is available in ODS 2207 while data older than 12 months is preferably stored in one or more historical data tables. Product facts 2210 comprise data that is related to one or more products and is preferably stored in a product data store. Architecturally, this product data store may be stored in a Content Management System (CMS). CMS is critical part of the DemanData platform architecture. The content required for the products (such as product specifications, ratings, reviews etc.) and the website (images, audio & video files, fonts etc.) are stored in the CMS. Generally, CMS systems are built on top of relational databases like MySQL, Postgres and etc. This data store preferably contains both the current and historical data that has been transacted on the DemanData platform. Data stored within the data store may include one or more product specifications 2212, product ratings 2213, market data 2214, product reviews 2215, product pricing 2216, and, in an alternative embodiment of the invention, trusted 3^{rd} party expert reviews 2217. Product specifications 2212 may comprise specifications of the product including the features, images, audio and video data. Data related to each Original Source is also preferably included in this data store. During execution of the Expert Advisor matching process this data is preferably utilized for providing recommendations to the user. Product ratings 2213 preferably comprise ratings related to one or more products. This product ratings data may preferably be sourced from both external and internal labs or other product review functions which rate the products after testing across various parameters. Notably, various weights may be assigned to one or more particular aspects of each product based on the number of parameters, criticality and importance of the feature in accordance with user wants, needs, and desires. Market data 2214 from sources which store data such as the quantity of products sold, amount, volume and etc. preferably comprises external data that is preferably provisioned by purchasing from external sources and may be employed. Data purchased is preferably updated at a regular frequency as defined in the agreement with the respective providers. Product reviews 2215 preferably comprise a repository of reviews of products offered for sale, such reviews being performed by testing labs and the like preferably engaged by DemanData. Data available in both the internal and external repositories are the datastore components of architecture. These repositories are created on relational databases and are sourced and saved in these data stores. Product Pricing 2216 comprises a repository of pricing associated with one or more products that are to be presented to users. Any specific Original Source offers or promotional data is preferably also included as part of this data store. Finally, in an alternative embodiment of the invention, and in order to supplement internal product reviews 2215, reviews from trusted 3^{rd} party experts may be utilized.

Expert advisor 176 further utilizes a set of user facts 2220 preferably comprising a repository storing all data related to one or more users. This data may further comprise data that is associated with user’s profile, changes made during the life of the user’s account, product interests and other information. This factual data will be referenced as appropriate and linked for analytics, preference center interactions, providing promotional information, and providing information related to one or more products or services in which one or more users may be interested. User facts 2220 preferably include one or more of basic user data 2222, demographics 2223, behavior 2224, language preferences 2225, product purchases 2226, and user journeys 2227. Basic user data 2222 comprises a repository of basic information (such as name, address, email etc., by way of example) that is requested of a user when creating the account to facilitate the procurement process. Demographics 2223 comprises a repository of a user’s demographic data requested from a user, and may preferably comprise age, gender, ethnicity, education, income, and the like. Behavior 2224 preferably comprises a repository of information collected with respect to pages visited, search behavior, lifestyle, email interactions etc. of a user. Language preferences 2225 preferably comprises a repository of language preferences of a user. Product purchases 2226 preferably comprises a repository of Information related to the purchase of one or more products purchased by one or more users, and may further include Future Intent to Purchase Data from Individual Consumers. Also preferably captured in this repository is information comprising a device used, geo location, amount of time spent on one or more product or other website pages, and the like, by way of example. Finally, User Journeys 2227 comprises a repository of data related to one or more user journeys. The type of information that is captured preferably comprises one or more of a user’s touchpoint with the platform, user’s searches and compare options, number of times website is visited, product pages, pricing information, and the like. This user journey information is recognized by the inventors of the present invention as some of the most key and critical input information when applying AI algorithms to predict a future user’s behavior.

Transaction facts 2205 and product facts 2210 preferably feed into a rules engine 2230. A rule is preferably defined as a specific guideline or principle that provides a deterministic output. In accordance with the present invention, Machine Learning (ML) algorithms will be leveraged to generate rules based on historical and current Facts (2205 and 2210) data available in the various repositories by implementing and deploying an automated process. These rules may be further enhanced and specialized based on the product and/or type of purchase by the user. Rules identified through the automated ML process are preferably stored in a repository (such as ODS 1340) and refreshed at a regular frequency. All the AI components/modules leverage this rules repository and layered on top of the output generated by executing them. All the business rules required are preferably stored in a relational database base (such as ODS 1340) to manage and makes changes dynamically. This is one of the key components depicted in the platform architecture. While any rules scheme can be employed, the exemplary set of rules 2230 include facts 1 and 2 with a binary “AND” gate resulting in decision 1, and facts 3, 4, and 5 with a binary “OR” gate resulting in decision 2. A further “AND” gate takes decisions 1 and 2 as inputs and outputs a decision 3.

User facts 2220 and an output from rules 2230 are then preferably input to knowledgebase 2240. Knowledgebase 2240 preferably comprises a knowledgebase repository 2245 that is preferably a centralized repository that stores all information that is vital and critical to analyzing and predicting user’s behavior and choices. The data in this repository is organized in structural format that is friendly for search process and to enhance the user experience of the platform. This knowledgebase is refreshed at a regular frequency per the changing needs and behaviors. This information is critical in the following processes: (1) Product recommendations; (2) Dynamic user communities; (3) Personalization; (4) Personalized Preference Center content; and (5) other processes.

Knowledgebase repository 2245 further receives input from Knowledge Acquisition store 2241 and Product Category store 2242. Knowledge acquisition store 2241 captures knowledge about products, transactions and users, and are preferably acquired from both internal and external sources. Depending upon the frequency of updates, both batch and real-time interfaces are utilized for capturing and saving data in the repository. The knowledge thus gathered is preferably stored in a Graph-database in the form of tuples for context and accuracy of the knowledge. A graph database is a type of database that uses graph structures to store and manage data. It is based on graph theory and consists of nodes, edges, and properties. They are designed to efficiently store and query relationships between data entities, making them ideal for applications like social networks, recommendation systems, and fraud detection. Tuples are immutable, ordered collections of elements, which makes them suitable for representing fixed sets of related data. Each tuple represents a single entry in the knowledgebase. This format allows for easy retrieval and parsing of information when processing for inferencing. In Product Category store 2242, product information is preferably organized and stored based on their characteristics in different categories to make it consistent from storage perspective and faster for retrieval and usage in the execution.

Based on the agreement and type of products, data in the knowledgebase is preferably updated at a predefined frequency in accordance with a Periodic Update procedure 2243. The refresh frequency varies by the OS, type of product, and potentially reviews provided by the DemanData or other user either in the current platform, or on other social media sites. Furthermore, AI components are preferably executed using data in the knowledgebase, and outputs are stored in separate repositories/tables. These are saved and a version number is assigned per the generation of outputs. Based on the frequency of updates to the data, the generations will be executed and outputs stored with an associated generation number. This allows revisiting and/or fine tuning to compare against previous generations of the knowledgebase outputs to improve accuracy and efficiency.

Processing then continues upon implementation of a Rules Execution process 2260. Rules stored in the knowledgebase are triggered based on the type of product, relevance, context and the recommendation requested by the user. The Rules Execution process 2260 further comprises a rules hierarchy 2261, data 2262, working memory 2263, rule sets 2264, patterns 2265, and an interface 2266 to knowledgebase 2240. Rules Hierarchy 2261 preferably comprises a business rules hierarchy, which is a way to organize one or more applicable rules in a model with generic rules at the top and more specific rules at the bottom. This structure helps address reducing the complexity while improving performance of the system during run-time execution. Each rule is unique and given an identifier along with priority and level of criticality to business operations. Data 2262 preferably comprises data that is captured while the user is going through the procurement process in accordance with one or more processes in accordance with the present invention. Along with details related to one or more products, this data is preferably stored in ODS repository 1340. This is preferably referred to as factual data which is used for deriving rules, analytics and other insights required for various business operations. Working Memory 2263 further comprises data and rules that are required based on the user’s request. These items are preferably brought in from longer term storage and processed for faster execution. The memory that is used during the time of processing is defined as working memory. This helps with better performance of the system and provides a better user experience. Rule sets 2264 comprise a collection of relevant rules that are used to evaluate data, customize how requests are handled for automated decision making. All the rules in a particular set preferably should be executed for generating an output. Although rules in a set can be executed individually and separately, they should all be executed together if they are grouped together as a set, thus allowing for quick and consistent execution of a particular task. If not grouped together, there can be scenarios where a rule in the rule set may need to be executed individually. In these scenarios each rule is preferably identified and categorized separately. Patterns 2265 are preferably identified in a manner so that repeated inputs or outputs are identified as such a pattern, the pattern being useful during future processing of additional data. All of these rules comprising rules execution 2260 are integrated into knowledgebase 840 via interface 866. Both batch and real-time interfaces are preferably available to leverage data, facts and rules stored in knowledgebase 2240.

Processing then continues with inference engine 2250 which is a component of the Expert Advisor AI module which is designed to derive logical conclusions from knowledgebase 2240 using reasoning techniques based on the rules 2230 and rules execution 2260 implemented in the platform. These rules in DemanData platform are extracted from the DemanData ODS 1340and historical data repositories using ML techniques. Relevancy of these rules are monitored and checked by the product subject matter expert at a predefined frequency. Accuracy and efficiency of the Inference engine output is directly correlated to the knowledgebase, relationships and rules implemented in the platform. Where and when possible, patterns are preferably identified through the automated process (as noted above) and stored in knowledgebase 2240. Interface engine 2250 relies on one or more external interfaces 2251, which are employed as it is important and critical to capture data from the sources that are not implemented within the DemanData platform. Batch and Real-time integration techniques are preferably implemented to get data from the external sources. All integration mechanisms to such repositories or platforms are defined as External interfaces 2251.

Inference engine 2250 further relies on an explainability concept 2252 in order to provide an understandable explanation for one or more recommendations given to user based on their inputs. It is important to be able to explain the reason for recommendation to the user from a transparency perspective. Inference engine 2250 uses backward propagation 2253 and forward propagation 2254 techniques to explain the one or more recommendations. A backward propagation 2253 is an AI component of inference engine 2250 that starts with a goal and works backward to determine necessary conditions. This is useful for diagnosis and proving the hypothesis for a recommendation by the Expert Advisor. A forward propagation 2254 is an execution technique is used in accordance with inference engine 2250 which initiates the process of recommendation with known facts in the knowledgebase and applies relevant rules to derive new facts. This helps with prediction and planning phase of execution in the AI component.

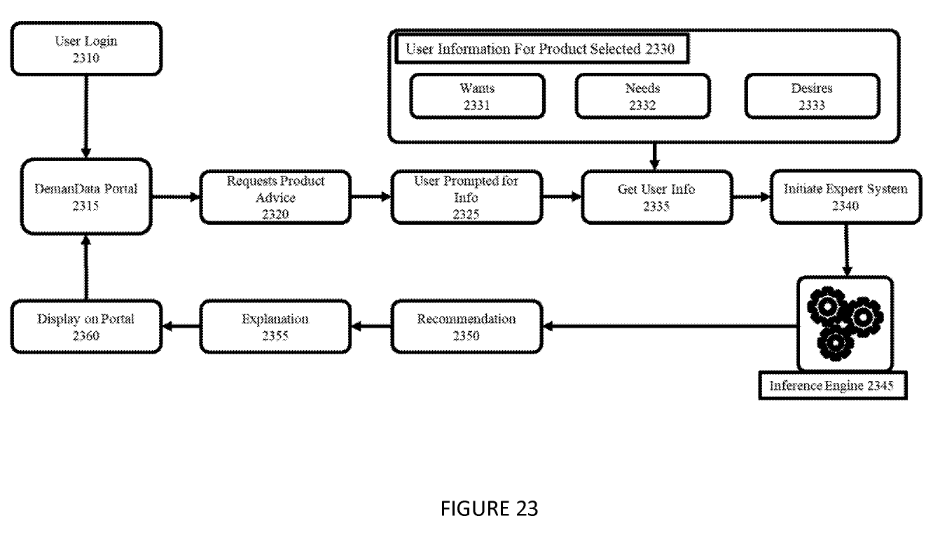

Further implementation of Expert Advisor 176 is shown in FIG. 23. As is shown in FIG. 23, an Individual Consumer user first logs into the Expert Advisor 176 module at step 2310 by entering credentials to login to the DemanData platform via a DemanData portal 2315. After the user’s credentials are validated, the user is logged into the platform. Login time and other information is preferably captured and saved in ODS 1340. Processing then proceeds to step 2320 where the user requests product advice and is able to browse one or more products and chooses to leverage Expert Advisor (all the webpage interactions are captured into ODS 1340), and then to step 2325 where the user is prompted to provide various general user information to assist with their request. Additionally, user information for the request for a particular product is collected at step 2330, and preferably includes wants 2331 (captured via a series of prompts), needs 2332 (identified by gathering information that is available in the DemanData platform), and desires 2333 (based on the information available, other insights, and one or more prompts to the user). The information collected at steps 2325 and 2330 is provided to the system at step 2335 and an expert system is then initiated at step 2340. A request to the expert system to process all the information captured in the above sequences is made ready to be presented to an inference engine 2345 which processes factual data received from the knowledgebase, relevant rules, information secured from various repositories, product related data and makes a recommendation (along with the explanation on how it arrived at the final recommendation), to the user. Inference engine 2345 preferably outputs one or more recommendations at step 2350 with an explanation 2355 which is generated using backward propagation to provide the explanation for the recommendation, and is ready to be presented to the user. This information is then displayed to the user via portal 2360 as part of the DemanData portal 2315.

One Prompt Purchase 171. This function allows a user to purchase a good or service in response to a single prompt being presented to them. The One Prompt Purchase application is designed to streamline the purchasing process by allowing users to buy products with a single prompt, assuming payment information (address, delivery preferences, etc.) is already provided. This application aims to emulate the convenience of well-known one-click purchase features.

Content Generation 174. The Content Generation AI application leverages generative AI, specifically a large language model (LLM), to enrich and provide product-specific content for a website. This application includes proprietary tools for content generation and management. Key use cases involve creating detailed product pages, including descriptions and competitor pricing. The application also processes expert and community user reviews to provide concise summaries, generates scorecards and ratings with explanations, and offers smart context search functionalities with prompt hints to help users find more information.

User 175. This function performs all items related to setup and maintenance of one or more user support functions. DemanData is transforming how customers experience a personalized, efficient, and engaging shopping experience where they will have full control and complete Data transparency. The Individual Consumer Preference Center is a cutting-edge platform feature designed to empower users by allowing them to control their interaction with our service. It serves as a centralized hub where customers can specify their preferences regarding the types of content, communications, and product recommendations they wish to receive.

Communities 177. Communities comprise groups of Individual Consumers with one or more common interests related to purchasing one or more goods or services. Such communities may be set up around lifecycle events (i.e. weddings, pregnancy, birthdays, retirement, senior age, etc.), interests (i.e. running, bicycling, music, reading, etc.), geography (location, environmental characteristics, etc.), and the like. Dynamic communities allow for the dynamic modification of community membership, definition, focus, etc. Dynamic real-time communities are generated and maintained by analyzing users personal Dynamic Primary Validated Data, presenting relevant information and products. This fosters connection among users with similar interests, enhancing the sense of community on the platform. A more detailed description of the formation and use of dynamic communities will now be provided.

Referring to FIG. 24, at step 1, internal data 2410 is retrieved. All the information and attributes captured during the user registration process is defined as internal data. Examples of internal data are as follows: 1) basic user data; 2) user demographics; 3) user behavior data; 4) site navigation data; 5) products purchased; 6) user’s user journey on the platform 7) user Future Intent to Purchase Data. This data is collected and preferably stored in the DemanData platform ODS 1340. One of the key factors of this Dynamic Primary Validated Data is that it is validated at the source prior to saving in ODS 1340.

In an alternative embodiment of the invention, in addition to this internal data, external data 2412 may also be retrieved at step 1. This external data may include information and attributes collected from external agencies, repositories and through sensing (e.g., if employed, via user reviews, feedback, surveys etc.). Examples of external data are as follows: 1) market conditions; 2) consumer purchase data; 3) product data; 4) ratings and reviews; 5) social medial data; 6) other relevant from external sources. If collected, this data is also preferably stored in the platform’s ODS 1340 and used for analytics and AI modules. Processing then continues at step 2 where data profiling 2415 is first performed. During the data profiling process, all of the data is collected and captured in the system at various touchpoints are assessed for the quality and consistency. Profiling comprises a mechanism of evaluating the quality of data prior to storing in ODS 1340. There are preferably 12 or more metrics (such as consistency, null-check, integrity, variance etc., by way of example only) that will be applied to the data stored in ODS 1340. This is a component that allows for the processing of large volumes of data in a short period of time.

Collected data is then preferably cleaned and standardized at step 2416. Data cleansing is the process of identifying and correcting or removing errors, inaccuracies, and inconsistencies in the data. Standardization is the process of transforming data into common format that can be easily understood and used across different modules of the DemanData platform. Some examples of standardization comprise one or more of converting data to consistent formats, applying uniform rules and structures, and ensuring compatibility between different sources, which is important when, in accordance with the alternative embodiment of the invention, data is procured from disparate sources. Processing then passes to both supervised learning 2417 and unsupervised learning 2418 techniques that are well known to one of ordinary skill in the art. Supervised learning comprises a standard machine learning (ML) technique where algorithms are trained on labeled data. This means each input data point is paired with a corresponding correct output. The goal is for the model to learn the mapping from inputs to outputs, enabling it to make accurate predictions on new, unseen data. Supervised learning is commonly used for tasks such as classification and regression. In classification, an algorithm assigns input data into predefined categories, while in regression, it predicts continuous values. Unsupervised learning, in contrast, deals with unlabeled data. Here, the algorithm tries to identify patterns and structures within the data without any pre-existing labels or outputs. This approach is useful for clustering, where the algorithm groups similar data points together, and for association tasks, which involve finding relationships between variables in a dataset. Unsupervised learning is often used when the goal is to explore the underlying structure of the data without specific outcomes in mind.

Processing then continues at step 3 where Communities Correlations are determined at 2420. The measure of association or relationship between the attributes in the dataset without relying on predefined labels is defined as communities’ correlations. This is determined by applying both unsupervised and supervised ML techniques on the datasets of the DemanData platform. The communities correlations are primarily used for:
Pattern discovery – identifying hidden structures and relationships between attributes of the dataset
Dimensionality reduction – reducing the number of features while preserving important information (for example: user to product to payment to logistics relationships are derived directly as opposed to going through the cardinality like 3rd normal form)
Development Data Set

From the data available in the DemanData platform (in ODS 1340 such as internal and external collected data) a dataset is preferably created to be used for the development team’s component development and unit testing purpose. This helps with the unit test while validating the hypothesis at a very granular level. The hypothesis is that the dataset created will encompass combinations of scenarios to represent personalization. This process is defined as the Personalize dataset used for functionality development purposes.

After community correlations are determined, processing continues at step 4, where the following data sets are preferably determined:

Development Dataset 2425 – The data that is used for maturing the AI Model is sliced and diced to encompass all different scenarios and factors. The datasets are created and differentiated based on the usage i.e. for development, testing & validation or training. The dataset that will be leveraged during the development of the AI Model is categorized as Development Dataset.

Validation Dataset 2427 - The validation dataset that is created from the various repositories of the DemanData platform to be used to validate the functionality is defined as the Validation data. This is a critical step in validating the AI model and building on the knowledgebase to be used on the platform.

Test Dataset 2428 - The test dataset that is created from the various repositories of the DemanData platform to be used to test the functionality is defined as the Test data. This is a critical step in testing the AI model and building on the knowledgebase to be used on the platform.

Generally, datasets such as these are iterated and changed to improve the accuracy and efficiency of the model. A training dataset that is leveraged for one generation of the model is recycled and exchanged with Test dataset. This is a best practice which helps with the accuracy and efficacy of the AI Models.

Processing then continues at step 5 in which first an Input Data Layer 2430 is defined. An input data layer is the first layer in an artificial neural network (ANN) and is responsible for receiving one or more input data. It consists of nodes or units that correspond to each feature of the input data. The primary functions of the input layer include: 1) a receiving node: each node (or neuron) in the input layer takes in one feature of the input data, such as pixel values in an image or attributes in a dataset; and 2) passing data forward: The input layer nodes pass the received data directly to the neurons in the first hidden layer without performing any computations themselves. In accordance with an embodiment of the invention there is preferably one input layer to manage all the data that is required to execute this AI module. The number of inputs may vary based on the number parameters that are to be considered. Flexibility is embodied in the platform to dynamically change the number of parameters by storing in an external configuration file.

A number of hidden layers is then determined at 2431. Hidden layers are intermediate layers between the input and output layers. They are crucial for transforming and processing the input data to extract features and patterns. Key aspects of hidden layers are as following: 1) Computation: Each neuron in a hidden layer takes inputs from the previous layer, applies weights, sums them up, adds a bias, and passes the result through an activation function to introduce non-linearity; 2) Feature extraction: Hidden layers help in extracting complex features from the input data by performing various transformations. This is especially important for capturing non-linear relationships; and 3) Multiple layers: An artificial neural network (ANN) can have one or more hidden layers. Networks with multiple hidden layers are often referred to as deep neural networks, which can model more complex patterns. In the DemanData platform implementation there are preferably a minimum of 3 hidden layers for determining one or more non-linear relationships. The number of hidden layers employed is optimized from a performance perspective as a higher number of hidden layers require more computing power. Based on initial results of processing using a default number of hidden layers, the number of hidden layers may be increased dynamically, and such configuration information is stored externally in a configuration file.

Next, a number of neurons is determined at 2432. Neurons (also called as nodes) are mathematical models which are fundamental processing units in the ANN. They are the granular attributes (i.e. data attributes) of the business function (like Personalization, Dynamic communities, Procurement language model etc.). Each neuron receives one or more inputs, applies weights to these inputs and produces a single output. The components of a neuron are as follows: 1) Inputs: data received from DemanData platform’s internal repositories and, when employing the alternative embodiment of the invention, external repositories; 2) Weights: values that determine the strength of connection between the attributes in different and same layers; 3) Bias: an additional input that helps adjust the execution process; and 4) Activation function: a mathematical function (in the DemanData platform case, non-linear equations) that determines the output. Using a non-linear relationship, neurons help understand the complex relationships for a business function. The number of neurons employed in any particular embodiment of the invention is determined by using scientific functions (such as input-output, square root and decreasing neurons methods) initially and applying a data driven approach after an appropriate passage of time after which enough data has been collected.

An output data layer is then determined at 1833. The output layer in an artificial neural network (ANN) is the final layer that produces the network's predictions or results. Such an output layer comprises one or more of the following key characteristics and functions:
1. Final layer: The output layer is the last layer in the neural network architecture, responsible for producing the final output based on the inputs processed through previous layers;
2. Number of nodes: The number of nodes in the output layer depends on the specific problem being solved. There are various methods (such as Binary classification, Multi-class classification, Regression) to determine the number of nodes;
3. Transforming inputs: The output layer preferably receives transformed data from the hidden layers and applies weights and biases to produce an output; and
4. Producing predictions: The output layer generates predictions that can be interpreted directly or require further processing, such as converting probabilities into class labels in classification problems. The output layer plays a critical role in determining how an ANN's learned patterns are translated into actionable insights or decisions. In accordance with an embodiment of the invention, the network is preferably iterated until received results are reasonable and meet a predetermined threshold.

Processing then continues at step 6 in which an ANN communities configuration is created at 2434. After all factors are determined to build the ANN this information is stored in an external configuration file to make changes dynamically to suit business needs. The configuration is stored in a repository with appropriate version management. This enables the ability to run multiple iterations of the model for fine tuning the results while improving efficiency and accuracy of the model.

At a next Step 7, first one or more probabilities of the ANN are determined at 2435. There are several methods that may be employed to determine the probabilities in the ANN. A sigmoid function is preferably leveraged to determine the probabilities which are used in binary classification problems to output a probability between 0 and 1. After the probabilities are determined using this function they are preferably stored in an external configuration file and are able to be changed dynamically when required. Weights are next determined at 2437. Weights in the ANN are numerical values that determine the strength and significance of the connection between neurons. These weights are applied to each of the inputs as they are passed from neuron to another. These weights are preferably determined initially through Bayesian methods and are refined over time based on the efficiency and efficacy of the results. Biases are then determined at 2436. Biases are additional parameters in the ANN that allow the model to fit the data better by providing each neuron with a constant value. They help in enabling the network to better fit complex patterns by adjusting the thresholds during the computation of the relationships. Together weights and biases enable ANN’s to learn complex relationships between attributes. Efficiency and accuracy of the model is based on fine tuning these parameters. These values are externally stored as configuration parameters to change dynamically per an analysis on the accuracy of the results.

Next, at Step 8, a communities model is configured. One or more community model thresholds are determined at 2440. An ANN which forms the core of the AI module is built with different factors as explained in the above sections. Values for each of these are stored by applying appropriate version mechanisms externally. Threshold values for each of the factors are determined and stored in the configuration files to fine tune and refine as required. Next, at 2441, one or more community model values are stored. The factors that are used to build the Community AI Model are stored externally either in ODS 1340 or file storage. Components are developed to change these values dynamically per the business needs. The model configurations are version managed to record the efficiency and accuracy. Finally, at 2442 one or more communities content model configurations are created. Based on all the factors defined and determined above the AI Model for the Personalization content are developed. These are self-contained code components which may be executed independently or in collaboration with the DemanData platform modules.

Processing then continues with Step 9 in which one or more models are generated employing one or more generations or iterations. It is a best practice to execute the AI model multiple times with different datasets of varying sizes in batches. By going through this process, the AI model provides better accuracy and results as it learns from the different datasets. For example, if there are 1000 training examples and a batch size of 100 there will be 10 iterations. A set of iterations are termed as epoch as results are evaluated by epoch. Processing multiple model generations may include the following:
a. Determine batch size;
b. Calculate or define the total number of iterations;
c. Create a training loop for the model to learn from the datasets;
d. Process data through the model;
e. Compute factors influencing the model along with the weights;
f. The above steps will be repeated and required to stop after meeting a predefined criteria;
g. Assess model results after each epoch;
h. Adjust parameters based on the performance and output;
i. Progress will need to be monitored based on the result set; and
j. Determine early stopping criteria in case there is no significant improvement in performance after each epoch.

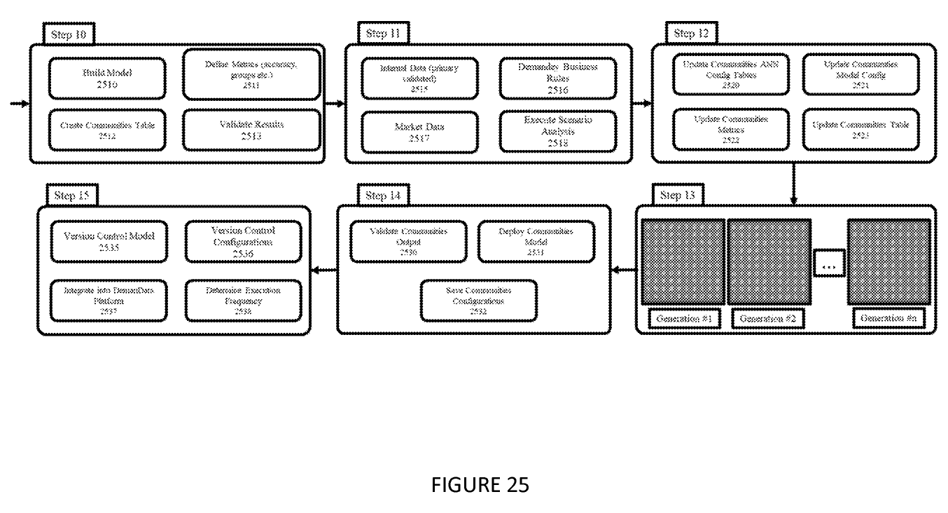

Processing continues with Step 10, shown in FIG. 25. As is shown in step 10, a build model is generated at 2510. Thus, after evaluating the results from the execution of the model in step 9, the model is finalized for the build process to be used on the DemanData platform. The final version of the model is preferably created and deployed into the platform environment. Version of the values of the model are stored in ODS 1340. Processing then continues to 2511 where one or more metrics are defined. Goals and metrics are defined for accuracy, efficiency, etc. for the model. Output of each execution of the epoch is checked and documented against the goals. These metrics may then be adjusted based on the model output result set. At 2512 a dynamic communities configuration table is preferably generated. All the factors and metrics defined against the model are stored in a configuration file or table to make it easy for future executions. Components are deployed to make it easier and simpler to change these factors dynamically. Finally at 2513 results from the AI model are validated and evaluated for accuracy and efficiency.

Processing then continues at step 11 where internal data collected during the onboarding process of one or more consumers is accumulated. Such internal Dynamic Primary Validated Data 2515 may include one or more of the following: basic user data; user demographics; user behavior and psychographic data; site navigation data; language settings & preferences; user’s user journey on the platform; and Future Intent to Purchase Data. This data is preferably collected and stored in the DemanData platform ODS 1340. One of the key factors is that the collected Dynamic Primary Validated Data is validated at the source of collection prior to saving in ODS 1340. At step 2516 one or more business rules are defined. A rule employed by the DemanData platform is defined as a specific guideline or principle that provides a deterministic output. In the DemanData platform ML algorithms are leveraged in order to generate rules based on the historical and current (Facts) data available in the various repositories by implementing and deploying an automated process. These rules are further enhanced and specialized based on the product and/or type of purchase by the user. Rules identified through the automated ML process are stored in the repository and refreshed at a regular frequency. All the AI components/modules leverage the rules repository and are layered on top of the output generated by executing them. Generally, AI Models produce an output based on the datasets on which the model is developed and trained. A set of rules are preferably defined and cross-referenced in order to validate and ensure that the model is producing outputs that are logical. For example: a married couple purchasing a product that is normally included in a wedding registry would normally be perceived as a gift (with exceptions coded based on other conditions like the person voluntarily giving information stating that they are renewing their vows, for example). Any exceptions to the rule defined above will be checked to ensure the AI model is working appropriately.

In the alternative embodiment of the invention, market Data 2517 preferably comprises Data from the external sources fetched from the DemanData platform’s ODS repositories 1340. The following data may be used for the market data to be used in the AI model development: 1) NPD; 2) IRI; 3) Social Media sources; 4) Feedback and reviews data. Finally, a scenario analysis is executed at 2518. The data that was used for development, training, testing and validation will be sliced and diced into various scenarios to ensure wider coverage of the dynamic community assignment functionality. This is a key factor in improving performance, accuracy and efficiency of the AI model.

Processing then continues at step 12 where various tables, models, and settings are updated according to new model outputs. At 2520 Communities ANN configuration tables are updated. This is the process of updating the relevant AI Model’s configuration tables to be able to change them dynamically. These are version controlled and tracked for providing feedback loop in improving efficiency of the model. At 2521 communities model configuration tables are updated. The configuration parameters are updated immediately after the execution and validation of the result sets. These are then stored in external configuration files providing flexibility to make changes without having to go through the time-consuming build and deployment process. At 2523 communities tables are also updated after each model execution. This is the process of updating the relevant AI model’s configuration tables to be able to change them dynamically. These are version controlled and tracked for providing feedback loop in improving efficiency of the model. Finally, at 2522, community metrics tables are updated. Goals and metrics will be defined for accuracy, efficiency, etc. for the model will be updated after each iteration of the execution. Metrics are preferably adjusted after each iteration to refine the accuracy and efficiency of the model.

Next, processing passes to step 13 where final models are generated. The sequence to execute and process the AI model is preferably iterated through multiple times to refine the results for accuracy, model efficiency and performance. Steps explained in the section above for model generations (step 9) are preferably repeated here while updating the parameters for accurate results. The model output results are validated manually by developing and applying different test cases and scenarios.

After these new models are generated processing continues at step 14 in which various validation and deployment steps are performed Communities Output is validated, i.e. output from the execution of the communities model is validated and finalized at step 2530 and is then deployed at 2531. The following steps are followed to deploy the model: Save the model to a file that contains all necessary information (containerize) for making predictions; Keep different model versions using the Bitbucket repository; Package the serialized model and its dependencies into a container; Deploy the trained model into the environment; Set up monitoring tools to track the model's performance, catch errors, and detect any drift in behavior over time; and Implement encryption, authentication, and access control to protect the model and data from unauthorized access. Then at 2532 the communities configurations are saved. The model, its factors and related configuration is saved for future use, allowing these saved elements to be updated in the future per business needs.

Processing then is then completed at step 15 in which the final deployment items are put in place to release these updated models. At 2535 the model is version controlled. Thus, the model and parameters will be controlled through version management as it helps track results, accuracy and efficiency. This is a standard and straightforward process in helping assess to go forward or rollback in case required. At 2536 the configurations applicable to the models are also controlled through version control. At 2537 the new models are integrated into a production platform. This is the final step in the AI model creation. The AI model is thus integrated into the DemanData platform. Finally, at 2538 execution frequency is determined. It is important to understand and determine frequency of the AI model execution. The frequency is based on changing business needs and usage patterns. On the DemanData platform the models are monitored and checked regularly (monthly, for example) to cater to the market and user demands. It is also possible to update the model in parallel with the production instance and then to test to see if an updated model provides significantly improved and more accurate output.

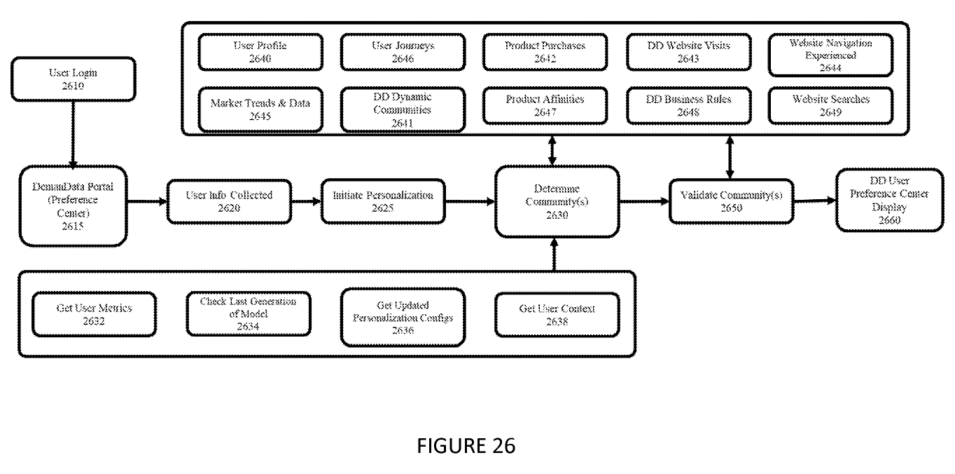

Referring next to FIG. 26, a use case for the application of dynamic communities content in accordance with an embodiment of the invention will be described. At step 2610 an Individual Consumer user first enters credentials to login to the DemanData platform. Then at step 2615, after the user’s credentials are validated, the user is logged into the DemanData platform. Login time and other information is captured and saved in ODS 1340. Then at step 2620 user information is collected. Information regarding the profile, number of logins, etc. is collected from ODS 1340 to be presented to the personalization component of the system, and at step 2625 the personalization engine is initiated in order to perform the one or more personalization steps. A community determination content engine is implemented at step 2630. Inputs to the processing at step 2630 include one or more of the following:
User Profile 2640: Information related to the basic profile is put into the platforms state machine to be presented to the personalization engine.
User Journeys 2646: All the data that was captured as the user browsed on the platform (i.e. products searched, features & specifications viewed etc.) is fetched into the state machine.
Product Purchases 2642: Detailed data regarding the past purchases made on the platform are fetched from ODS 1340.
DemanData Website Visits 2643: Number of times the user has visited the website is fetched.
Website Navigation Experienced 2644: Information that is specific to the user’s navigation on the website is captured and made available to the personalization engine.
Website Searches 2649: Different searches made by the user on the platform are fetched and made available for use by the personalization engine
Market Trends & Data 2645: In the alternative embodiment of the invention, data from any external sources (if employed, such as social media, NPD, IRI etc.) may be fetched from the platform’s repositories.
DD Dynamic Communities 2641: Data that is related to the grouped communities will be fetched.
Product Affinities 2647: The data that is captured with respect to the products that the user is interested in will be fetched to provide as input into the AI model.
DD Business Rules 2648: System fetches business rules related to the product and context the user is in are identified and will be made ready in the memory. User Settings is defined as the configuration related to the user’s likes and preferences of the UI aspects which are fetched from ODS 1340. This information along with the user settings and preferences is defined and stored in ODS 1340

In addition to the above information, various information is preferably fetched from the platform in order to further inform the community determination content engine 2630, and may include one or more of the following:
Get User Metrics 2632: The user metrics related to the number of purchases, feedback provided, satisfaction level etc. are fetched from the ODS.
Check Last Generation of Model 2634: System ensures that the version of the AI model being used is the latest and approved version in the repository.
Get Updated Personalization Configs 2636: All the configuration information is validated and fetched to make any changes, if required.
Get User Context 2638: Content related to the user’s request along with context is provided as additional inputs to the engine.

One potential output from the community content engine 2630 may comprise dynamic community recommendations at step 2650. The AI model is executed with all the inputs from the above sections. The latest version of the configuration parameters and the model are fetched from the version management repository. With the data that is fetched and stored in the session along with user’s context is provided as input to this AI model. After the execution is complete the AI model generates one or more potential communities that can be recommended to the user. These potential communities are then displayed to the user in the preference center at step 2660.

Analytics 179. The Product Analytics AI application is a powerful tool that provides detailed insights and analytics related to products. The Product Analytics application provides insights into product trends by focusing on current and future user needs and desires, rather than relying solely on historical data. This forward-thinking approach helps identify futuristic market trends, driving product development, innovation and extremely higher profit actualization. This application offers several key advantages:
Product Insights: It delivers valuable insights to original sources by analyzing user interactions and preferences. By having a direct link with customers, they will know what new products and services to offer.
Feature Development: By capturing user journeys, it helps drive the development of product features that align with current consumer desires.
Market Trends: The application identifies futuristic market trends by focusing on Consumption’s current wants and needs, including their Future Intent to Purchase Data, rather than relying solely on historical data. This forward-looking approach helps original sources stay ahead in the market.

Through efficient utilization of supply and demand data, the inventive system can provide original sources (manufacturers) with valuable insights to optimize their operations and profitability. By presenting demand and supply curves for each individual SKU, the inventive system demonstrates how they can increase sales and EBITDA. This approach helps mitigate the bullwhip effect, a common supply chain inefficiency, where fluctuations in consumer demand cause progressively larger fluctuations in inventory and order quantities moving up the supply chain, often resulting in excess inventory, Increased production costs, and Inefficient resource allocation.

The Customer Analytics AI application is designed to create detailed profiles of users based on their Dynamic Primary Validated Data, allowing the DemanData platform to improve the offered services and products. Developed from scratch and tailored to the business's proprietary needs, this application aims to deliver tailored suggestions, predictive analytics, targeted offers, personalized content, customized user interfaces, and contextual marketing. It also includes community-targeted marketing, and in an alternative embodiment of the invention, the aggregation and summarization of relevant community-based reviews.

Through DemanData AI tools, manufacturers will be able to reach the holy grail of production efficiency, manufacturing on demand rather than to stock.

Affiliates 180. An affiliate (person or company) has the opportunity to provide its customers/followers/members access to the DemanData system and receive a portion of all money spent by their customers/followers/members. The Affiliate Analytics AI application uses advanced artificial intelligence to improve how affiliates work and engage with users. It does this in three main ways: First, it creates personalized experiences for affiliates based on their preferences. Second, it provides smart advice on how to make affiliate content perform better. Finally, it suggests new affiliate partnerships to help expand reach. All of these features work together to make affiliate marketing more effective, reach more people, and run more efficiently.

3PL (Third Party Logistics) 181. 3PL refers to the groups of distribution partners, such as FedEx, UPS, DHL, USPS, XPO, etc. These groups are preferably employed to deliver goods directly from a manufacturer site, or one of the large VMI distribution locations representative of the manufacturer. Through such direct delivery, multiple levels of intermediate distribution partners may be avoided, thus significantly reducing the cost of such distribution, allowing that savings to be returned to the ultimate consumer.

Onboarding 182. Users will be onboarded in a manner that is generally known to one of ordinary skill in the art. In addition to simply collecting basic user data, demographic and psychographic data will be collected from users based on a particular set of questions that will allow the user to be connected to one or more communities, and to be presented with one or more personalization and product recommendations, as described above. Additionally, if a user indicates a particular interest in a product area or type, the user may be presented with one or more questions directly related to those product categories.

Smart Search 183. Smart search refers to the ability to use prior consumer-shared data in addition to any current searches to determine a best response for a particular Individual Consumer. Consumers will also benefit from the assisted Smart Search application in that it improves search experiences by providing refined suggestions and alternative search criteria.

Fraud Detection 184. The Fraud Detection & Prevention (Entity Resolution) AI application is designed to identify and prevent fraudulent transactions by leveraging a comprehensive knowledge base of rules. This system is adept at detecting instances where users may be exploiting or abusing the system. It employs a combination of Support Vector Machines (SVM) and classification models to analyze transaction data and identify anomalies indicative of fraud. Additionally, a rules-based inference engine is integrated to enhance decision-making processes by applying predefined rules to flag suspicious activities. This multi-faceted approach ensures robust fraud detection capabilities, safeguarding the system from potential misuse.

Demand Forecasting 185. Based on the most accurate, up to date, validated data received directly from Consumption ready to purchase, the DemanData system is able to forecast demand and efficiently pass this information to Original Sources. Accuracy of the projected data results in fewer items being produced that will not be purchased, improving Original Source profits and reducing cost to Consumption to cover unsold goods. The Demand Forecasting AI Application is designed to optimize procurement processes for large Business Consumers and Individual Consumer, as described above. The application can functionally create the perfect demand-supply price curve (price and supply discovery). It preferably employs a variety of regression models to create accurate demand forecasts. The Demand Forecasting application provides a comprehensive approach to resource management, allowing Individual Consumers and Business Consumers to anticipate and meet demand effectively. This helps Individual Consumers and Business Consumers save 50% on everything they have been purchasing, same brand and products, because it creates manufacturing to order rather than to stock – the Holy Grail.

Original Sources (OS) 186. Original Sources of goods or services (manufactures for example) are onboarded onto the system. These Original Sources may present a set of questions or filters they wish to have applied to the collected Individual Consumer data in order to identify one or more Individual Consumers with a high intent to purchase a particular good or service, as described above in relation to the Data Value Score. The Profile Question Generation AI application empowers Original Sources by analyzing their submitted requested profiles of high-intent customers to generate relevant generic profile questions for consumption. The application (or AI Agent, if employed) preferably processes these profiles to establish a Universal Generic Question Set and a set of Offer Specific Questions. These questions are designed to effectively match consumers with manufacturers and their offers, thereby optimizing the data collection and maximizing consumption data value.

Payment Service Provider (PSP) 187. Interface to the respective PSP will be accessed and upon confirmation of the payment success message is generated (in case of any issue error raised) and responded back to the Prompt management component.

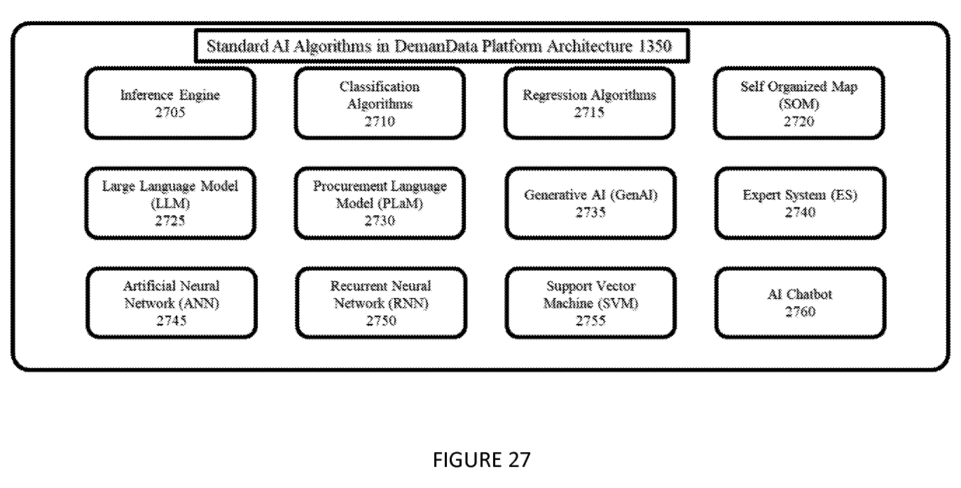

Referring next to FIG. 27, a preferred group of standard AI algorithms 1350 (see FIG. 13) will be described. These AI Algorithms support the DemanData business functions 1310 described above.

Interference Engine 2705. An inference engine is a key component of artificial intelligence systems, that applies logical rules to a knowledge base to deduce new information or make decisions. The knowledge base is built over a period of time based on a set of facts and rules. The inference engine is a key component of DemanData platform AI architecture layered over all models as it helps with explainability. Major areas that leverage this model are Expert advisor, personalized marketing, personalized recommendations and etc.

Classification Algorithms 2710. Classification algorithms are supervised learning methods that aim to identify which category or class an observation belongs to, based on a set of input features. The algorithm learns from a training dataset where the correct classifications are known and then applies this knowledge to classify new and unseen data. In the DemanData system this technique is leveraged for fraud detection, sentiment analysis, dynamic communities and other critical functions for better user experience.

Regression Algorithms 2715. Regression algorithms are a set of statistical and machine learning techniques used to model and analyze the relationships between a dependent variable (often called outcome variable) and one or more independent variables (predictors or features). Demand forecast and assisting with ordering of products for DemanData business clients apply this technique on the DemanData platform. Seasonal variants, promotional events, offerings and etc. will be factored into this model.

Self Organized Map (SOM) 2720. SOM is a type of artificial neural network used for unsupervised learning. SOMs are primarily used for dimensionality reduction and clustering, transforming high-dimensional data into a lower-dimensional (typically two-dimensional) representation. SOM is leveraged for classification and understanding the relative impact between and across the attributes on the DemanData platform. This helps the system to understand the relation and impact when performing current state analysis.

Large Language Model (LLM) 2725. Large language model (LLM) is an advanced artificial intelligence system trained on vast amounts of text data to understand and generate human-like text. It uses deep learning techniques, typically based on Neural Network (NN) architectures, to process and produce natural language. In the DemanData system this technique is leveraged for all the business functions which require processing a set of documents (agreements, terms & conditions, policies and etc.) on the DemanData platform the LLM will be leveraged to summarize, identify anomalies, inconsistencies and etc.

Procurement Language Model (PlaM) 2730. PLaM is a specialized version of the LLM focused primarily on terms and language related to Procurement. Facilitates processing of Procurement specific documents, PO’s, Invoices and etc. in the environment supporting all three lines of business. It enables prompt engineering for all users to get information in textual format.

Generative AI (GenAI) 2735. GenAI focuses on creating new content, such as text, images, videos, audio, or code, based on patterns and structures learned from existing data. Generates outputs that are coherent and contextually relevant to the input prompts provided by users. One-Prompt Purchase supported by the DemanData platform leverages both the GenAI and Prompt engineering techniques. In general all functions available on the platform are supported through Prompts making it AI enabled.

Expert System (ES) 2740. An expert system is a computer program that uses artificial intelligence techniques to simulate the judgment and decision-making ability of a human expert in a particular field or domain. It is designed to solve complex problems by reasoning through bodies of knowledge, represented mainly as if-then rules. The design and implementation of Expert Advisor in the DemanData platform leverages this technique for all products.

Artificial Neural Network (ANN) 2745. ANN is a computational model consisting of interconnected nodes (artificial neurons) organized in layers that process information and learn patterns from data to perform various tasks such as classification, prediction, and pattern recognition. ANN is used throughout the platform across all supporting business functions like building dynamic Communities, personalization, targeted marketing and etc.

Recurrent Neural Network (RNN) 2750. RNN is a specialized form of ANN designed to work with sequential data. It processes sequences of data by maintaining an internal state (memory) from previous inputs, allowing it to exhibit dynamic temporal behavior. In the DemanData platform RNN is used for speech recognition, time series prediction, and sentiment analysis.

Support Vector Machine (SVM) 2755. SVM is a supervised machine learning algorithm used for classification, regression, and outlier detection tasks. The primary focus of SVM is to find optimal line of demarcation between clusters in the data. This model is used for text classification, anomaly detection, outliers in the data as part of the DemanData platform. Primary usage of this model is in the DemanData business platform for understanding the patterns in past procurement historical data.

AI Chatbot 260. AI chatbots are components that use artificial intelligence to simulate human-like conversations leveraging Natural Language Processing (NLP), Machine learning and available 24X7 for customer support. The customer support function of the platform are enabled with AI Chatbot for facilitating user queries.

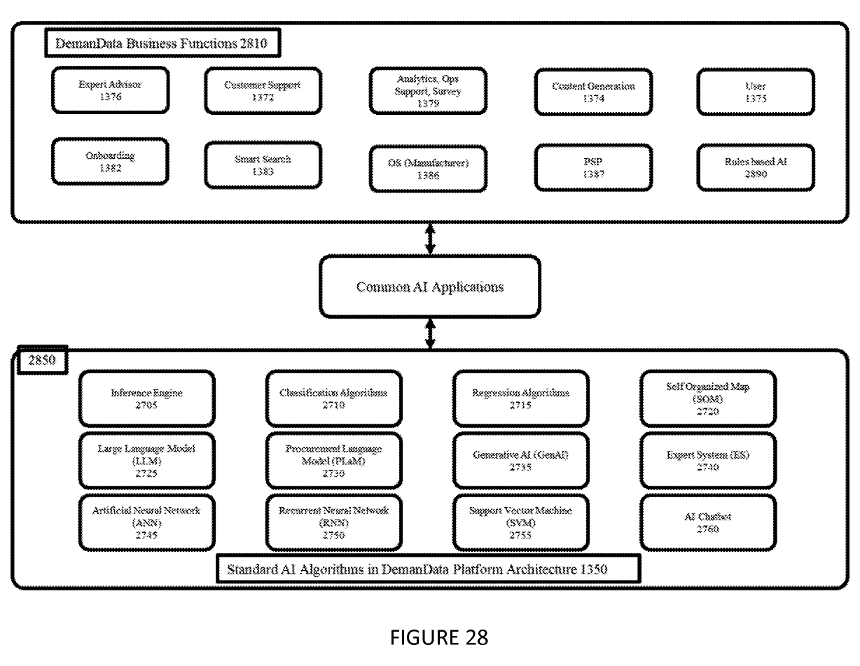

Referring next to FIG. 28, a subset 2810 of the business functions 1310 and subset 2850 of the AI Algorithms 1350 are presented that are preferably applied across all application areas. The common business functions that were described above in FIG. 13 comprise Customer Support 1372, Content Generation 1374, User 1375, Expert Adviser 1376, Analytics, Operations, Support, Survey 1379, Onboarding 1382, Smart Search 1383, Original Source (OS) Manufacturer 1386, and PSP 1387. The solution also commonly comprises a rules based AI system 2890. The DemanData rules based AI system preferably establishes rules on top of deep learning algorithms involving integrating rule-based systems with neural networks to enhance interpretability and control. This hybrid approach leverages the strengths of both systems: the flexibility and learning capabilities of deep learning, and the transparency and explicit control of rule-based systems. This rules based process is preferably employed before or during the training of a deep learning model, to inject specific rules to guide the learning process. This helps in constraining the model to adhere to known domain knowledge or safety regulations. The common applicable AI algorithms 2850 preferably include all of those presented in FIG. 27.

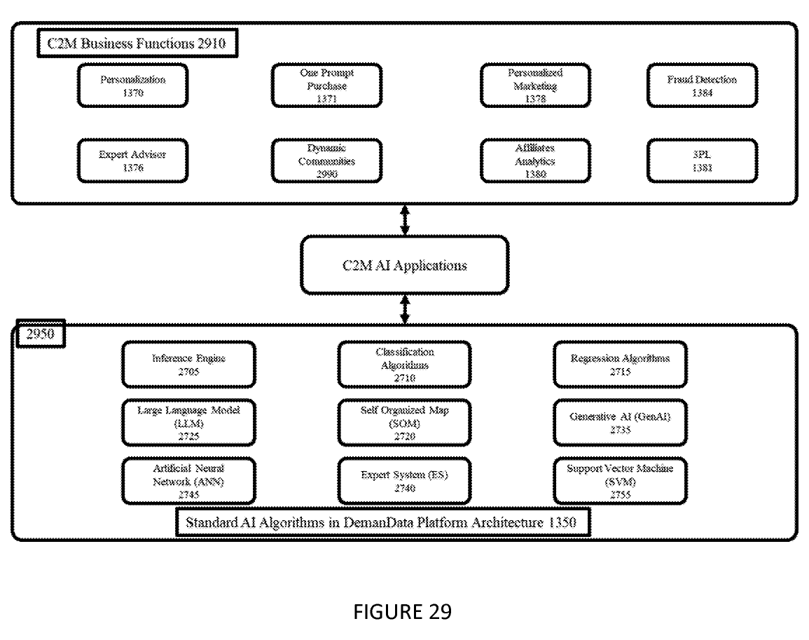

Further referring to FIG. 29, a set of business functions 2910 and AI algorithms 2950 are presented that are preferably applied to the application area for direct to consumer purchasing by Individual Consumers. The common functions that were described above in FIG. 13 comprise Personalization 1370, One Prompt (or click) Purchase 1371, Expert Adviser 1376, Personalized Marketing 1378, Affiliate Analytics 1380, and 3PL 1381. The Individual Consumer focused solution also includes a function for managing Dynamic Communities 2990. The Dynamic Communities AI Application builds real-time communities by analyzing users personal Dynamic Primary Validated Data, presenting relevant information and products (as described above with reference to FIGS. 17-19). This fosters connection among users with similar interests, enhancing the sense of community on the platform. The consumer applicable AI algorithms 2950 comprise Inference Engine 2705, Classification Algorithms 2710, Regression Algorithms 2715, Self Organized Map (SOM) 2720, Large Language Model (LLM) 2725, Generative AI (GenAI) 2735, Expert System (ES) 2740, Artificial Neural Network (ANN) 2745, and Support Vector Machine (SVM) 2755.

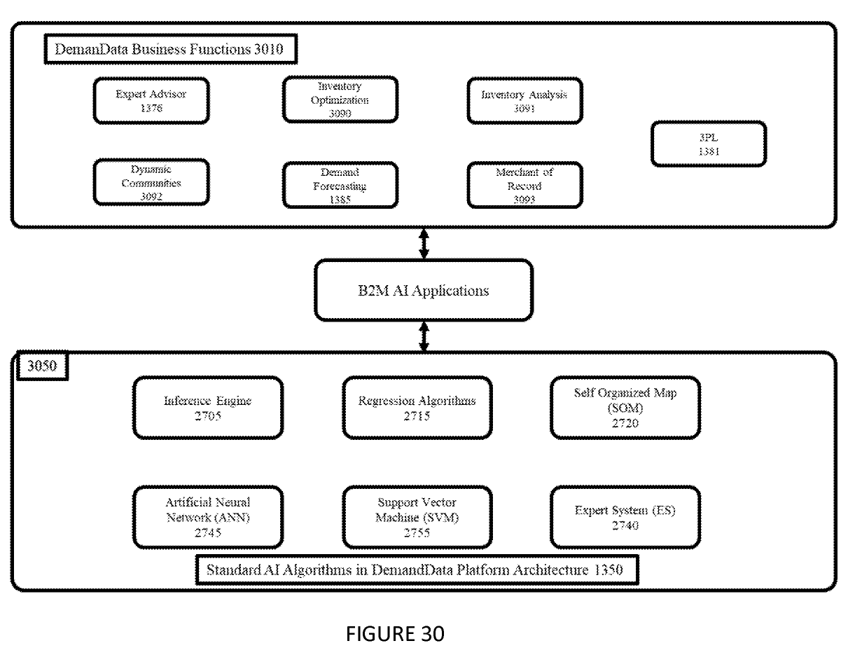

Additionally referring to FIG. 30, a set of business functions 3010 and AI algorithms 3050 are presented that are preferably applied to the application area for direct to business purchasing by Business Consumers. The common business functions that were described above in FIG. 13 comprise Expert Adviser 1376, 3PL 1381, and Demand Forecasting 1385. The business focused solution also comprises business functions Inventory Optimization 3090 (which is designed to optimize inventory management through data-driven analysis, forecasting, and reporting. The system processes historical data, current inventory levels, and market conditions to provide optimal inventory recommendations while maintaining service levels and minimizing costs) and Inventory Analysis 3091. The Inventory Analysis AI application 3091 analyzes historical data preferably consisting of two years of utilization rates, to identify patterns, overages, and wastage through an AI data analysis. This analysis helps determine accurate utilization rates, and inventory purchasing levels for the proper periods of time, allowing original Sources to adopt a made-to-order production approach, which minimizes waste, maximizes price efficiency for the buyer, and optimizes inventory management. The Optimal Inventory Ordering AI Application 3090 analyzes procurement data and market conditions to maintain ideal inventory levels using Self-Organizing Maps and Regression models. It predicts optimal reorder points to prevent stockouts, adjusts inventory levels based on market trends, and reduces holding costs by minimizing excess inventory, in other words the perfect perpetual inventory system.

Additional business functions for business purchasing comprise Dynamic Communities 3092 (as described above), and Merchant of Record 3093, comprising a third party entity responsible for settling the payment between institutional businesses and the Original Sources after the goods are delivered. The applicable AI algorithms comprise Inference Engine 2705, Regression Algorithms 2715, Self Organized Map (SOM) 2720, Expert System (ES) 2740, Artificial Neural Network (ANN) 2745, and Support Vector Machine (SVM) 2755, as described above.

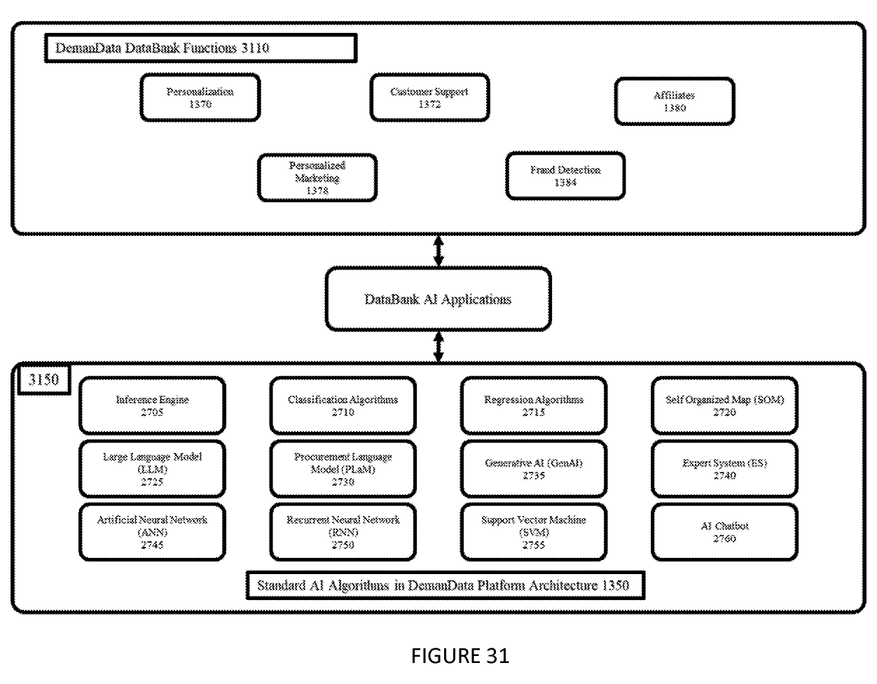

Next referring to FIG. 31, a set of business functions 3110 and AI Algorithms 3150 are presented that are preferably applied to the application area for DataBank. The common business functions that were described above in FIG. 13 comprise Personalization 1370, Customer Support 1372, Personalized Marketing 1378, Affiliates 1380, and Fraud Detection 1384. The solution also commonly comprises a Product Offers and Matching 690, comprising a process of matching product offers between user’s needs (as per their detailed profile) and the original source’s availability of products that suits the user. The common applicable AI algorithms include all of those presented in FIG. 13.

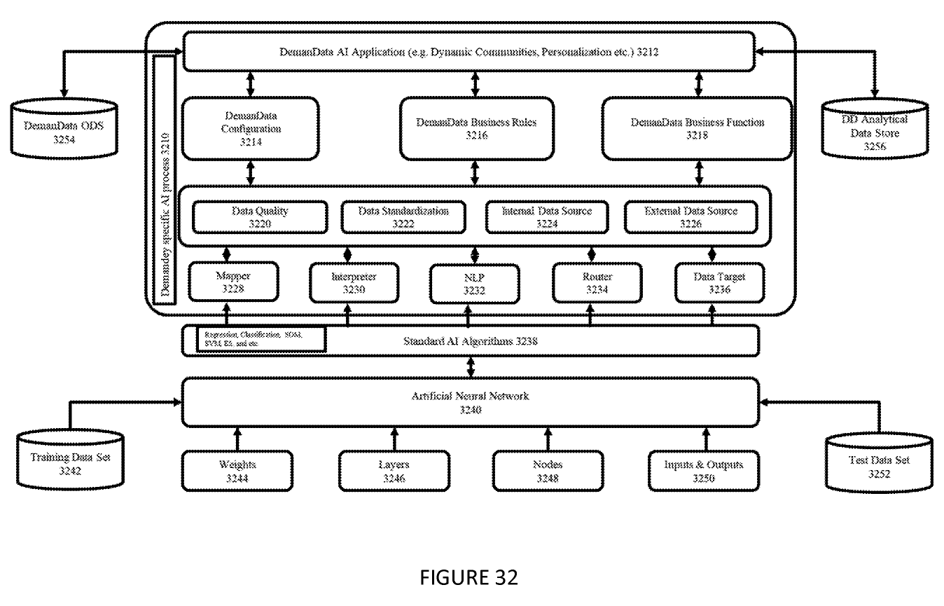

FIG. 32 discloses an Artificial Intelligence structure presented in accordance with an embodiment of the invention. Specific AI processes are shown at 3210. Any of the inventive AI applications described above may be included at 3212. One or more of these AI applications receive inputs and provide outputs, and including configuration elements 3214, business rules 3216, and business functions 3218. Information is also provided from an ODS 3254 and an analytical data store 3256. Each of these inputs/outputs in turn relies on rules for data quality 3220, data standardization 3222, an internal data source 3224, and an external data source 3226. More standard AI Algorithms 3238 (such as Regression, Classification, SOM, SVM, ES) interact with noted rules via a mapper 3228, an interpreter 3230, a natural language processor (NLP) 3232, a router 3234, and a data target 3236. In turn, the standard algorithms 3238 interact with an artificial neural network 3240 which in turn receives inputs from a training data set 3242, weights 3244, layers 3246, notes 3248, inputs 3250, and a test data set 3252.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description, the below claims, and shown in the accompanying drawings shall be interpreted as illustrative and not in a limiting sense.

It is also to be understood that this description and claims are intended to cover all of the generic and specific features of the invention herein described and all statements of the scope of the invention which, as a matter of language, might be said to fall there between.

1. A system for providing dynamic primary validated data of consumers wishing to purchase products, comprising:
a user interface for receiving future intent to purchase data for one or more products, the future intent to purchase data for each product being associated with a particular one of one or more registered consumer users of the system;
a user data storage for storing the received future intent to purchase data for the one or more products associated with the particular one of the one or more registered consumer users of the system;
an internal data storage storing internal recent and current consumption data relevant to prior purchases of products of the particular one of the one or more registered consumers;
an external data storage storing recent and current consumption data collected from one or more external data sources relevant to prior purchases of products of the particular one of the one or more registered consumers;
a first processor for processing the internal and external recent and current consumption data relevant to prior purchases of products and the one or more future intent to purchase data for the one or more products of the particular one of the one or more registered consumers to determine for each of the products, whether the particular one of the one or more registered consumers has indeed purchased one or more of the one or more of the products identified in the future intent to purchase data; and
a second processor for generating a data value score in accordance with the determination of whether the particular one of the one or more registered consumers has indeed purchased one or more of the one or more of the products identified in the future intent to purchase data.

2. The system of claim 1, wherein the user interface receives further received future intent to purchase data for the one or more products associated with the particular of one or more registered consumer users of the system, the user data storage stores the received further future intent to purchase data for the one or more products, the first processor processes the further received future intent to purchase data for the one or more products, and the second processor updates the data value score in accordance with the determination of whether the particular one of the one or more registered consumers has indeed purchased one or more of the one or more products indicated by the further received future intent to purchase data.

3. The system of claim 1, further comprising a digital marketplace where one or more data purchasers provide one or more of the one of the one or more registered consumers with one or more offers to purchase their data based at least in part on their generated data score.

4. The system of claim 3, wherein the digital marketplace enables the one or more data purchasers to modify the terms of the one or more offers to purchase data based at least in part on the data score of the of the one of the one or more registered consumers.

5. The system of claim 4, wherein the modification of the terms of the one or more offers to purchase data provides a greater payment to one or more of the one or more registered consumers with a data score reaching a predetermined threshold.

6. The system of claim 3, wherein the data value score is calculated from a subset category of the products indicated in the future intent to purchase data that are relevant to that particular subset of products.

7. The system of claim 3, wherein the offer to purchase data is based upon receiving anonymized aggregated data from a plurality of users whose profile meets one or more criteria provide by the data purchaser.

8. The system of claim 3, wherein the offer to purchase data is based upon receiving identifiable, individual data from one or more purchasers of users whose profile meets one or more criteria provide by the data purchaser, allowing the data purchasers to market directly to each of the one or more purchasers.

9. The system of claim 1, wherein the internal data storage further stores one or more data types selected from the group of: product specifications, product ratings, market data, product reviews, and product pricing.

10. The system of claim 1, wherein more recently obtained recent and current consumption data is weighted more heavily in calculating the data value score so that the data value score changes over time in accordance with changes in the users recent and current consumption data.

11. A method for providing dynamic validated of consumers wishing to purchase products, comprising:
receiving, via a user interface, future intent to purchase data for one or more products, the future intent to purchase data for each product being associated with a particular one of one or more registered consumer users of the system;
storing, in a user data storage, the received future intent to purchase data for the one or more products associated with the particular one of the one or more registered consumer users of the system;
storing, in an internal data storage, internal recent and current consumption data relevant to prior purchases of products of the particular one of the one or more registered consumers;
storing, in an external data storage, recent and current consumption data collected from one or more external data sources relevant to prior purchases of products of the particular one of the one or more registered consumers;
processing, by a first processor, the internal and external recent and current consumption data relevant to prior purchases of products and the one or more future intent to purchase data for the one or more products of the particular one of the one or more registered consumers to determine for each of the products, whether the particular one of the one or more registered consumers has indeed purchased one or more of the one or more of the products identified in the future intent to purchase data; and
generating, by a second processor, a data value score in accordance with the determination of whether the particular one of the one or more registered consumers has indeed purchased one or more of the one or more of the products identified in the future intent to purchase data.

12. The method of claim 11, further comprising:
receiving, via the user interface, further future intent to purchase data for the one or more products associated with the particular of one or more registered consumer users of the system;
storing the received further future intent to purchase data for the one or more products in the user data storage;
processing the further received future intent to purchase data for the one or more products by the first processor; and
updating, by the second processor, the data value score in accordance with the determination of whether the particular one of the one or more registered consumers has indeed purchased one or more of the one or more products indicated by the further received future intent to purchase data.

13. The method of claim 11, further comprising providing, by the one or more data purchasersone or more of the one of the one or more registered consumers with one or more offers to purchase their data based at least in part on their generated data score.

14. The method of claim 13, further comprising enabling the one or more data purchasers to modify the terms of the one or more offers to purchase data based at least in part on the data score of the of the one of the one or more registered consumers.

15. The method of claim 14, wherein the modification of the terms of the one or more offers to purchase data provides a greater payment to one or more of the one or more registered consumers with a data score reaching a predetermined threshold.

16. The method of claim 13, further comprising calculating the data value score from a subset category of the products indicated in the future intent to purchase data that are relevant to that particular subset of products.

17. The method of claim 13, further comprising basing the offer to purchase data upon receiving anonymized aggregated data from a plurality of users whose profile meets one or more criteria provide by the data purchaser.

18. The method of claim 13, further comprising basing the offer to purchase data upon receiving identifiable, individual data from one or more purchasers of users whose profile meets one or more criteria provide by the data purchaser, allowing the data purchaser to market directly to each of the one or more purchasers.

19. The method of claim 11, further comprising storing, in the internal data storage, one or more data types selected from the group of: product specifications, product ratings, market data, product reviews, and product pricing.

20. The method of claim 11, further comprising weighing more heavily more recently obtained recent and current consumption data in calculating the data value score so that the data value score changes over time in accordance with changes in the users recent and current consumption data.
